(19) United States
(12) Patent Application Publication
(10) Pub. No.: US 2025/0320159 A1
(43) Pub. Date: Oct. 16, 2025

(54) USE OF CARRAGEENAN AS A VISCOSITY-MODIFYING ADMIXTURE IN A FLOWABLE CEMENTITIOUS SUSPENSIONS

(71) Applicant: SOCPRA SCIENCES ET GENIE S.E.C., Sherbrooke (CA)

(72) Inventors: Ammar YAHIA, Sherbrooke (CA); Kamal BOUARAB, Sherbrooke (CA); Asma BOUKHATEM, Sherbrooke (CA); Ahmed MOSTAFA, Calgary (CA)

(21) Appl. No.: 18/253,465

(22) PCT Filed: Nov. 18, 2021
(86) PCT No.: PCT/CA2021/051637

§ 371 Date: May 18, 2023

Related U.S. Application Data
(60) Provisional application No. 63/115,270, filed on Nov. 18, 2020.

(51) Int. Cl. C04B 24/38; C04B 28/02; C04B 28/16; C04B 103/00; C04B 111/62; C04B 111/70

(52) U.S. Cl. CPC C04B 24/38; C04B 28/02; C04B 28/16; C04B 2103/0079; C04B 2111/62; C04B 2111/70

(57) ABSTRACT

There is provided the use of carrageenan as a viscosity-modifying admixture in a flowable cementitious suspension; a viscosity-modifying admixture for a flowable cementitious suspension, the viscosity-modifying admixture comprising carrageenan; a method of modifying the viscosity of a flowable cementitious suspension, the method comprising adding carrageenan as a viscosity-modifying admixture to the flowable cementitious suspension. There is also provided a dry cementitious composition comprising carrageenan as a viscosity-modifying admixture and a flowable cementitious suspension comprising carrageenan as a viscosity-modifying admixture. The flowable cementitious suspension typically comprises the dry cementitious composition as well as water. The flowable cementitious suspension can be a self-leveling flowable cementitious suspension, such as grout or mortar for self-leveling flooring, crack injection, or and anchorage sealing, or a self-consolidating flowable cementitious suspension, such as a flowable concrete.

### CROSS REFERENCE TO RELATED APPLICATIONS

This application claims benefit, under 35 U.S.C. § 119(e), of U.S. provisional application Ser. No. 63/115,270, filed on Nov. 18, 2020. All documents above are incorporated herein in their entirety by reference.

### FIELD OF THE INVENTION

The present invention relates to the use of carrageenan as a viscosity-modifying admixture in flowable cementitious suspensions, such as self-consolidating concrete (SCC). More specifically, the present invention is concerned with a viscosity-modifying admixture for flowable cementitious suspensions, the viscosity-modifying admixture comprising carrageenan; a method for modifying the viscosity of a flowable cementitious suspension, the method comprising adding carrageenan as a viscosity-modifying admixture to the flowable cementitious suspension; a dry cementitious composition comprising carrageenan as a viscosity-modifying admixture; and a flowable cementitious suspension comprising carrageenan as a viscosity-modifying admixture.

### BACKGROUND OF THE INVENTION

### Flowable Cement-Based Materials

Concrete is a construction material made of a mixture of cement, sand, aggregates, and water. Concrete solidifies and hardens after mixing with water and placement due to a chemical process known as hydration of cement. The water reacts with the cement, which bonds the other components together, eventually creating a stone-like material. Concrete is used to make pavements, architectural structures, foundations, motorways/roads, bridges/overpasses, parking structures, brick/block walls and footings for gates, fences and poles.

In concrete technology, an important field of interest is flowable concrete, which flows and consolidates itself due to gravity. Consequently, no external vibration or other consolidation is needed. Hardened concrete will exhibit better mechanical behavior than conventional concrete. It is possible to produce very high-performance flowable concrete. Because consolidating work is not needed, noise level during construction is lowered remarkably and one working phase is eliminated.

A problem with the flowable concretes is that they are more sensitive to bleeding and segregation than conventional concrete. Bleeding and segregation usually result in concrete with unacceptable properties. Bleeding and segregation of concrete are two interrelated phenomena. Concrete segregation occurs by gravity of its constituents, the densest aggregates descend downwards (segregation), while the paste, less dense, rises to the surface (bleeding). Bleeding is the consequence of segregation. Paste is the mixture of water, cement, fine powders, and admixtures.

Flowable concretes contain, among others, superplasticizers (also called high-range water-reducers (HRWR) so they can spread readily into place with minimal consolidation and achieve suitable consolidation.

### Viscosity-Modifying Admixtures (VMAs)

An approach to improving the stability of flowable cementitious materials is to incorporate a viscosity-modifying admixture (VMA). VMAs were first used in Germany in the mid-1970s and later in Japan in the early 1980s. In North America, VMAs have been used since the late 1980s to proportion underwater concrete used in specialized applications, such as underwater repair, massive foundations, and high-performance cement grout for post-tensioning ducts protection.

VMAs are used to modify rheology and enhance stability of these cement-based systems, and especially those characterized by high fluidity, such as self-consolidating concrete (SCC) and high-performance grouts. Indeed, in highly fluid cement-based materials that are susceptible to segregation due to their low yield stress and plastic viscosity (such as SCC), the incorporation of VMA helps preventing liquid-solid phase separation (i.e., bleeding and segregation) and the separation of the heterogeneous constituents of concrete during transport, placement, and consolidation. This can therefore provide added stability to the cast concrete while in a plastic state to achieve good mechanical and structural performances. Some VMAs can also be used to impart thixotropy to the cement-based materials in order to improve the static stability and reduce lateral pressure on the concrete formwork. VMAs are also used to enhance rheology and stability of specialty cement grouts intended for the underwater repair of marine and hydraulic structures, sealing of cracks in offshore structures, and massive foundations as well as those used for filling post-tensioning ducts.

Selection of a suitable VMA is challenging because while desirably increasing viscosity, the VMA may also undesirably increase the yield stress of the SCC and thereby inhibit its self-consolidating nature or increase its likelihood to trap air bubbles. Therefore, selection of an appropriate VMA for SCCs and fluid grout is restricted, primarily, to a rather small group of materials. VMAs commonly used in cement-based materials are inorganic materials or high-molecular-weight and water-soluble organic polymers. These water-soluble polymers can be classified as synthetic, semi-synthetic, or natural polymers. The most used natural VMAs include biopolymers, such as polysaccharides: guar gum, alginates, diutan gum, welan gum, rhamsan gum, gellan gum, and xanthan gum. Semi-synthetic polymeric VMAs include decomposed starch and its derivatives, cellulose ether derivatives, such as hydroxy-propyl-methyl-cellulose (HPMC), hydroxyethylcellulose (HEC), carboxymethylcellulose (CMC), as well as electrolytes, including sodium alginate and propylene glycol alginate. Synthetic polymers VMAs, such as ethylene-based polymers, polyethylene oxide, polyacrylamide, polyacrylate, and polyvinyl alcohol, are also used. Finally, inorganic VMAs are silica-based materials, such as nano-silica and colloidal silica.

The above VMAs impact both yield stress and plastic viscosity of cement-based materials. It is noted that starches tend to detrimentally impact both yield stress and plastic viscosity, clays tend to detrimentally impact yield stress, Welan gum and diutan gum are expensive and tend to detrimentally impact both yield stress and plastic viscosity, hydroxyethyl cellulose tends to detrimentally impact flow properties and synthetic polymers based on polyacrylates are expensive and tend to detrimentally impact yields stress.

As noted above, organic VMAs are high molecular weight water-soluble polymers. They improve the water-retention capacity of cement-based materials by absorbing the amount of free water available for lubrication, thereby modifying the rheological properties and stability of the material. More specifically, the VMAs long chains physically adsorb large amounts of mixing water via hydrogen bonding, hence reducing the amount of free water. By binding some of the mixing water, these polymers enhance the liquid-phase viscosity, hence reducing the rate of separation of constituents of different densities and improving the homogeneity. The water absorption increases the VMAs' effective volume and, consequently, the viscosity of the interstitial fluid of cementitious systems. Apart from this specific effect on the continuous phase, the VMA polymers can also adsorb onto cement particles due to their ionic character. This can therefore increase the yield tress of cement-based materials. In fact, three different modes of action of VMA have been reported:
adsorption where the long-chain polymer molecules adsorb and fix part of the mixing water and thereby expanding,
association between expanded polymer chains resulting in a gel formation and an increase in viscosity and attractive forces, and
entanglement between the polymer chains, especially at low shear rates and high concentrations, hence increasing the apparent viscosity.

Because they alter the rheology and flow properties of cement mixtures, VMAs are mostly used in combination with a HRWR to achieve highly fluid, yet cohesive cement-based material that can flow easily into place with minimal separation of the various constituents. The mode of action of a VMA depends on the type and concentration of the VMA used, as well as the presence of other admixtures, such as HRWR and air-entraining agent (AEA).

Most of the synthetic VMAs are expensive. This is especially the case for most microbial-based VMAs because of their time-consuming fermentation processes, particularly those associated with the preparation of culture media and the constant supervision of fermentation processes. Despite the technological advances made to facilitate the extraction and recovery processes of these products, their costs remain high compared to other concrete ingredients, especially aggregates and cement.

VMAs' performance is dependent on their compatibility with the cement and HRWR types. Although the use of polysaccharides of microbial origin, such as welan gum, xanthan gum, starch ether, etc., has proved very effective in improving rheology and stability characteristics of cement-based materials. However, their elaboration is delicate and requires large quantities of microbial cultures. Furthermore, their use in combination with HRWR can result in some delay in setting time and strength development, especially at high HRWR dosages.

### Carrageenan

Marine algae contain a large amount of polysaccharides in their cell walls. These polysaccharides constitute broad class of biopolymers derived from green algae, such as ulvans, brown algae, such as alginates, and red algae, such as agar and carrageenan. These algae are available in large quantities and their chemical composition provides them great thickening and gelling properties.

Carrageenans are produced by several species of red algae (or seaweeds), including Chondrus crispus, Kappaphycus alvarezii, and Eucheuma denticulatum, which are the most exploited algae to produce polysaccharides. K. alvarezii is a seaweed that can contain more than 50% of (κ)-carrageenan.

Carrageenan is a biopolymer consisting of long chains of linear sulphated polysaccharides. Carrageenan is a linear polysaccharide. It has a high molecular weight between 100 and 1000 kDa and is composed of repeated sulfated galactose residues. It has interesting physicochemical properties, abundant functional groups, a high-water retention limit, and a high negative charge. It is used in different applications in the pharmaceutical, cosmetic, and food industries. Carrageenan is often used as a thickening/gelling agent in various food and non-food applications.

The most common types of carrageenans are the Kappa (κ), Iota (ι), and Lambda (λ) carrageenans. Many algal gametophytes simultaneously produce (κ)- and (ι)-carrageenan. In chemical terms, (κ)-carrageenan is composed of alternating β(1,4)-D-galactose-4-sulfate (G4S) and α(1,3)-3,6-anhydro-D-galactose (DA) units. The difference between (κ)- and (ι)-carrageenan lies in the fact that (κ)-carrageenan has a sulfate group on carbon 4 (C₄) of β-D-galactopyranose linked in α(1,3) and (ι)-carrageenan has an additional sulfate group on carbon 2 (C₂) of the 3,6-anhydro-α-D-galactopyranose residue linked at (1,4). The separation between these two carrageenans is time consuming and requires additional cost. As a result, these polysaccharides are generally used together. Their combination can enhance the rheological properties because of the nature of gels formed. The use of (κ)-carrageenan can form rigid, hard, and brittle gels, while (ι)-carrageenan can form weak, soft, and thixotropic gels. The (λ)-carrageenan is devoid of the 3,6-anhydro bridge and, consequently, contains three sulphate groups linked to the C₂ of the α(1,3)-D-galactose units and the C₃ and C₆ of the residue linked in 4. Thus, (λ)-carrageenan acts only as a thickening agent.

To date, carrageenans have been used for enhancing some properties in few materials. Previous studies have indeed shown that the use of (κ)-carrageenan is much more effective than xanthan gum in increasing the early-age compressive strength of blended fly ash/glass powder mortars. Furthermore, the use of carrageenan at low dosage led to a significant increase in the early-age compressive strength of alkali-activated fly ash/glass powder systems. Furthermore, a recent study showed that chemically modified (κ)-carrageenan used as a superabsorbent agent contributed in reducing the autogenous shrinkage in low water to cement ratio (w/c) concrete.

### SUMMARY OF THE INVENTION

In accordance with the present invention, there is provided:
1. Use of carrageenan as a viscosity-modifying admixture in a flowable cementitious suspension.
2. A viscosity-modifying admixture for a flowable cementitious suspension, the viscosity-modifying admixture comprising carrageenan.
3. A method of modifying the viscosity of a flowable cementitious suspension, the method comprising adding carrageenan as a viscosity-modifying admixture to the flowable cementitious suspension.
4. A dry cementitious composition comprising carrageenan as a viscosity-modifying admixture.
5. The dry cementitious composition of item 4, being for producing a flowable cementitious suspension.
6. The dry cementitious composition of item 4 or 5, wherein the dry cementitious composition comprises:
   from about 40% to about 80, preferably from about 40% to about 60%, and more preferably about 45% of sand;
   from about 0% to about 50%, preferably from about 0% to 40%, and more preferably about 35% of aggregates;
   from about 10% to about 40%, preferably less than 40%, and more preferably about 25 +2% of cement;
   from about 0.04% to about 0.6%, preferably from about 0.05% to about 0.3%, and more preferably about 0.1% of a superplasticizer; and
   from about 0.04% to about 0.25%, preferably from about 0.04% to about 0.09%, and more preferably less than 0.09% of carrageenan,
all percentages being w/w % based on the total weight of the dry cementitious composition.
7. The dry cementitious composition of any one of items 4 to 6, being for producing a self-leveling flowable cementitious suspension.
8. The dry cementitious composition of item 7, wherein the self-leveling flowable cementitious suspension is grout or mortar for self-leveling flooring, crack injection, or anchorage sealing.
9. The dry cementitious composition of item 7 or 8, being free coarse aggregates (such as gravel).
10. The dry cementitious composition of item 9, comprising:
from 60 to 80% of sand,
   from 20 to 40% of cement,
   from 0.08 to 0.6%, preferably from 0.1% to 0.4%, of a superplasticizer, and
   from about 0.06% to 0.25% of carrageenan,
all percentages being w/w % based on the total weight of the dry cementitious composition.
11. The dry cementitious composition of item 10, wherein the sand has a maximum size of about 5 mm.
12. The dry cementitious composition of item 10 or 11, wherein the sand is siliceous sand.
13. The dry cementitious composition of any one of items 10 to 12, further comprising one or more of hydrated calcium sulphate, a natural or synthetic anhydrite, a biocide, an antifoam agent, a redispersible resin, or another conventional additive.
14. The dry cementitious composition of any one of items 4 to 6, being for producing a self-consolidating flowable cementitious suspension.
15. The dry cementitious composition of item 14, wherein the self-consolidating flowable cementitious suspension is a flowable concrete.
16. The dry cementitious composition of item 14 or 15, comprising:
   from 40 to 60% of sand,
   from 30 to 50% of aggregates,
   from 10 to 40% of cement
   from 0.05 to 0.4%, more preferably from 0.07 to 0.3%, of a superplasticizer, and
   from about 0.04% to 0.16% of carrageenan,
all percentages being w/w % based on the total weight of the dry cementitious composition.
17. The dry cementitious composition of any one of items 14 to 16, further comprising a mineral addition and/or another conventional additive.
18. The dry cementitious composition of item 17, wherein the mineral addition is one or more of fly ash, ground limestone filler, silica fume, blast furnace slag, or glass powder.
19. The dry cementitious composition of any one of items 15 to 18, wherein the total volume of powder material having a size up to 0.075 mm is between about 320 to about 500 kg/m³.
20. The dry cementitious composition of any one of items 4 to 19, wherein the superplasticizer is a sulfonated melamine-formaldehyde, a sulfonated naphthalene-formaldehyde, or a polycarboxylate ether, preferably a sulfonated naphthalene-formaldehyde or a polycarboxylate, and more preferably a polycarboxylate.
21. A flowable cementitious suspension comprising carrageenan as a viscosity-modifying admixture.
22. The flowable cementitious suspension of item 21, comprising the dry cementitious composition of any one of items 4 to 20 and water.
23. The flowable cementitious suspension of item 22, having a water-to-cement ratio, by weight, of from 0.40 to 0.60, preferably from about 0.42 to 0.55.
24. The flowable cementitious suspension of any one of items 21 to 23, being a self-leveling flowable cementitious suspension.
25. The flowable cementitious suspension of item 24, being grout or mortar for self-leveling flooring, crack injection, or and anchorage sealing.
26. The flowable cementitious suspension any one of items 21 to 23, being a self-consolidating flowable cementitious suspension.
27. The flowable cementitious suspension of item 26, being a flowable concrete.
28. The use/admixture/method/composition/suspension of any one of items 1 to 27, wherein the carrageenan is Kappa (κ), Iota (ι), or Lambda (λ) carrageenan or any mixture thereof; preferably (κ)-carrageenan or a mixture of (ι)-carrageenan and (κ)-carrageenan; and more preferably (κ)-carrageenan.
29. The use/admixture/method/composition/suspension of any one of items 1 to 28, wherein the carrageenan is provided in the form of a algae powder, preferably a red algae powder such as a Chondrus crispus, Kappaphycus alvarezii or Eucheuma denticulatum powder, more preferably a Kappaphycus alvarezii powder.

30. The use/admixture/method/composition/suspension of item 29, wherein the seaweed powder comprises dried and ground algae.

### BRIEF DESCRIPTION OF THE DRAWINGS

In the appended drawings:

FIG. 1. shows the effect of (κ)-carrageenan dosage on the apparent viscosity of cement-paste mixtures at low and high-shear rates.

FIG. 2 shows the flow curves of cement-paste mixtures containing different dosages of (κ)-carrageenan corresponding to 0.5, 1.0, and 1.5%, by mass of water.

FIG. 3 shows the variation of the apparent viscosity of cement-paste mixtures containing different dosages of (κ)-carrageenan corresponding to 0.5, 1.0, and 1.5%, by mass of water.

FIG. 4 shows the flow curves for cement-paste mixtures containing an equal dosage of 0.5% (κ)-carrageenan and welan gum, by the mass of water.

FIG. 5 shows the variation of plastic viscosity and yield stress of cement-paste mixtures with (κ)-carrageenan dosages.

FIG. 6 shows the variation of the yield stress and plastic viscosity values of cement-paste mixtures containing an equal dosage of 0.5% of (κ)-carrageenan and welan gum, by mass of water.

FIG. 7 shows the variation of viscoelastic properties (G′: filled symbols; G″: empty symbols) of cement-paste mixtures with (κ)-carrageenan.

FIG. 8 shows the variations of G′ (filled symbols) and G″ (empty symbols) of cement-paste mixtures with the VMA type.

FIGS. 9 and 10 show the flow curves of cement suspensions made with different dosages of (κ)-carrageenan corresponding to 0.5, 1.0, and 1.5%, by mass of water, in combination with two HRWR types: FIG. 9 combination with PC HRWR and FIG. 10 combination with PNS1 HRWR.

FIGS. 11 and 12 show the variation of the apparent viscosity with shear rate for cement suspensions made with different dosages of (κ)-carrageenan corresponding to 0.5, 1.0, and 1.5%, by mass of water, in combination with two HRWR types: FIG. 11 combination with PC HRWR and FIG. 12 combination with PNS1 HRWR.

FIG. 13 shows the variation of the yield stress for cement suspensions made with different dosages of (κ)-carrageenan corresponding to 0.5, 1.0, and 1.5%, by mass of water, PC and PNS1 HRWR types.

FIG. 14 shows the variation of plastic viscosity for cement suspensions made with different dosages of (κ)-carrageenan corresponding to 0.5, 1.0, and 1.5%, by mass of water, PC and PNS1 HRWR types.

FIGS. 15 and 16 show the variations of viscoelastic properties (G′: filled symbols; G″: empty symbols) of cement suspensions made with different dosages of (κ)-carrageenan corresponding to 0.5, 1.0 and 1.5%, by mass of water, in combination with two HRWR types: FIG. 15 combination with PC HRWR and FIG. 16 combination with PNS1 HRWR.

FIG. 17 shows the evolution of the phase angle (δ) and storage modulus (G′) of cement-paste mixtures containing different dosages of (κ)-carrageenan corresponding to 0.5, 1.0, and 1.5%, by mass of water.

FIG. 18 shows the values of the G_{rigid.} of cement suspensions made with different dosages of (κ)-carrageenan corresponding to 0.5, 1.0, and 1.5%, by mass of water, PC and PNS1 HRWR.

FIG. 19 shows the values of the t_{perc.} of cement suspensions made with different dosages of (κ)-carrageenan corresponding to 0.5, 1.0, and 1.5%, by mass of water, PC and PNS1 HRWR.

FIGS. 20 and 21 show the evolution of the phase angle (δ) and storage modulus (G′) of cement suspensions made with different dosages of (κ)-carrageenan corresponding to 0.5, 1.0, and 1.5%, by mass of water, in combination with two HRWR types: FIG. 20 combination with PC HRWR and FIG. 21 combination with PNS1 HRWR.

FIG. 22 shows the variation of G_{rigid.} values of cement paste-mixtures with the VMA type.

FIG. 23 shows the relative forced bleeding of cement-paste mixtures made with different dosages of (κ)-carrageenan corresponding to 0.5, 1.0, and 1.5%, by mass of water.

FIGS. 24 and 25 show the forced bleeding of cement suspensions made with different (κ)-carrageenan dosages corresponding to 0.5, 1.0, and 1.5%, by mass of water, in combination with two HRWR types: FIG. 24 combination with PC HRWR and FIG. 25 combination with PNS1 HRWR.

FIG. 26 shows the effect of (κ)-carrageenan dosage on the heat flow of cement paste-mixtures.

FIG. 27 shows the effect of (κ)-carrageenan and welan gum on the heat of hydration of cement-paste mixtures.

FIGS. 28 and 29 show the effect of (κ)-carrageenan dosage on the heat flow of cement suspensions made with two HRWR types: FIG. 18 cement suspension with PC HRWR and FIG. 29 cement suspension with PNS1 HRWR.

FIGS. 30 and 31 show the compressive strength of cement suspensions containing different dosages of (κ)-carrageenan corresponding to 0.5, 1.0, and 1.5%, by mass of water, PC and PNS1 HRWR after hardening: FIG. 30 after 24 h of hardening and FIG. 31 after 7 days of hardening.

FIG. 32 shows the flow curves of cement-paste mixtures containing different dosages of (κ)-(ι)-carrageenan corresponding to 0.5, 1.0, and 1.5%, by mass of water.

FIG. 33 shows the variation of the apparent viscosity of cement-paste mixtures containing different dosages of (κ)-(ι)-carrageenan corresponding to 0.5, 1.0, and 1.5%, by mass of water.

FIG. 34 shows the variation of plastic viscosity and yield stress of cement-paste mixtures with (κ)-(ι)-carrageenan dosages (0.5, 1.0, and 1.5%, by mass of water).

FIG. 35 shows the impact of different dosages of (κ)-(ι)-carrageenan (0.5, 1.0, and 1.5%, by mass of water) on the variations in the viscoelastic properties of cement-paste mixtures (G′: filled symbols; G″: empty symbols).

FIGS. 36, 37, and 38 show the flow curves of cement suspensions made with different dosages of (κ)-(ι)-carrageenan corresponding to 0.5, 1.0, and 1.5%, by mass of water, in combination with different HRWR: FIG. 36 combination with PC; FIG. 37 combination with PNS1; and FIG. 38 combination with PNS2.

FIGS. 39, 40, and 41 show the variations of the apparent viscosity with the shear rate for cement suspensions proportioned with different dosages of (κ)-(ι)-carrageenan corresponding to 0.5, 1.0, and 1.5%, by mass of water, in combination with different HRWR: FIG. 39 combination with PC; FIG. 40 combination with PNS1; and FIG. 41 combination with PNS2.

FIG. 42 shows the variation of yield stress of cement suspensions made with different dosages of (κ)-(ι)-carrageenan corresponding to 0.5, 1.0, and 1.5%, by mass of water, and HRWRs (PC, PNS1, and PNS2).

FIG. 43 shows the variation of plastic viscosity of cement suspensions made with different dosages of (κ)-(ι)-carrageenan corresponding to 0.5, 1.0, and 1.5%, by mass of water, and HRWRs (PC, PNS1, and PNS2).

FIGS. 44, 45 and 46 show the variations of storage modulus (G′) (filled symbols) and loss modulus (G″) (empty symbols) of cement suspensions made with different dosages of (κ)-(ι)-carrageenan corresponding to 0.5, 1.0, and 1.5%, by mass of water, combined with HRWRs: FIG. 44 combination with PC; FIG. 45 combination with PNS1; and FIG. 46 combination with PNS2.

FIG. 47 shows the evolution of the phase angle (δ) and storage modulus (G′) of cement-paste mixtures containing different dosages of (κ)-(ι)-carrageenan corresponding to 0.5, 1.0, and 1.5%, by mass of water.

FIG. 48 shows the values of the G_{rigid.} of cement suspensions made with different dosages of (κ)-(ι)-carrageenan corresponding to 0.5, 1.0, and 1.5%, by of water, and HRWRs (PC, PNS1, and PNS2).

FIG. 49 shows the values of the t_{perc.} of cement suspensions made with different dosages of (κ)-(ι)-carrageenan corresponding to 0.5, 1.0, and 1.5%, by of water, and HRWRs (PC, PNS1, and PNS2).

FIGS. 50, 51, and 52 show the evolution of the phase angle (δ) and storage modulus (G′) of cement suspensions made with different dosages of (κ)-(ι)-carrageenan corresponding to 0.5, 1.0, and 1.5%, by mass of water, and HRWR types: in FIG. 50, the HRWR was PC; in FIG. 51, the HRWR was PNS1; and in FIG. 52, the HRWR was PNS2.

FIG. 53 shows the effect of (κ)-(ι)-carrageenan dosage (0.5, 1.0 and, 1.5%, by mass of water) on the heat flow of the investigated cement-paste mixtures.

FIGS. 54, 55, and 56 show the effect of (κ)-(ι)-carrageenan dosage (0.5, 1.0, and 1.5%, by mass of water) on the heat flow of cement suspensions made with HRWRs: in FIG. 54, the HRWR was PC; in FIG. 55, the HRWR was PNS1; and in FIG. 56, the HRWR was PNS2.

FIGS. 57 and 58 show the compressive strength of cement suspensions containing different dosages of (κ)-(ι)-carrageenan (0.5, 1.0, and 1.5%, by mass of water) in combination with HRWRs (PC, PNS1, and PNS2) after hardening: FIG. 57 shows the compressive strength after 24 h and FIG. 58 shows the compressive strength after 7 days.

FIG. 59 shows the experimental program of K. alvarezii seaweed powder cooking parameters optimization: particles ≤160 μm and ≤100 μm, dosages of 1.5 and 3.0%, stirring times of 30 and 60 min, temperatures of 23, 40, and 80° C., and storage modes (without storage, stored for 24 h at room temperature or at 8° C.).

FIG. 60 is a low-resolution Scanning Electron Microscopy (SEM) image of the commercial (κ)-carrageenan particles

FIG. 61 is a high-resolution SEM image of the commercial (κ)-carrageenan particles

FIG. 62 is a low-resolution SEM image of the coarse fraction of K. alvarezii

FIG. 63 is a high-resolution SEM image of the coarse fraction of K. alvarezii

FIG. 64 is a low-resolution SEM image of the fine fraction of K. alvarezii

FIG. 65 is a high-resolution SEM image of the fine fraction of K. alvarezii

FIGS. 66 and 67 show the Energy Dispersion Spectrometry (EDS) spectra of (κ)-carrageenan particles from various points: FIG. 66 shows the spectrum from point 1 (labelled “Spectrum 1” on FIG. 61) and FIG. 67 shows the spectrum from point 2 (labelled “Spectrum 2” on FIG. 62).

FIGS. 68 and 69 show the EDS spectra of K. alvarezii particles (coarse fraction) from various points: FIG. 68 shows the spectrum from point 1 (labelled “Spectrum 1” on FIG. 63) and FIG. 69 shows the spectrum from point 2 (labelled “Spectrum 2” on FIG. 63).

FIGS. 70 and 71 show the EDS spectra of K. alvarezii particles (fine fraction) from various points: FIG. 70 shows the spectrum from point 1 (labelled “Spectrum 1” on FIG. 65) and FIG. 71 shows the spectrum from point 2 (labelled “Spectrum 2” on FIG. 65).

FIGS. 72, 73, 74, 75, 76, and 77 show the flow curves of unheated aqueous solutions containing different dosages of K. alvarezii seaweed powder (fractions ≤160 μm and ≤100 μm), tested under various conditions: FIG. 72 shows the flow curves for 1.5% and 3.0% w/w of K. alvarezii seaweed coarse fraction powder solution, directly tested; FIG. 73 shows the flow curves for 1.5% and 3.0% w/w of K. alvarezii seaweed fine fraction powder solution, directly tested; FIG. 74 shows the flow curves for 1.5% and 3.0% w/w of K. alvarezii seaweed coarse fraction powder solution, tested after storage at room temperature; FIG. 75 shows the flow curves for 1.5% and 3.0% w/w of K. alvarezii seaweed fine fraction powder solution, tested after storage at room temperature; FIG. 76 shows the flow curves for 1.5% and 3.0% w/w of K. alvarezii seaweed coarse fraction powder solution, tested after storage at 8° C.; FIG. 77 shows the flow curves for 1.5% and 3.0% w/w of K. alvarezii seaweed fine fraction powder solution, tested after storage at 8° C.

FIGS. 78, 79, 80, 81, 82, and 83 show the flow curves of aqueous solutions (heated at 40° C.) containing different dosages of K. alvarezii seaweed powder (fractions ≤160 μm and ≤100 μm), tested under various conditions: FIG. 78 shows the flow curves for 1.5% and 3.0% w/w of K. alvarezii seaweed coarse fraction powder solution, directly tested; FIG. 79 shows the flow curves for 1.5% and 3.0% w/w of K. alvarezii seaweed fine fraction powder solution, directly tested; FIG. 80 shows the flow curves for 1.5% and 3.0% w/w of K. alvarezii seaweed coarse fraction powder solution, tested after storage at room temperature; FIG. 81 shows the flow curves for 1.5% and 3.0% w/w of K. alvarezii seaweed fine fraction powder solution, tested after storage at room temperature; FIG. 82 shows the flow curves for 1.5% and 3.0% w/w of K. alvarezii seaweed coarse fraction powder solution, tested after storage at 8° C.; FIG. 83 shows the flow curves for 1.5% and 3.0% w/w of K. alvarezii seaweed fine fraction powder solution, tested after storage at 8° C.

FIGS. 84 and 85 show the flow curves of aqueous solutions (heated at 80° C.) containing various dosages of K. alvarezii seaweed powder (fractions ≤160 μm and ≤100 μm), tested under various conditions: FIG. 84 shows the flow curves for 1.5% and 3.0% w/w of K. alvarezii seaweed coarse fraction powder solution, directly tested; FIG. 85 shows the flow curves for 1.5% and 3.0% w/w of K. alvarezii seaweed powder solution, directly tested.

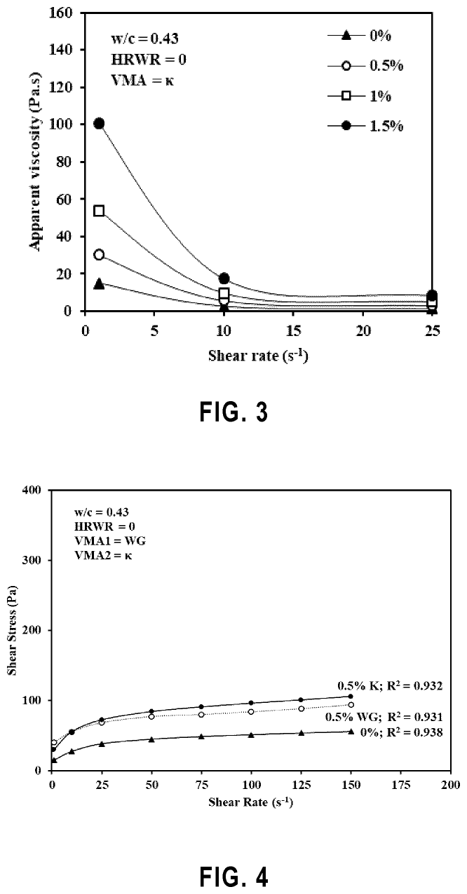

FIGS. 3.86, 87, 88, 89, 90, and 91 show the variation of the yield stress and plastic viscosity values of unheated aqueous solutions containing different dosages of K. alvarezii seaweed powder (fractions ≤160 μm and ≤100 μm), tested under various conditions: FIG. 86 shows the variation of the yield stress and plastic viscosity values for 1.5% and 3.0% w/w of K. alvarezii seaweed coarse fraction powder solution, directly tested; FIG. 87 shows the variation of the yield stress and plastic viscosity values for 1.5% and 3.0% w/w of K. alvarezii seaweed fine fraction powder solution, directly tested; FIG. 88 shows the variation of the yield stress and plastic viscosity values for 1.5% and 3.0% w/w of K. alvarezii seaweed coarse fraction powder solution, tested after storage at room temperature; FIG. 89 shows the variation of the yield stress and plastic viscosity values for 1.5% and 3.0% w/w of K. alvarezii seaweed fine fraction powder solution, tested after storage at room temperature; FIG. 90 shows the variation of the yield stress and plastic viscosity values for 1.5% and 3.0% w/w of K. alvarezii seaweed coarse fraction powder solution, tested after storage at 8° C.; FIG. 91 shows the variation of the yield stress and plastic viscosity values for 1.5% and 3.0% w/w of K. alvarezii seaweed fine fraction powder solution, tested after storage at 8° C.

FIGS. 92, 93, 94, 95, 96, and 97 show the variation of the yield stress and plastic viscosity values of aqueous solutions (heated at 40° C.) containing different dosages of K. alvarezii seaweed powder (fractions ≤160 μm and ≤100 μm), tested under various conditions: FIG. 92 shows the variation of the yield stress and plastic viscosity values for 1.5% and 3.0% w/w of K. alvarezii seaweed coarse fraction powder solution, directly tested; FIG. 93 shows the variation of the yield stress and plastic viscosity values for 1.5% and 3.0% w/w of K. alvarezii seaweed fine fraction powder solution, directly tested; FIG. 94 shows the variation of the yield stress and plastic viscosity values for 1.5% and 3.0% w/w of K. alvarezii seaweed coarse fraction powder solution, tested after storage at room temperature; FIG. 95 shows the variation of the yield stress and plastic viscosity values for 1.5% and 3.0% w/w of K. alvarezii seaweed fine fraction powder solution, tested after storage at room temperature; FIG. 96 shows the variation of the yield stress and plastic viscosity values for 1.5% and 3.0% w/w of K. alvarezii seaweed coarse fraction powder solution, tested after storage at 8° C.; FIG. 97 shows the variation of the yield stress and plastic viscosity values for 1.5% and 3.0% w/w of K. alvarezii seaweed fine fraction powder solution, tested after storage at 8° C.

FIGS. 98 and 99 show the variation of the yield stress and plastic viscosity values of aqueous solutions (heated at 80° C.) containing different dosages of K. alvarezii seaweed powder (fractions ≤160 μm and ≤100 μm), tested under various conditions: FIG. 98 shows the variation of the yield stress and plastic viscosity values for 1.5% and 3.0% w/w of K. alvarezii seaweed coarse fraction powder solution, directly tested; FIG. 99 shows the variation of the yield stress and plastic viscosity values for 1.5% and 3.0% w/w of K. alvarezii seaweed fine fraction powder solution, directly tested.

FIG. 100 shows the flow curves of aqueous solutions containing different dosages of (κ)-carrageenan powder corresponding to 0.5, 1.0, and 1.5% w/w.

FIG. 101 shows the variation of the yield stress and plastic viscosity values of aqueous solutions containing different dosages of (κ)-carrageenan powder corresponding to 0.5, 1.0, and 1.5% w/w.

FIGS. 102, 103, and 104 show the flow curves of cement-paste mixtures proportioned with different solutions containing different dosages of K. alvarezii seaweed powder corresponding to 0.25, 0.50, and 0.75%, by mass of water, tested under various conditions: FIG. 102 solutions directly tested; FIG. 103 solutions pre-hydrated for 24 h at room temperature; and FIG. 104 solutions pre-hydrated for 24 h at 8° C.

FIGS. 105, 106, and 107 show the variation of the yield stress and plastic viscosity values of the cement-paste mixtures proportioned with different solutions containing different dosages of K. alvarezii seaweed powder corresponding to 0.25, 0.50, and 0.75%, by mass of water, tested under various conditions: FIG. 105 solutions directly tested; FIG. 106 solutions pre-hydrated for 24 h at room temperature; and FIG. 107 solutions pre-hydrated for 24 h at 8° C.

FIGS. 108, 109, and 110 show the variations of the viscoelastic properties (G′: filled symbols and G″: empty symbols) of cement-paste mixtures proportioned with different solutions containing different dosages of K. alvarezii seaweed powder corresponding to 0.25, 0.50, and 0.75%, by mass of water, tested under various conditions: FIG. 108 solutions directly tested; FIG. 109 solutions pre-hydrated for 24 h at room temperature; and FIG. 110 solutions pre-hydrated for 24 h at 8° C.

FIGS. 111, 112, and 113 show the variation of maximum rigidity and critical shear strain of cement-paste mixtures proportioned with different solutions containing different dosages of K. alvarezii seaweed powder corresponding to 0.25, 0.50, and 0.75%, by mass of water, tested under various conditions: FIG. 111 solutions directly tested; FIG. 112 solutions pre-hydrated for 24 h at room temperature; and FIG. 113 solutions pre-hydrated for 24 h at 8° C.

FIGS. 114, 115, and 116 show the variation of the shear stress-strain of cement-paste mixtures proportioned with different solutions containing different dosages of K. alvarezii seaweed powder corresponding to 0.25, 0.50, and 0.75%, by mass of water, tested under various conditions: FIG. 114 solutions directly tested; FIG. 115 solutions pre-hydrated for 24 h at room temperature; and FIG. 116 solutions pre-hydrated for 24 h at 8° C.

FIGS. 117, 118, and 119 show the values of the G_{rigid.} and t_{perc.} of cement-pastes mixtures proportioned with different solutions containing different dosages of K. alvarezii seaweed powder corresponding to 0.25, 0.50, and 0.75%, by mass of water, tested under various conditions: FIG. 117 solutions directly tested; FIG. 118 solutions pre-hydrated for 24 h at room temperature; and FIG. 119 solutions pre-hydrated for 24 h at 8° C.

FIG. 120 shows the relative forced bleeding of cement-paste mixtures prepared from non-prehydrated solutions containing different dosages of K. alvarezii seaweed powder corresponding to 0.25, 0.50, and 0.75%, by mass of water.

FIG. 121 shows the effect of different dosages of K. alvarezii seaweed powder corresponding to 0.25, 0.50, and 0.75%, by mass of water, on the hydration kinetics of cement-paste mixtures.

### DETAILED DESCRIPTION OF THE INVENTION

Turning now to the invention in more details, there is provided the use of carrageenan as a viscosity-modifying admixture (VMA) in a flowable cementitious suspension.

It has been found that carrageenan can advantageously be used as a viscosity-modifying admixture in flowable cementitious suspensions.

Herein, “flowable cementitious suspensions” indicates a cement-based composition that can be cast without consolidation and vibration. Flowable cementitious suspensions can be used, for example, to make self-levelling floorings that can be poured on uneven grounds to provide by themselves an even surface, where, for example, tiles or parquet can be laid. A typical example of flowable cementitious suspensions is flowable concrete, such as self-consolidating concrete (SCC). SCC is a non-segregating concrete that can spread into place, adequately fill formwork, and encapsulate reinforcements without any mechanical vibration. High-performance cement grouts used for crack injection and anchorage sealing are other examples of a flowable cementitious suspension. Flowable cementitious suspensions contain superplasticizers (also called high-range water-reducers, HRWR) that are essential to impart the required fluidity and self-consolidating properties without excessively increasing the need of water. Superplasticizers provide flowability, but do not impart resistance to segregation (denser aggregates descending downward) and bleeding (formation of a layer of surface water). Viscosity modifying admixtures (VMAs) are therefore used to (at least) enhance the cohesion and stability of these cement-based systems. VMA can also be used to modify thixotropy of flowable cementitious suspensions given the application on hand.

The present inventors have shown that carrageenan improves the rheological properties and the stability of flowable cementitious suspensions as well as their mechanical resistance. It is a particularly advantageous feature of the invention that the carrageenan does not compromise (or only minimally compromise) the mechanical performances of the cementitious compositions after they have set as other VMAs are known to do.

The mode of action of carrageenan is based on the absorption of free water in the matrix, which modifies its rheology and improves its stability. This biopolymer forms a three-dimensional network in the cement matrix by crosslinking between chains due to the presence of potassium ions (K⁺). Carrageenan acts with the K⁺ ions, present in cementitious materials, to stabilize the junction areas in the brittle gel.

The examples below report the following for carrageenan (either (κ)-carrageenan alone or mixed with (ι)-carrageenan, or carrageenan provided as a seaweed powder):
The cement suspensions containing (κ)-carrageenan showed a pseudoplastic behavior in which the apparent viscosity decreases with the shear rate, hence facilitating the flow behavior under shear such as pumping. At low shear rate (i.e. at rest), the rapid recovery of the viscosity is essential for better stability of the suspension. This behavior is more pronounced with increasing of (κ)-carrageenan dosage. This property can largely facilitate several construction site operations, such us pumpability and placing of SCC.
An increase in (κ)-carrageenan dosage increased the apparent viscosity, both at high and low shear rates, in an almost linear fashion, regardless of the HRWR type. This means that the (κ)-carrageenan can maintain good stability of the cement system even in the presence of HRWR under both static (i.e. after placement) and dynamic conditions (i.e. during the transport and pumping of flowable composition).
The use of (κ)-carrageenan enhanced the plastic viscosity and yield stress values of cement-paste mixtures. The use of a (κ)-(ι)-carrageenan combination resulted in even higher plastic viscosity than that of (κ)-carrageenan, especially at low dosage of (κ)-(ι)-carrageenan. This allows reducing the cost product while offering an obvious economic advantage.
Cement suspensions containing (κ)-carrageenan in combination with HRWR showed a decrease of the linear viscoelastic domain (LVED) with the (κ)-carrageenan dosage. The incorporation of a (κ)-(ι)-carrageenan combination increased the rigidity but decreased the length of the LVED of cement suspensions containing HRWRs. This is probably due to the effect of filling the intergranular space and the densification of the cement matrix.
The cement suspensions containing the (κ)-carrageenan with or without HRWR showed a significant evolution in the structural build-up kinetics. This resulted in greater rigidity of the formed network. The incorporation of a (κ)-(ι)-carrageenan combination also increased the structural build-up kinetics of cement suspensions. This confirms that (κ)- and (ι)-carrageenans exhibit a higher thixotropic effect, which makes it more preferred in the case of SCC destined to reduce the lateral pressure exerted on the formwork.
All the tested dosages of (κ)-carrageenan led to substantial enhancement in the resistance to forced bleeding, especially in the presence of HRWR, while providing better stability. This property allows (κ)-carrageenan to be used as an anti-washout admixture in injective grouts to repair cracks in underwater structures.
Cement suspensions containing the (κ)-carrageenan showed a more prolonged induction period than that of the reference mixture, regardless of the (κ)-carrageenan dosage and HRWR type used. However, compared to (κ)-carrageenan, the (κ)-(ι)-carrageenan combination reduced the duration of the dormant period, which largely corrects the setting time delay when (κ)-carrageenan is used.
The addition of (κ)-carrageenan resulted in an increase in compressive strength, regardless of the dosage of (κ)-carrageenan used. The use of (κ)-(ι)-carrageenan resulted in even higher compressive strength compared to (κ)-carrageenan.

Therefore, in various aspects of the present invention, there is provided:
the use of carrageenan as a viscosity-modifying admixture in a flowable cementitious suspension;
a viscosity-modifying admixture for flowable cementitious suspensions, the viscosity-modifying admixture comprising carrageenan;
a method for modifying the viscosity of a flowable cementitious suspension, the method comprising adding carrageenan as a viscosity-modifying admixture to the flowable cementitious suspension;
a dry cementitious composition (for producing a flowable cementitious suspension) comprising carrageenan as a viscosity-modifying admixture; and
a flowable cementitious suspension comprising carrageenan as a viscosity-modifying admixture.

In embodiments, the carrageenan can be Kappa (κ), Iota (ι), or Lambda (λ) carrageenan or any mixture thereof. Preferably, the carrageenan is (κ)-carrageenan or a mixture of (ι)-carrageenan and (κ)-carrageenan and more preferably it is (κ)-carrageenan.

In embodiments, the carrageenan is provided in the form of a algae powder, preferably a red algae powder such as a Chondrus crispus, Kappaphycus alvarezii or Eucheuma denticulatum powder, more preferably a Kappaphycus alvarezii powder. In embodiments, the seaweed powder is prepared by drying and grinding the algae. The use of algae powder in the invention is advantageous as it significantly reduces the cost (compared to refined carrageenan and other conventional VMAs).

The use of (κ)-carrageenan either extracted from algae or as part of algae powder allows the exploitation of otherwise unused and abundant algae, which constitutes an environmental burden. This also offers an affordable alternative to chemically synthesized VMAs which have high production cost.

The use of (κ)-carrageenan either extracted from algae or as part of algae powder helps reduce the environmental impacts of cement manufacturing, in particular those associated with climate change, the quality of ecosystems, and human health. It further contributes to the development of more sustainable construction materials a smaller environmental footprint.

The dry cementitious composition of the invention is a composition for producing a flowable cementitious suspension. This means that a flowable cementitious suspension can be obtained by adding an appropriate water amount to the dry cementitious composition.

In embodiments, the flowable cementitious suspension comprises the dry cementitious compositions mixed with water. In more preferred embodiments, the flowable cementitious suspension has a water-to-cement ratio, by weight, of from 0.40 to 0.60, preferably from about 0.42 to 0.55.

The cementitious flowable compositions is typically prepared from the dry cementitious composition by adding gradually said dry cementitious composition to water and mixing.

In embodiments, the dry cementitious composition comprises:
from about 40% to about 80%, preferably from about 40% to about 60%, and more preferably about 45% of sand;
from about 0% to about 50%, preferably from about 0% to 40%, and more preferably about 35% of aggregates;
from about 10% to about 40%, preferably less than 40%, and more preferably about 25±2% of cement;
from about 0.04% to about 0.6%, preferably from about 0.05% to about 0.3%, and more preferably about 0.1% of a superplasticizer; and
from about 0.04% to about 0.25%, preferably from about 0.04% to about 0.09%, and more preferably less than 0.09% of carrageenan,
   all percentages being w/w % based on the total weight of the dry cementitious composition.

When the dry cementitious composition and the flowable cementitious suspensions of the invention are for self-leveling grouts or mortars for different applications, such self-leveling flooring, crack injection and anchorage sealing, they are free coarse aggregates e.g. aggregates having a size greater than about 5 mm (such as gravel), and sand is rather used instead. Hence, the dry cementitious composition useful for preparing self-leveling flowable cementitious suspensions is free of aggregates and preferably comprises:
from 60 to 80% of sand,
from 20 to 40% of cement,
from 0.08 to 0.6%, preferably from 0.1% to 0.4%, of a superplasticizer, and
from about 0.06% to 0.25% of carrageenan,
   all percentages being w/w % based on the total weight of the dry cementitious composition. In preferred embodiments, the sand has a maximum size of about 5 mm. In preferred embodiments, the sand is siliceous sand. In embodiments, these dry cementitious compositions and flowable cementitious suspensions may further comprise hydrated calcium sulphate, natural or synthetic anhydrites, biocides, antifoam agents, redispersible resins and other conventional additives well known in the art.

When the dry cementitious composition and the flowable cementitious suspensions of the invention are for self-consolidating applications (e.g. flowable concrete), coarser aggregates (such as gravel) are present. Hence, the dry cementitious compositions useful for preparing these flowable cementitious suspensions preferably comprises:
from 40 to 60% of sand,
from 30 to 50% of aggregates,
from 10 to 40% of cement,
from 0.05 to 0.4%, more preferably from 0.07 to 0.3%, of a superplasticizer, and
from about 0.04% to 0.16% of carrageenan,
   all percentages being w/w % based on the total weight of the dry cementitious composition. These flowable cementitious suspensions may further contain mineral additions and other conventional additives. Typical optional mineral additions are fly ash, ground limestone filler, silica fume, blast furnace slag, glass powder, etc. In these flowable cementitious suspensions, the total volume of powder material (i.e. have maximum size of 0.075 mm, including cement, optional mineral additions, and the finest particles of sand) is preferably in the range of about 320 to about 500 kg/m³.

In all of the above, the superplasticizer may be any superplasticizer (also called high-range water-reducer (HRWR)) known in the art to be useful in flowable cementitious suspensions. Non-limiting examples of superplasticizers include sulfonated melamine-formaldehyde, sulfonated naphthalene-formaldehyde, and polycarboxylate ethers. Preferred superplasticizers include sulfonated naphthalene-formaldehyde and polycarboxylate, and more preferably polycarboxylate.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—(κ)-Carrageenan Effect on Rheology, Stability and Mechanical Performances of Cement-Based Materials

An experimental investigation was carried out to evaluate the performance of (κ)-carrageenan used as a viscosity-modifying admixture (VMA) in cement-based materials. Rheology, viscoelastic properties, structural build-up kinetics, forced bleeding, cement hydration kinetics, and compressive strength of cement suspensions proportioned with a relatively a high water to cement ratio (w/c) of 0.43 and a general use (GU) Portland cement were evaluated. The effect of different dosages of (κ)-carrageenan corresponding to 0.5, 1.0, and 1.5%, by mass of water, was evaluated. Furthermore, its effect in presence of two different high-range water-reducer (HRWR) types: a polynaphthalene sulfonate-(PNS1) and a polycarboxylate-(PC) based HRWR was also evaluated.

When incorporated in cement paste, the use of (κ)-carrageenan led to higher yield stress and plastic viscosity, shear-thinning response and greater resistance to forced bleeding compared to reference mixture made without (κ)-carrageenan. On the other hand, when used in combination with HRWR, linear Bingham behavior, lower yield stress and plastic viscosity was shown, regardless of the dosage of (κ)-carrageenan. Indeed, the mixture incorporating of PC type resulted in a significant decrease in the yield stress compared to those made with PNS1type. However, the use of PNS1 in conjunction with (κ)-carrageenan resulted in the lowest plastic viscosity, regardless of the dosage of (κ)-carrageenan than the addition of the PC. Furthermore, the use of (κ)-carrageenan in combination with HRWR resulted in further decrease in forced bleeding. This improvement is due to both the absorption of water by the (κ)-carrageenan and the improvement in dispersion of the system due to the presence of HRWR.

In the case of hydration kinetics, the presence of (κ)-carrageenan prolonged the induction period regardless of the dosage of (κ)-carrageenan used. This delay in the dormant period can be referred to a decrease in the concentration of the Na⁺, Ca²⁺, and K⁺ ions necessary to initiate the acceleration period. The addition of PC HRWR to mixtures containing (κ)-carrageenan extended the duration of the dormant period.

In the case of compressive strength, the mixture containing 0.5% of (κ)-carrageenan showed the highest compressive strength. This increase in compressive strength with a low dosage of (κ)-carrageenan is probably due to the adhesion mechanism between the cement particles because of the presence of (κ)-carrageenan, its gelling properties and its ability to form a rigid gel.

### Experimental Program

### Materials and Mixing Sequence

A general use (GU) cement complying with ASTM C150M standard was used. The chemical and physical properties of the cement are summarized in Table 1.1.

TABLE 1.1
Chemical and physical characteristics of used cement

| SiO₂ | TiO₂ | Al₂O₃ | Fe₂O₃ | MgO | CaO | Na₂O | K₂O | SO₃ | BET | Blaine | Gs |
|---|---|---|---|---|---|---|---|---|---|---|---|
| (%) | | | | | | | | | (m²/kg) | | (g/cm³) |
| 20.4 | 0.2 | 4.4 | 2.5 | 2.1 | 62.0 | 0.0 | 0.8 | 3.8 | 1557 | 444 | 3.15 |

All the investigated mixtures were proportioned using a w/c ratio of 0.43. Different dosages of (κ)-carrageenan corresponding to 0.5, 1.0, and 1.5%, by mass of water, were investigated. The (κ)-carrageenan used is a food grade product which was obtained from the company Sigma-Aldrich®. In some mixtures, the (κ)-carrageenan was used in combination with two different types of HRWR: a polycondensate of formaldehyde and sulfonated naphthalene or polynaphtalene sulfonate-(PNS1) and a polycarboxylate-(PC) based HRWR. For each mixture, optimum HRWR dosages, to ensure proper dispersion of cement particles and suitable initial fluidity, were used. For comparison purposes, welan gum VMA has been used at a given dosage of 0.5%, by weight of water.

The investigated mixtures were prepared in batches of 1.0 liter using a high-shear blender and the mixing procedure described in the ASTM C1738 M standard. The temperature of mixing water was controlled and maintained at 11±2° C. to compensate for heat generation during mixing. Following the end of mixing, all mixtures had constant temperatures of 21±2° C. Water, HRWR (if any), and the VMA (powder) were first added into the blender. The cement was then gradually introduced over 1 min, while the mixer was operating at a rotational speed of 4 000 rpm. After the introduction of solid materials, the rotation speed is increased to 10 000 rpm for 30 s. After a rest period of 150 s, the mixture was resumed for another mixing at a rotating speed of 10 000 rpm during 30 s. The sample is then left at rest during 10 min before carrying the rheological measurements.

### Testing Procedures

Rheology of various mixtures was assessed using a high precision MCR 302 coaxial cylinders rheometer. A profiled inner cylinder was used to reduce wall slip. The inner and outer cylinders had 26.660 mm and 28.911 mm diameters, respectively, resulting in a narrow gap of 1,126 mm, thus ensuring constant shear rate across the gap. During the measurement, the temperature of the sample was maintained at 23° C. Different rheological tests were conducted to determine the flow curves, strain sweep, and time sweep measurements. The test procedure used to determine the flow curves consists in pre-shearing the sample at 50 s⁻¹ for 30 s to ensure homogeneous distribution of the sample in the shear gap. The sample was then allowed a rest period of 30 s to allow temperature stabilization of tested sample. The descending curve was determined by applying a pre-shear of 150 s⁻¹ during 2 min, then by decreasing the shear rate from 150 s⁻¹ to 1 s⁻¹ during 160 s (8 steps, 20 s for each step).

In addition to the flow curves, for each mixture the linear viscoelastic domain (LVED) was identified using a strain sweep test in which the sample was subjected to an increasing shear strain from 0.0001% to 100% at a constant angular frequency of 10 rad/s. On the other hand, time sweep measurements were carried out to determine the structural kinetic of build-up. The test procedure consisted in applying a pre-shear at 50 s⁻¹ during 10 s to ensure a homogenous distribution of the sample in the gap. The sample was then allowed a rest period of 30 s. Then, a small-amplitude oscillatory shear (SAOS) at a constant angular frequency of 10 rad/s and a shear strain value within the LVED during 60 s was applied. A disruptive shear regime was applied before determining the kinetic of build-up. It consisted in applying a pre-shear of 200 s⁻¹ during 3 min. After 14 s of rest, time sweep measurements were carried out. This consisted in applying a SAOS during 20 min at an angular frequency of 10 rad/s and a shear strain value within the LVED. This allowed monitoring the evolution of both storage (G′) and loss (G″) moduli, and the phase angle (δ) with time at rest.

The resistance of the cement suspensions to forced bleeding was evaluated using a standard Guelman filter capable of retaining 99.7% of solid particles with diameters greater than 0.3 microns (method adapted from standard ASTM D5891—“API 1991”). This method was used to determine the ability of cement paste to retain some of its free water in suspension under prolonged pressure. The applied pressure can cause separation of the mixing water. The method involved introducing 200 ml of cement paste into a sealed steel container. Then, a sustained pressure of 80 psi (equivalent to 0.55 MPa), for 10 min, was applied using nitrogen gas. The forced bleeding water was expressed as a percentage of the mixing water present in the test sample.

A TAM air calorimeter was used to control the heat of hydration of the cement. A mass equivalent to 9.78 g was sampled and weighed of each cement suspensions, in an ampoule, prepared in the high shear blender. The ampoule was then closed and placed in the calorimeter. The evolution of the heat flow was recorded at 23° C. for 72 h.

Compressive strength tests have also been carried out. The cement suspensions were cast in cubic molds (50×50×50 mm³). After 24 h, the samples were demolded and cured. The compressive strength test was performed at 24 h and 7 days following the recommendations of ASTM C109.

### Test Results

The experimental study consisted in evaluating the effect of different dosages of (κ)-carrageenan on rheology, viscoelastic properties, structural build-up kinetics, stability, dormant period and compressive strength of cement-based materials. The interaction between (κ)-carrageenan and HRWR was also evaluated.

### Effect of (κ)-Carrageenan on Rheology and Viscoelastic Properties

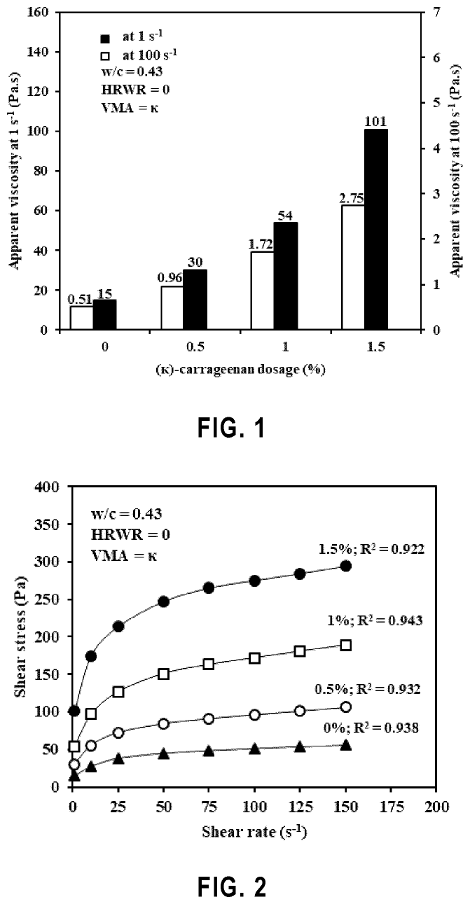

Rheology and viscoelastic properties of various cement-paste mixtures incorporating different dosages of (κ)-carrageenan were evaluated. As can be observed in FIG. 1, the increase in (κ)-carrageenan dosage enhanced the apparent viscosity of cement paste at both low and high shear rate values of 1 s⁻¹ and 100 s⁻¹, respectively. This behavior reflects the capacity of (κ)-carrageenan polymers to retain the absorbed water even at relatively high shear rate. The decrease in apparent viscosity observed when the shear rate increased from 1 s⁻¹ to 100 s⁻¹ is probably due to the change in the structural conformation of the polymer chains due to the shear.

The flow curves and variation of apparent viscosity presented in FIGS. 2 and 3 show that mixtures containing different dosages of (κ)-carrageenan of 0.5, 1.0, and 1.5%, by mass of water, exhibited a shear thinning behavior, where the apparent viscosity decreased significantly with the shear rate, regardless of the dosage of (κ)-carrageenan. On the other hand, the pseudoplastic degree, which is defined as

$$\frac{{μ}_{1} - {μ}_{150}}{150 - 1} ,$$

where μ₁ and μ₁₅₀ are the apparent viscosity values at 1 and 150 s⁻¹, respectively, increased with the dosage of (κ)-carrageenan. The highest dosage of 1.5% resulted in the greatest pseudoplastic response of 0.664 compared to 0.098 obtained with reference mixture.

FIG. 4 shows the flow curves of cement-paste mixtures containing an equal dosage of 0.5% of (κ)-carrageenan or welan gum, by mass of water. This dosage was selected based on experimental observations. Indeed, the addition of welan gum at dosages greater than 0.5% resulted in a very high viscous mixture, hence resulting in blockage during mixing, unlike the use of (κ)-carrageenan, where the viscosity of the mixtures continued to increase with the (κ)-carrageenan dosage without causing a mixing blockage. The mixture containing (κ)-carrageenan showed higher shear stress than that of the mixture containing welan gum. This means that the shear-thinning effect is more pronounced in the case of (κ)-carrageenan, which is preferred to facilitate the flow performance of flowable compositions.

Aqueous carrageenan solutions exhibit pseudoplastic behavior as do most of the hydrocolloids. This is due to a gelling process that takes place in aqueous solutions of (κ)-carrageenan with or without the presence of salt. This gelation can also be promoted at relatively higher polymer concentration. The shear-thinning response and high apparent viscosity observed at low-shear rates is due to the contribution of (κ)-carrageenan polymers in increasing the inter-particle attraction forces, which leads to the formation of flocs. Indeed, at low shear rates, the inter-particle attraction forces predominate over the hydrodynamic forces, hence leads to the formation of flocs. As the shear rate increases, the hydrodynamic forces increase, which result in decomposition of the flocs into smaller units. This contributes in releasing the water otherwise entrapped into the flocs and decreasing the viscosity of the system. Furthermore, the presence of Na⁺ ions in the system can open the bridge of the long chains of (κ)-carrageenan polymers, thus resulting in a relatively large hydrodynamic gyration radius (ρ). Under shear, these long chains are easily oriented in the flow direction, hence promoting the shear thinning behavior. The gelling behavior is also affected by the number of sulfate groups per repeating units and/or the conformational restriction by anhydrous residues. It is well established that the gelling process decreases with the increase of the sulfate groups number.

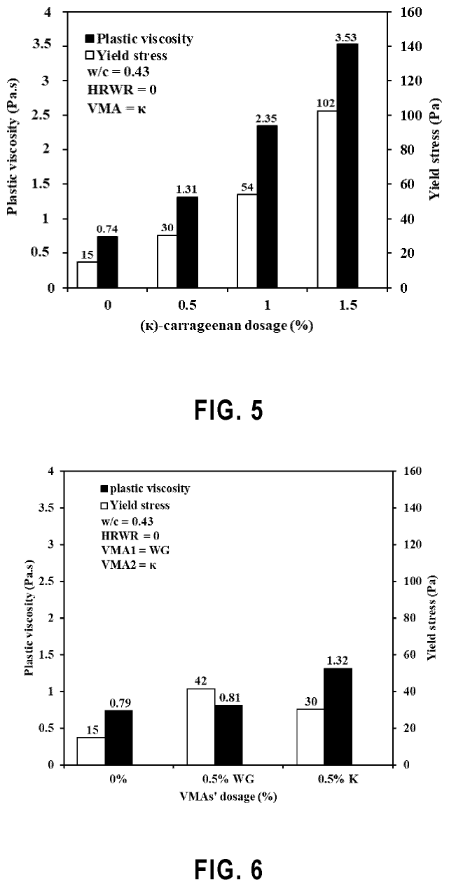

As can be observed in FIG. 5, the use of (κ)-carrageenan increases both the yield stress and plastic viscosity values of cement-paste mixtures. These parameters were determined by fitting the flow curves using the modified Bingham model (Yahia and Khayat, 2001). The shear stress of modified Bingham model follows a second-degree polynomial law beyond a yield stress point (T_{0, MB}):

$$\{ \begin{matrix}τ = {τ}_{0 , MB} + {μ}_{p , MB} \cdot \dot{γ} + {c}_{MB} \cdot {\dot{γ}}^{2} & si τ > {τ}_{0} \\ \dot{γ} = 0 & si τ \leq {τ}_{0}\end{matrix} \qquad Equation 1$$

where c_{MB}(Pa·s²) is a second order parameter.

The use of 0.5% of (κ)-carrageenan increased the yield stress from 15 Pa to 30 Pa and the plastic viscosity from 0.74 Pa·s to 1.31 Pa·s. Further increase in (κ)-carrageenan dosage to 1.0 and 1.5% resulted in higher yield stress of 54 Pa and 102 Pa and plastic viscosity of 2.35 Pa·s and 3.53 Pa·s, respectively. The increase in yield stress is caused by the increase in the interparticle force between solid particles and the densification of the matrix due to the presence of (κ)-carrageenan polymers. On the other hand, the increase in plastic viscosity can be due the gelling process that occurs in presence of (κ)-carrageenan.

As can be observed in FIG. 6, for the same dosage of 0.5%, the use of (κ)-carrageenan increases the plastic viscosity of the cement-paste mixtures without increasing so much the yield stress, unlike the use of welan gum. It is admitted in the literature that most conventional VMAs, such as cellulose ether and welan gum, increase the yield stress of cement systems more significantly than plastic viscosity. This results flow blockage in post-tensioning conducts, pumping circuit, and during formwork filling. The use of (κ)-carrageenan instead of these conventional VAMs can avoid the flow blockage due to its more pronounced shear-thinning response effect and unusual rheological properties of increasing the viscosity of the cement systems without a noticeable effect on the yield stress, compared to welan gum.

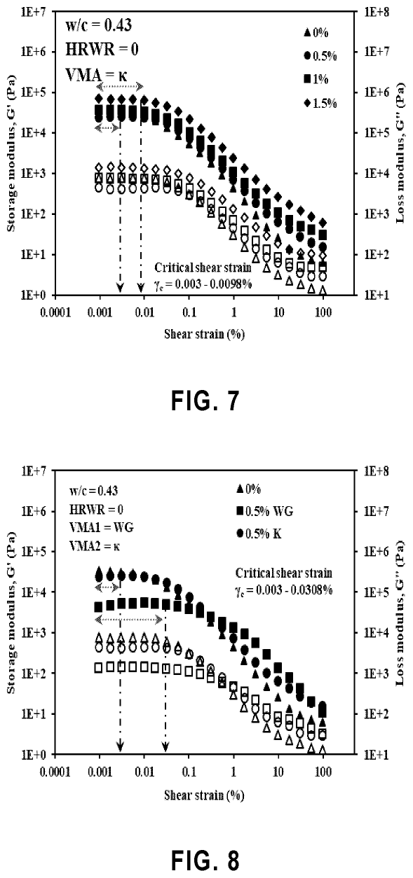

Strain sweep measurements, in which the sample is subjected to an increasing shear strain from 0.0001% to 100% at a constant angular frequency of 10 rad/s, were carried out to evaluate the viscoelastic behavior of the investigated cement-paste mixtures. The linear viscoelastic domain (LVED), corresponding to the region where the viscoelastic properties are independent of imposed deformations, allowed monitoring the evolution of both storage (G′) and loss (G″) moduli with the shear strain. The G′ and G″ of cement-paste mixtures containing different dosages of (κ)-carrageenan determined from the strain sweep measurements are summarized in FIG. 7.

As can be observed, the mixtures exhibited a linear viscoelastic behavior up to some critical shear strain, beyond which a decrease in shear moduli is observed with the shear strain, thus reflecting destruction of the material. A critical strain of 0.0098% is observed, regardless of the dosage of (κ)-carrageenan in use compared to reference mixture which exhibited a critical strain value of 0.0030%. The critical strain corresponds to the value of shear strain where the curve G′ begins to deviate substantially from the plateau of the LVED (Mezger, 2011) by more than 5%. When the sample is subject to a shear strain lower than the critical strain, it behaves like a solid structure. The G′ values obtained with cement-based mixtures investigated in this study are between 10 000 Pa and 100 000 Pa. The increase in (κ)-carrageenan dosage increased slightly the G′, especially for a dosage beyond 1.0%. The storage modulus of (κ)-carrageenan gels increases with their dosages. (κ)-carrageenan polymers can form a rigid gel with a G′ of 10 000 Pa at a concentration of 1.0%. The increase in rigidity is due to the presence of K⁺ ions that promote intermolecular interactions, hence contribute in strengthening the elastic network of cementitious systems containing (κ)-carrageenan. Indeed, the resulting gelling product consisting of small colloidal spherical particles with high specific surface area densify the formed network, hence contribute in strengthening cement-based system. On the other hand, the electrostatic repulsion between the negatively charged sulfate groups can contribute to increasing the distance between chains, which leads to greater distance between the cement particles, hence longer LVED. The stability of the LVED observed with higher dosage of (κ)-carrageenan is due to the formation of smaller particles size and greater viscosity of (κ)-carrageenan gel, which enhances the densification of the matrix and hinder particle movement.

As shown in FIG. 8, the use of 0.5% of welan gum or (κ)-carrageenan increased the critical shear strain value from 0.003% or 0.0098% to 0.0308%, respectively. In addition, the mixture containing welan gum exhibited lower rigidity compared to the mixture containing (κ)-carrageenan.

### Interaction between (κ)-Carrageenan-HRWR Combination and Its Effect on Rheology and Viscoelastic Properties

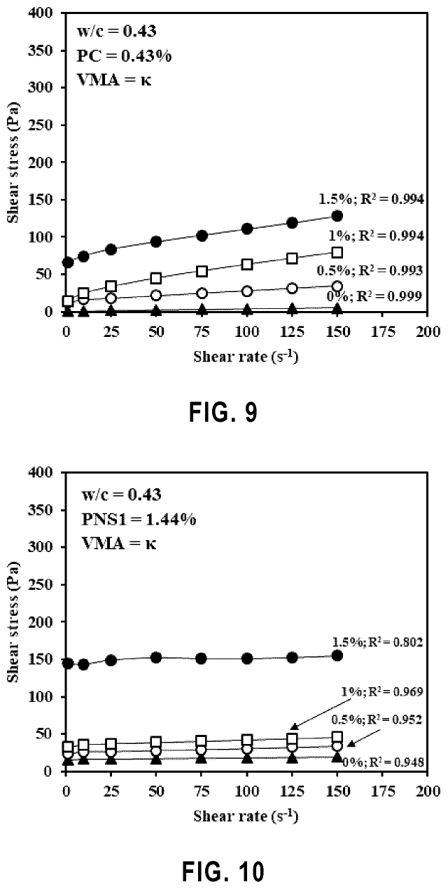

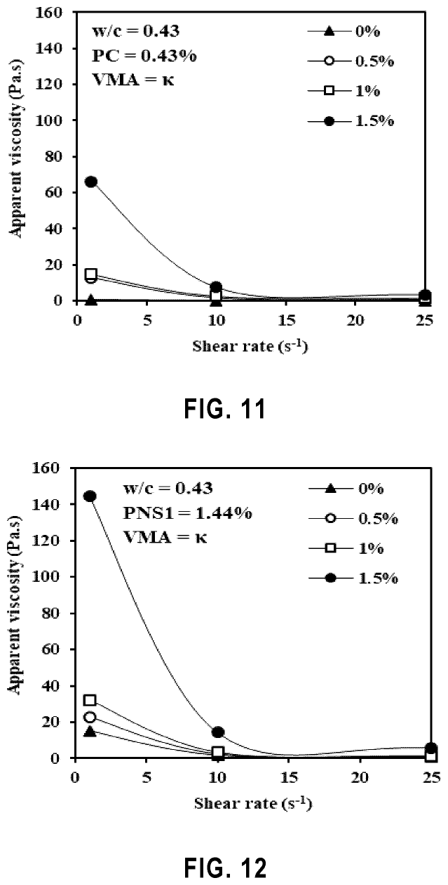

VMAs are usually used in conjunction with HRWR to secure a given level of fluidity and improve fluidity retention. Herein, the (κ)-carrageenan is used in combination with two different HRWR types, PC- and PNS1-based HRWR. The PC and PNS1 were used at optimum dosages of 0.43% and 1.44%, by mass of cement, respectively. These dosages were selected to ensure good dispersion of the system, while ensuring good stability, i.e. without inducing bleeding and segregation. The flow curves of investigated mixtures incorporating PC and PNS1 HRWR types are shown in FIGS. 9 and 10. On the other hand, the variation of apparent viscosity of the investigated mixtures is presented in FIGS. 11 and 12.

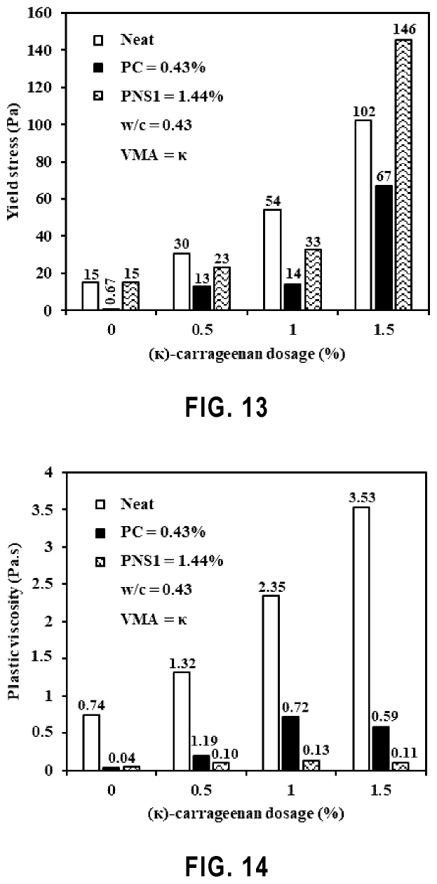

The use of (κ)-carrageenan considerably increased the shear stress (i.e. flow curve) and shear thinning response of cement paste. However, the incorporation of HRWR resulted in lowering the shear stress and causing a linear Bingham behavior compared to mixtures made without HRWR, regardless of the dosage of (κ)-carrageenan. For example, the use of 1.5% of (κ)-carrageenan resulted in a shear stress of 300 Pa at a shear rate of 150 s⁻¹. The incorporation of PC HRWR reduced the shear stress to 100 Pa. This resulted in lowering both the yield stress and plastic viscosity (FIGS. 13 and 14), regardless of the dosage of (κ)-carrageenan. For example, the mixture made with 1% of (κ)-carrageenan exhibited a yield stress value of approximately 54 Pa. The use of PC and PNS1 resulted in lower yield stress of 14 and 33 Pa, respectively. Furthermore, the incorporation of HRWR reduced the pseudoplastic degree of the mixtures, regardless of the type of HRWR and the dosage of (κ)-carrageenan. It is worthy to mention that in the case of PNS1 HRWR type, the increase of (κ)-carrageenan up to 1.0% did not result in significant change in the flow curve, but the use of 1.5% (κ)-carrageenan resulted in higher shear stress values of cement suspension.

The mixtures incorporating PC type showed lower yield stress and pseudoplastic degree (i.e. lower variation in the apparent viscosity with shear rate) than those made with PNS1 type. On the other hand, the use of PNS1 in conjunction with (κ)-carrageenan resulted in the lowest plastic viscosity, regardless of the dosage of (κ)-carrageenan than the addition of PC (FIGS. 13 and 14).

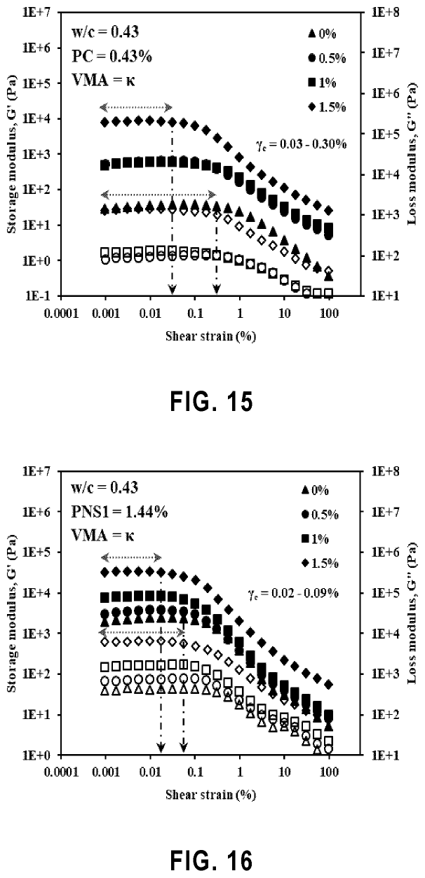

The evolution of G′ and G″ determined from the shear strain sweep measurements for the investigated mixtures containing HRWR are showed in FIGS. 15 and 16. The use of HRWR increased the LVED, thus reflecting higher dispersion and inter-particles distance between cement particles. For example, critical strains of 0.3080% and 0.0975% were obtained with mixtures containing PC and PNS1 HRWR types compared to 0.0030% (FIG. 7) obtained with reference mixture made without HRWR. The use of PC HRWR resulted in higher critical strain than PNS1 type. This is due to the higher efficiency of PC HRWR type in dispersing the matrix.

The mixtures incorporating (κ)-carrageenan and HRWR showed a viscoelastic linear behavior, regardless of the dosage of (κ)-carrageenan and HRWR type. The use of (κ)-carrageenan in conjunction with HRWR decreased the LVED, regardless of the HRWR type. Such a decrease was more pronounced with higher dosage of (κ)-carrageenan. For example, the increase in dosage of (κ)-carrageenan from 0.5 to 1.5% decreased the critical strain value from 0.0974 to 0.0309% with PC HRWR and from 0.0549 to 0.0174 with PNS1 HRWR. The increase in (κ)-carrageenan dosage increased, however, the rigidity of the systems compared to reference mixture without (κ)-carrageenan, regardless of the type of HRWR. The combination of (κ)-carrageenan and HRWR decreased the rigidity of cement suspensions compared to mixtures without HRWR, regardless of the (κ)-carrageenan dosage. For example, the use of (κ)-carrageenan at a dosage of 1.0% resulted in rigidity of 37 500 Pa. The incorporation of PC and PNS1 HRWR reduced the rigidity values to 500 and 7 510 Pa, respectively. The use of PC HRWR resulted, however, in lower rigidity than PNS1 HRWR type.

The decrease of the LVED observed with mixtures containing (κ)-carrageenan and HRWR can be due to the capacity of (κ)-carrageenan to fill the inter-particle space and densification of the system. Furthermore, the reduction in the rigidity of the system can contribute in reducing the LVED. The capacity of (κ)-carrageenan polymers to form and maintain a rigid gel in presence of dispersant depends mainly on the position of sulfate groups outside the helix which influence the electrostatic or steric repulsion forces and the formation of double helices.

### Effect of (κ)-Carrageenan on the Structural Build-Up Kinetics of Cement Suspensions

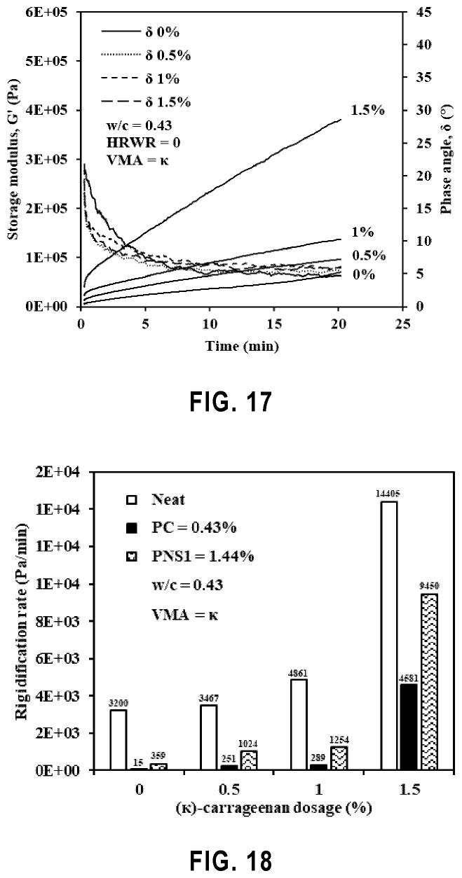

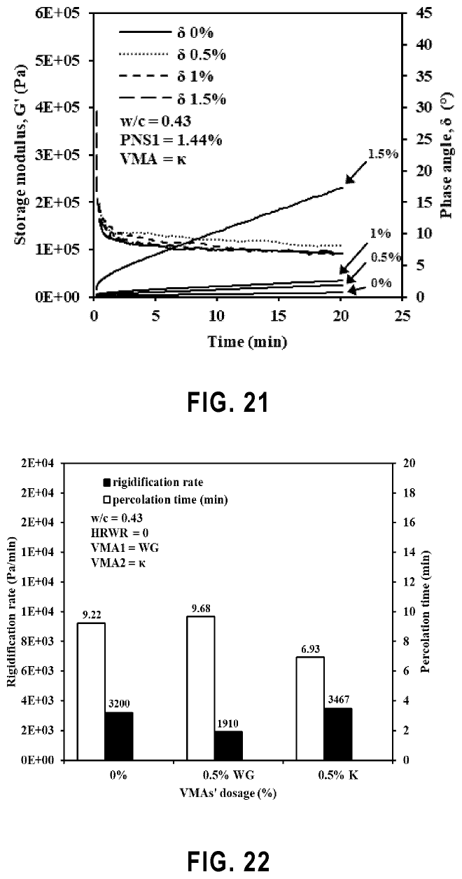

The structural build-up kinetics of cement-paste mixtures containing different dosages of (κ)-carrageenan was determined using time sweep measurements carried out at a SAOS, a constant angular frequency of 10 rad/s, and a shear strain value within the LVED, i.e. a strain lower than the critical value. These measurements allowed determining the evolution of both the G′ and G″ with time at rest. The evolution of G′ and G″ during 20 min of rest was determined and used to quantify the build-up properties for investigated mixtures containing different dosages of (κ)-carrageenan in the presence of HRWR (FIGS. 17 to 21). The phase angle (δ), calculated as tan⁻¹ (G″/G′), was also assessed to determine the transition of structure from fluid-like state to solid-like state. The value of 0° corresponds to a perfect (i.e. elastic) solid state in which there is no delay between the oscillatory deformation induced and the response to the measured stress. In the case of a perfectly viscous structure, the value of δ is 90°. The time needed for the phase angle to shift from 90 to 0°, an indication of the transition of the structure from fluid-like state to solid-like state, is referred to the percolation time (t_{perc.}). This describes the time necessary to build an elastic network. On the other hand, the rate of evolution of G′ after t_{perc.} (i.e. after the formation of the elastic network), referred to the rigidification rate (G_{rigid.}), represents the increase in the capacity of the formed network to support loads. The t_{perc.} and G_{rigid.} indices are used to quantify the influence of the (κ)-carrageenan on the structural kinetic of build-up of cement-based suspensions.

As can be observed in FIG. 17, immediately after breaking down the structure (lowest G′ and highest δ values), the δ decreased to reach a steady state, while the G′ increased, hence indicating higher rigidity of the formed network. This behavior reflects a transition from the liquid state to a solid state. The increase in (κ)-carrageenan dosage increased the G_{rigid.} of mixtures without HRWR, but limited effect on time needed to form the elastic network (t_{perc.}) was observed. For example, the use of 1.0% of (κ)-carrageenan resulted in higher rigidity after 20 min of rest (almost double) and higher kinetic of build-up (slope of the curve, 4860.74 Pa/min). On the other hand, the use of 1.5% of (κ)-carrageenan increased both rigidity (more than four times) and kinetic of build-up (14404.98 Pa/min). However, the increase in the dosage of (κ)-carrageenan increased slightly the percolation time of the investigated mixtures.

As can be observed in FIG. 22 and as in the case of shear strain sweep measurements, the use of welan gum decreased the rigidification rate of the investigated cement systems compared to those containing (κ)-carrageenan. The (κ)-carrageenan exhibited a higher build-up kinetics than welan gum, which is preferred in SCC destined to reduce the lateral pressure exerted on the formwork. Furthermore, the use of welan gum increased the t_{perc.} compared to those containing (κ)-carrageenan. This means that the welan gum affects the formation of the elastic network, thus delaying its percolation, which negatively affects the evolution of the rigidity of the system over time (i.e. the G_{rigid.}).

The high rigidity of the formed network is probably due to the ability of (κ)-carrageenan to form a helical structure through the presence of the 3,6-anhydro-galactose bridges that promote the gel formation, hence increasing the rigidity of the system. Furthermore, the (κ)-carrageenan polymers can fix the dissolved K⁺ ions in the pore solution to stabilize the junction bridges in the brittle gel, thus contribute in increasing the rigidity of the formed network. In addition, the increase in dosage of (κ)-carrageenan accelerates the kinetics of build-up. However, the increase in dosage of (κ)-carrageenan did not results in an important change in the t_{perc.}. For example, the use of 0.5% of (κ)-carrageenan allowed a rapid formation of the elastic network (lower t_{perc.} of 6.9 min compared to 9.2 min of the reference mixture). The acceleration of the network formation may be due to the topological entanglement between the two helices. However, the use of higher dosage did not result in further acceleration of the formation of the elastic network. This may due to the fact that the system slowly tends to its equilibrium state at temperature close to the critical cooling temperature (Tc), which is about 25° C.

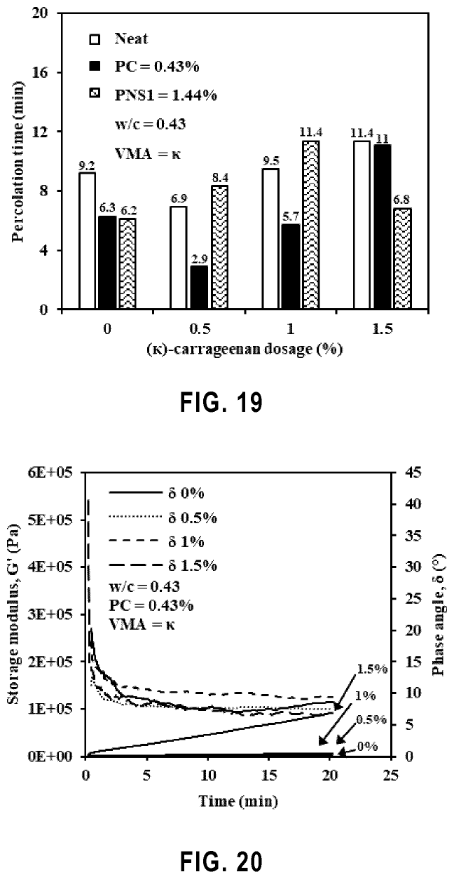

The addition of HRWR lowered the rigidity (lower G_{rigid.} value) of the cement suspensions, regardless of the type of HRWR. The use of PC type resulted in the lowest G_{rigid.} value than PNS1 type (FIGS. 18 and 19). This can be due to low number of contact points and high inter-particle distances due to greater dispersing ability of PC compared to PNS1. However, in the case of the t_{perc.}, the mixtures containing only HRWR (i.e. without (κ)-carrageenan), showed a faster formation of the elastic network compared to the reference mixture despite their weak rigidity (low G_{rigid.} value). This may be due to the dispersing action, which increases the distance between the particles. This trend is consistent with those of the critical strains, where a greater critical strain values were observed in the case of reference mixtures in presence of HRWR. In the case of mixtures containing (κ)-carrageenan, the addition of the PC HRWR resulted in a decrease in the t_{perc.}. However, in the case of PNS1 HRWR, the mixtures containing 0.5 and 1.0% of (κ)-carrageenan showed a larger increase in this index compered to the mixture that contains only (κ)-carrageenan. The PNS 1/1.5%κ combination showed a decrease in the t_{perc.}.

### Effect of (κ)-Carrageenan on Forced Bleeding

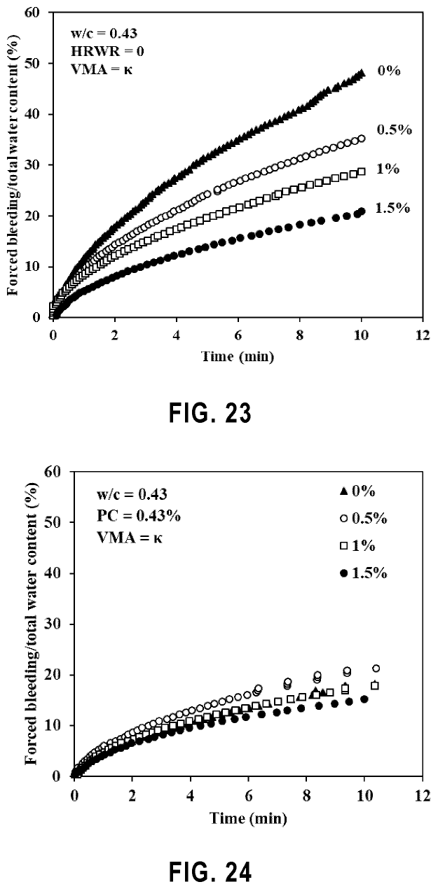

Resistance to forced bleeding and settlement of cement grout are key properties to ensure proper mechanical properties. Resistance to forced bleeding assesses the ability of suspension to maintain its constituents, especially the water, under sustained pressure. Indeed, under pressure, the free water that is not physically fixed or chemically combined with cement particles can drain out. The use of VMA significantly reduce the forced bleeding of cement-based suspensions. The relative forced bleeding of mixtures containing different dosages of (κ)-carrageenan is summarized in FIG. 23.

As can be observed, the use of (κ)-carrageenan decreased the kinetic of bleeding (slope of the curve) and the total forced bleeding, regardless of the dosage of (κ)-carrageenan. This is mainly due to the capacity of (κ)-carrageenan to absorb the free water available in the system. For example, the use of 0.5% of (κ)-carrageenan reduced the forced bleeding from 48% to 35% (reduction of 26%). Higher dosage of (κ)-carrageenan of 1.0% and 1.5% resulted in lower forced bleeding of 29% (reduction of 38%) and 21% (reduction of 55%), respectively. The greatest improvement was obtained with mixtures made with the highest dosage of (κ)-carrageenan of 1.5%. The presence of higher number of carrageenan molecules increase the number of junctions, thus resulting in high water absorption and lower free water in the system. In addition, the higher specific surface area of (κ)-carrageenan powder contributes in increasing higher water adsorption. This resulted in lowering the forced bleeding. (κ)-carrageenan has higher water retention capacity than other viscosity agents, such as cellulose. This is mainly due to the hydrophilic nature of the repeated sugar units and the amorphous molecular arrangement of the polysaccharide chains of carrageenan. Specifically, the interactions between sugar polymers and water occur mainly in the amorphous regions of the sugar molecules, thus allowing higher water absorption of the (κ)-carrageenan than the semi-crystalline cellulose.

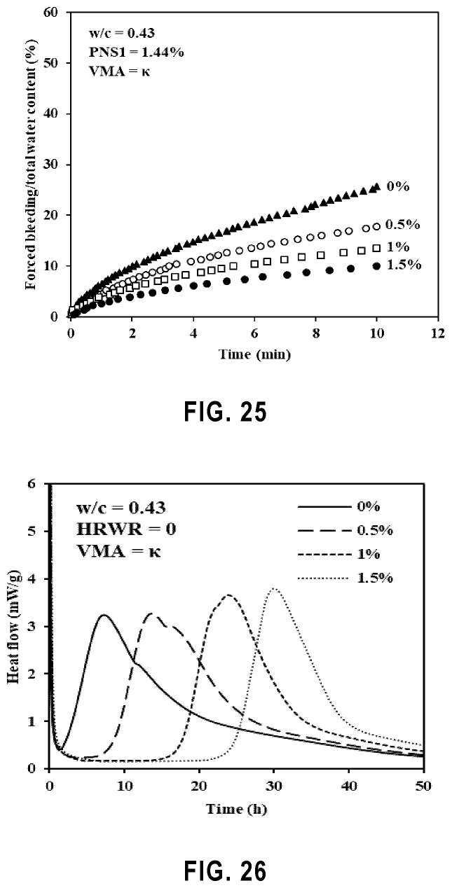

As can be observed in FIGS. 24 and 25, the use of 1.44% of PNS1 and 0.43% of PC reduced the forced bleeding from 48% to 26% and 18%, respectively. On the other hand, the use of (κ)-carrageenan in combination with HRWR enhanced the stability of cement suspensions, regardless of the dosage of (κ)-carrageenan. However, the use of PC resulted in lower forced bleeding than PNS1. This is mainly due to greater dispersion performance of PC compared to PNS. For example, the mixture made with PNS1 exhibited a forced bleeding of 25%. In the case of PC, the forced bleeding was 18%. In the case of PC HRWR, the use of different dosages of (κ)-carrageenan up to 1.5% resulted in forced bleeding values between 15 and 21%. However, the use of PNS1 resulted in higher improvement in forced bleeding, especially at dosages of (κ)-carrageenan corresponding to 1.0% and 1.5%. Indeed, the use of 1.0 and 1.5% of (κ)-carrageenan decreased the forced bleeding from 25% to 13 and 10%, respectively. On the other hand, the use of (κ)-carrageenan resulted in further decrease in forced bleeding. For example, the use of 1.0% of (κ)-carrageenan in combination with PNS1 and PC HRWR resulted in lower forced bleeding of 13 and 18%, respectively, compared to 29% obtained with mixtures made 1.0% of (κ)-carrageenan and without HRWR. This improvement is due to both the absorption of water by the (κ)-carrageenan and the improvement in dispersion of the system due to the presence of HRWR. Indeed, the dispersion state of the system affects the ability of water to drain out through the matrix, i.e. the bleeding water. A well-dispersed matrix will show less bleeding channels resulting in relatively high impermeability, thus leading to low filtration water, i.e. water loss.

### Effect of (κ)-Carrageenan on Cement Hydration Kinetic

After studying the effect of (κ)-carrageenan on the rheological properties and structural build-up kinetics of cement suspensions, we studied their effect on cement hydration. The heat flow of studied cement suspensions determined for 72 h after mixing are presented in FIG. 26. As can be observed, without HRWR, the addition of (κ)-carrageenan showed some effect on the cement hydration. Its presence prolonged the induction period, regardless of the dosage of (κ)-carrageenan used. In addition, the increase in (κ)-carrageenan dosage led to a greater extension of this period from 90 min for the reference mixture to 6.2 h, 14 h and 21 h for mixtures containing 0.5%, 1.0%, and 1.5% of (κ)-carrageenan, respectively. This delay in the dormant period can be referred to a decrease in the concentration of the Na⁺, Ca²⁺, and K⁺ ions necessary to initiate the acceleration period. These ions are consumed by the studied polysaccharide to stabilize its junction sites to form a rigid gel. VMAs do tend to delay the first hours of hydration of cement during the dormant period. This is due to the formation of new C—S—Hs which cover the clinker particles leading to a delay in the cement hydration.

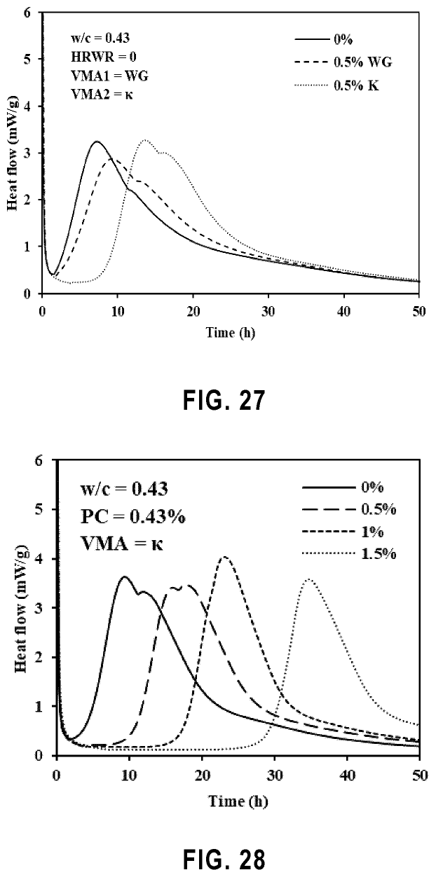

As can be observed in FIG. 27, the use of 0.5% welan gum increased the dormant period from 90 min to 114 min. The effect of (κ)-carrageenan on the dormant period remained stronger than that of welan gum, with a dormant period extension of 6.2 h.

As can be observed in FIG. 26, the maximum value of the second peak of heat increased from 3.225 mW/g for the reference mixture to 3.30, 3.40, and 3.80 mW/g for the cement-paste mixtures containing 0.5%, 1.0%, and 1.5% of (κ)-carrageenan, respectively. The increase in (κ)-carrageenan dosage has, therefore, increased the maximum value of the second peak of heat. This peak is followed by a deceleration period, in which appears a third hydration peak which is related to the transformation of ettringite into monsulfoaluminate. For the reference mixture and the mixture containing 0.5% of (κ)-carrageenan, the third peak is in the form of a slight convexity when the heat flow curve begins to descend. This peak is slightly more apparent in the case of the mixture containing 0.5% of (κ)-carrageenan. However, the intensity of the third hydration peak exceeded that of the second peak in the case of the mixture containing 1.0% of (κ)-carrageenan.

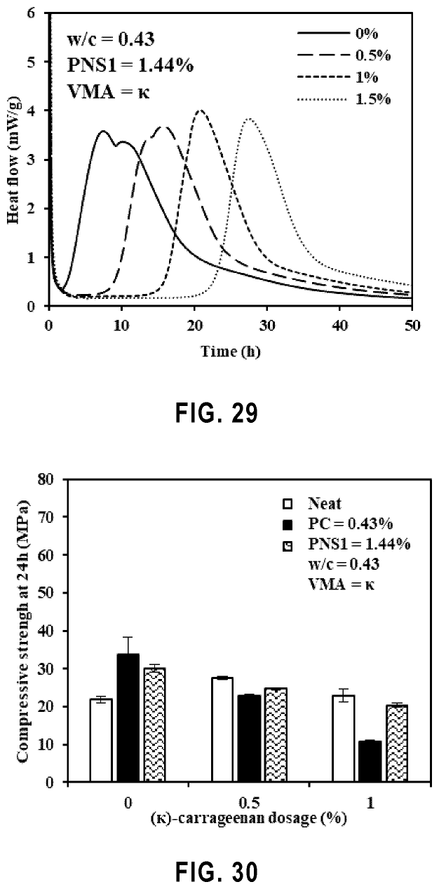

The heat flow of cement suspensions made with (κ)-carrageenan and HRWR are shown in FIGS. 28 and 29. For both reference mixtures, the HRWR affects significantly the duration of the dormant period. In the presence of PC HRWR, the duration of this period is 2 h. While, it is 105 min in the presence of PNS1 HRWR with a maximum heat release rate of 3.6 mW/g for both mixtures. The addition of PC HRWR to mixtures containing 0.5% and 1.5% of (κ)-carrageenan extended the duration of the dormant period to 8.2 h and 24 h, respectively. The maximum value of the second peak is increased to 3.40 mW/g for the PC/0.5%κ combination. This value decreased to 3.6 mW/g for the PC/1.5%κ combination compared to mixtures containing the same dosages of (κ)-carrageenan without PC HRWR. However, the addition of PC HRWR in the mixture containing 1.0% of (κ)-carrageenan did not have any effect on the dormant period showing a duration similar to that of the mixture without PC HRWR and with 1.0% of (κ)-carrageenan. The maximum value of the second peak is increased to 4.10 mW/g.

In the presence of the PNS1 HRWR, the duration of the dormant period was decreased by 1 h and 2 h in the case of mixtures containing 1.0% and 1.5% of (κ)-carrageenan, respectively. However, a prolongation of 48 min in the dormant period was recorded in the case of the PNS/0.5%κ combination compared to the mixture containing only 0.5% of (κ)-carrageenan. In addition, the values of the second peak of heat also showed some variations. These values were 4.0 mW/g, 3.90 mW/g, and 3.5 mW/g for PNS 1/1%κ, PNS 1/1.5%κ and PNS1/0.5%κ combinations, respectively. However, the third peak of heat was more apparent in the case of PNS1/0.5%κ compared to the PC/0.5%κ combination and the mixture containing only (κ)-carrageenan.

### Effect of (κ)-Carrageenan on Compressive Strength

The results of the compressive strength after 24 h of hardening of studied mixtures are shown in FIG. 30. Without HRWR, the reference mixture showed lower compressive strength compared to all mixtures containing (κ)-carrageenan. The mixture containing 0.5% of (κ)-carrageenan showed the highest compressive strength (27.5 Mpa). The increase in compressive strength with a low dosage of (κ)-carrageenan is probably due to the fact that the (κ)-carrageenan increases the adhesion mechanism between the cement particles because of its gelling properties and its ability to form a rigid gel. When used with cement, the (κ)-carrageenan fills the pores and enhances the performance of the cement by reacting with the hydration phases of the cement. However, increasing the dosage of (κ)-carrageenan led to a significant reduction in the compressive strength at early age. Indeed, the high dosage of (κ)-carrageenan did not result in an increase in the compressive strength but a decrease. This may be due to an excessive portion of this polymer in the mixture.

With HRWR and in the case of mixtures without (κ)-carrageenan, the addition of PC HRWR showed a significant increase in the short-term compressive strength than the addition of PNS1 HRWR. Mixtures containing PC-based HRWR tend to give greater compressive strength at all ages than those with PNS-based HRWR. However, increase of (κ)-carrageenan dosage significantly reduced the compressive strength of mixtures containing PC HRWR. This resistance decreases slightly in the case of mixtures containing PNS1 HRWR. Based on the results of cement hydration kinetics, it can be concluded that the retardation in setting time observed in HRWR/κ combinations is the main cause of the reduction in compressive strength at early age. Since the addition of PC HRWR resulted in a greater delay in setting time than the addition of PNS1 HRWR in mixtures containing (κ)-carrageenan, the PNS1/κ combinations showed a higher compressive strength than the PC/κ combinations.

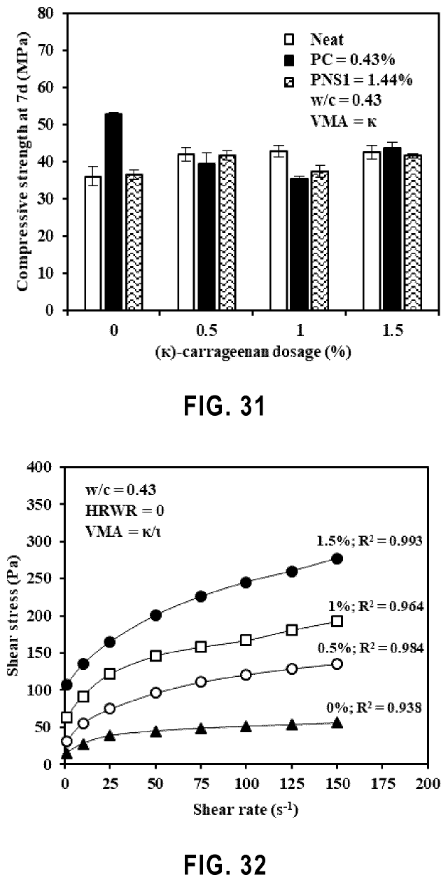

FIG. 31 shows the results of the compressive strength for the studied mixtures after 7 days of curing. In the absence of HRWR, an increase in the compressive strength was noticed compared to the reference mixture, regardless of the dosage of (κ)-carrageenan used. The dosage of 1.0% of (κ)-carrageenan showed the highest compressive strength. However, the addition of the PC HRWR decreased this resistance at different dosages of (κ)-carrageenan compared to the mixture containing only PC HRWR. In the case of mixtures containing PNS1 HRWR, adding (κ)-carrageenan has increased the compressive strength, regardless of the dosage of (κ)-carrageenan used.

### Conclusions

The effect of different dosages of (κ)-carrageenan and their interaction with two different types of HRWR on the rheological behavior (fluidity and viscosity), the viscoelastic properties, the structural kinetics of build-up, the stability, the cement hydration kinetics, and the compressive strength of cement suspensions formulated with a w/c ratio of 0.43 was evaluated. Based on the results presented in this example, the following conclusions can be pointed out:
The cement suspensions containing (κ)-carrageenan showed a pseudoplastic behavior which the shear stress increases with increasing the (κ)-carrageenan dosage;
An increase in (κ)-carrageenan dosage increased the apparent viscosity, both at high and low shear rates, in an almost linear fashion, regardless of the HRWR type;
The use of (κ)-carrageenan enhanced the plastic viscosity and yield stress values of cement-paste mixtures. The use of 1.0% of (κ)-carrageenan resulted in both 3 times higher plastic viscosity and yield stress values than the reference mixture;
Incorporation of HRWR caused a reduction in the plastic viscosity, regardless of the dosage of (κ)-carrageenan. This improved fluidity by reducing the yield stress value;
The LVED increased with the use of (κ)-carrageenan, regardless of the dosage of (κ)-carrageenan used, despite the high rigidity obtained with the increase in dosage of (κ)-carrageenan;
Cement suspensions containing (κ)-carrageenan in combination with HRWR showed a decrease of the LVED with the increase of (κ)-carrageenan dosage;
The cement suspensions containing the (κ)-carrageenan with or without HRWR showed a significant evolution in the structural build-up kinetics. This resulted in greater rigidity of the formed network due to the ability of this polysaccharide to form a helical structure through the presence of the 3,6-anhydro-galactose bridge and, therefore, the ability to form a rigid gel;
All the tested dosages of (κ)-carrageenan led to substantial enhancement in the resistance to forced bleeding, especially in the presence of HRWR;
The introduction of HRWR resulted in a significant enhancement in the resistance to forced bleeding;
Cement suspensions containing the (κ)-carrageenan showed a more prolonged induction period than that of the reference mixture, regardless of the (κ)-carrageenan dosage and HRWR type used;
The addition of (κ)-carrageenan resulted in an increase in compressive strength at 24 h and 7 days, regardless of the dosage of (κ)-carrageenan used; and
Generally, the addition of HRWR in cement suspensions containing (κ)-carrageenan did not cause an increase in the compressive strength but a decrease at 24 h or 7 days.

### Example 2—Effect of (κ)- and (ι)-Carrageenans Combination on the Rheological and Mechanical Properties of Cement-Based Materials

The main objective of this study is to evaluate the effect of (κ)- and (ι)-carrageenans combination on properties of cement-based suspensions. The combination of these biopolymers targets a higher rigidity than the individual components or a lower required dosage to achieve gels with comparable strength for economic purposes. Rheological measurements, isothermal calorimetry, and compressive strength properties are investigated.

More specifically, in this study, two different types of carrageenan were used: (κ)- and (ι)-carrageenan.

The study focused, initially, on the evaluation of the effect of a (κ)-(ι)-carrageenan combination on the rheological behavior of cement-based materials and, secondly, on the evaluation of the hydration kinetics and the mechanical performance of these new VMAs in cement-based materials. These performances of the (κ)-(ι)-carrageenan combination was then compared with those reported above in Example 1 for (κ)-carrageenan.

In this context, an experimental study was carried out to evaluate the performance of (κ)-(ι)-carrageenan combination in cement-based materials. The rheology, viscoelastic properties, structural build-up kinetics, hydration kinetics and compressive strength of different cement suspensions proportioned with a relatively high water to cement ratio (W/C) of 0.43 and a general use cement (GU) were evaluated. The effect of different dosages of (κ)-(ι)-carrageenan (50:50%) corresponding to 0.5, 1.0, and 1.5%, by mass of water, has been evaluated. Moreover, their effect in the presence of two different types of high-range water-reducer (HRWR), a polynaphthalene sulfonate (PNS1 and PNS2) and a polycarboxylate (PC) was also evaluated.

When incorporated into a cement paste, the use of (κ)-(ι)-carrageenan resulted in an increase in the yield stress, plastic viscosity, rigidity and structural build-up kinetics compared to the reference mixture. On the other hand, when used in combination with HRWRs, a lower yield stress and plastic viscosity have generally been obtained. Indeed, mixtures containing PC HRWR resulted in a significant decrease in the yield stress compared to that obtained in the case of PNS HRWR. However, the use of PNS in combination with (κ)-(ι)-carrageenan resulted in a lower plastic viscosity compared to the use of PC. Although, the use of HRWRs reduced the rigidity and the structural build-up kinetics of the studied mixtures, the use of (κ)-(ι)-carrageenan increased these parameters. However, the incorporation of (κ)-(ι)-carrageenan combination in cement suspensions extended in the duration of the dormant period. Despite this, it is worthy to mention that the use of (κ)-(ι)-carrageenan combination reduces the duration of the dormant period of cement suspensions by about 50% compared to the use of (κ)-carrageenan alone. Thus, the delay of cement suspensions setting time did not significantly reduce the early-age compressive strength of certain mixtures containing (κ)-(ι)-carrageenan due to the three-dimensional physical nature of (κ)- and (ι)-carrageenan gels.

### Comparison with Example 1

By comparing the plastic viscosity of the investigated cement-paste mixtures containing (κ)-(ι)-carrageenan with those containing only (κ)-carrageenan, important variations were reported. At low dosage of (κ)-(ι)-carrageenan (0.5%), the plastic viscosity increased by 24% compared to the use of (κ)-carrageenan alone, which reduces the amount and cost of the product for the same carrageenan dosage. However, the increase of (κ)-(ι)-carrageenan dosages to 1.0% and 1.5% led to a decrease in the plastic viscosity by 18% and 38%, respectively. This is probably due to the weakness nature of the (ι)-carrageenan gels in improving the viscosity of the system. As a result, the internal flow resistance of cement suspensions incorporating (ι)-carrageenan is decreased because of the lower rigidity of the formed gel. From an electrostatic point of view, the (ι)-carrageenan forms gels because the ι-ι double helices are formed rather than electrostatically favorable ι-κ mixed helices. The absence of interpenetration of the two forms of gel led to a greater formation of the ι-ι double helices, which contribute in decreasing the plastic viscosity.

By comparing the LVED of cement-paste mixtures containing (κ)-(ι)-carrageenan with those of cement-paste mixtures containing (κ)-carrageenan, it can be observed that, for a given dosage of 0.5% and 1.0% of (κ)-(ι)-carrageenan, no significant change in the LVED was observed compared to (κ)-carrageenan mixtures. However, at a higher dosage of (κ)-(ι)-carrageenan, higher critical shear strains than those fined with the use of (κ)-carrageenan were observed. On the other hand, the use of low dosage of (κ)-(ι)-carrageenan resulted in higher rigidity compared to the use of (κ)-carrageenan. These results showed the same trend than the plastic viscosity measurements. (κ)-carrageenan tends to significantly increase the gel strength of (ι)-carrageenan in the presence of cations, such as K⁺, that specifically induce helix formation and (κ)-polymer aggregation, even for small dosage, thus saving the product while achieving better performance.

In the presence of PC, the addition of 0.5% and 1.5% of (κ)-(ι)-carrageenan reduced the storage modulus of the investigated suspensions compared to mixtures containing only (κ)-carrageenan. However, the use of 1.0% of (κ)-(ι) carrageenan resulted in higher storage modulus. In the case of PNS1, an important difference was observed between the mixtures containing (κ)-carrageenan and those containing (κ)-(ι)-carrageenan combinations. The incorporation of (ι)-carrageenan type did not enhance the storage modulus of the investigated suspensions.

By comparing the rigidity of the mixtures containing (κ)-(ι)-carrageenan with those incorporating (κ)-carrageenan alone, it can be confirmed that the presence of higher amount of (ι)-carrageenan decreased the rigidity of the formed network. This suggests that the use of (κ)-(ι)-carrageenan combination, at low dosage, is preferable than using (κ)-carrageenan alone to increase the rigidity of the formed network. This is in good agreement with the results of strain sweep and plastic viscosity measurements.

It can be stated that the use of (ι)-carrageenan in combination with (κ)-carrageenan decreased the structural build-up kinetics of cement suspensions containing PC or PNS1 HRWR types. This may be due to the prolonged gel formation time in the case of (ι)-carrageenan biopolymer. The combination of these two biopolymers viscosity admixtures effectively reduced the dormant period compared to mixtures containing (κ)-carrageenan alone. The difference between the dormant period duration of mixtures containing different concentrations of (κ)-carrageenan with or without HRWR and mixtures containing (κ)-(ι)-carrageenan decreased by 50%.

The comparison between the compressive strength values of the mixtures containing (κ)-(ι)-carrageenan and those containing (κ)-carrageenan confirmed that the acceleration of the cement hydration reaction, by reducing the duration of the dormant period, observed in mixtures containing (κ)-(ι)-carrageenan results in an increase in compressive strength.

### Experimental Program

In total, 16 cement-paste mixtures were proportioned with three different carrageenan dosages of 0.5%, 1.0%, and 1.5%, by mass of water. For each dosage, a combination of (κ)- and (ι)-carrageenan corresponding to 50:50 was used, which simulates their existence in nature. This was also done to avoid the prolonged setting time by reducing the amount of (κ)-carrageenan. In addition, for each carrageenan dosage, cement suspensions were prepared with constant dosages of HRWR. The rheological properties, yield stress and plastic viscosity, viscoelastic properties, and the structural build-up kinetics at rest of flowable cement paste containing different dosages of carrageenan and HRWR were investigated. Then, the hydration kinetics and compressive strength development of the investigated mixtures were evaluated.

### Materials and Mixing Sequence

A General use (GU) Portland cementcomplying with the ASTM C150M specifications was used. The chemical and physical properties of GU cement are summarized in Table 2.1. The investigated mixtures were proportioned with a water to cement ratio (w/c) of 0.43. Three different types of high-range water-reducer (HRWR), corresponding to polycarboxylate (PC), polynaphthalene sulfonate (PNS1) and PNS2, were used at dosages of 0.43%, 1.44%, and 0.80%, by mass of cement, respectively. The HRWRs are obtained from the company Rütgers Polymers Canada and Sika Canada, respectively. The (κ)- and (ι)-carrageenan combination was used at dosages of 0.5%, 1.0%, and 1.5%, by mass of water. The (κ)- and (ι)-carrageenan used are food and type II commercial grade products, respectively, which were obtained from the company Sigma-Aldrich®. The mixtures were prepared in batches of 1.0 liter using a high shear mixer according to the procedure described in the ASTM C1738M specifications. The temperature of mixing water was controlled (11±2° C.) to compensate for the heat produced during mixing. At the end of mixing, all mixtures showed constant temperatures of 21±2° C. The mixing sequence consisted of introducing water, HRWR (if any), and VMA into the mixer. Then, the cement was introduced during 1 min while the mixer rotated at 4000 rpm. Then, the mixing speed was increased to 10 000 rpm for 30 seconds. After a rest period of 150 sec, the mixing was resumed at 10 000 rpm for 30 seconds. The sample was then left at rest for 10 min before carrying the measurements.

TABLE 2.1
Chemical and physical characteristics of the used GU cement

| SiO₂ | TiO₂ | Al₂O₃ | Fe₂O₃ | MgO | CaO | Na₂O | K₂O | SO₃ | BET | Blaine | Gs |
|---|---|---|---|---|---|---|---|---|---|---|---|
| (%) | | | | | | | | | (m²/kg) | | (g/cm³) |
| 20.4 | 0.2 | 4.4 | 2.5 | 2.1 | 62.0 | 0.0 | 0.8 | 3.8 | 1557 | 444 | 3.15 |

### Measurement Procedures

All rheological measurements were performed using a rotational coaxial-cylinders rheometer. Rough-surfaced cylinders were used to minimize slippage of the paste and prevent boundary layer formation. The inner cylinder rotates at different rotational speeds, while the outer cylinder remains stationary. The diameters of outer and inner cylinder are 28.911 and 26.660 mm, respectively, hence resulting in a narrow air gap of 1.126 mm. The flow curves, viscoelastic properties, including the linear viscoelastic domain (LVED) and rigidity, and the structural build-up kinetics (percolation time and rigidification rate) of the investigated cement suspensions were evaluated. The measurement procedures used to determine the flow curves consisted in applying a shear of 50 s⁻¹ for 30 s to ensure a homogeneous distribution of the sample within the gap. A rest period of 30 s was then allowed to reach the equilibrium temperature before carrying out the measurements. A pre-shear of 150 s⁻¹ for 2 min was applied before determining the flow curve. The shear rate was then reduced in 8 steps from 150 to 1 s⁻¹ (20 s/step) to assess the descending curve.

The LVED was identified using a shear strain sweep test, in which the sample is subjected to an increasing strain from 0.0001% to 100% at a constant angular frequency of 10 rad/s. This allowed to assess the storage (G′) and loss (G″) moduli within the LVED. Time sweep measurements were carried out to determine the structural build-up kinetics. The test procedure consisted of applying a pre-shear at 50 s⁻¹ during 10 s to ensure a homogenous distribution of the sample in the gap. The sample is then allowed a rest period of 30 s. Then, a small-amplitude oscillatory shear (SAOS) at a constant angular frequency of 10 rad/s and a shear strain value within the LVED during 60 s was applied (Mezger, 2011). A disruptive shear regime was applied before determining the kinetic of build-up. It consisted in applying a pre-shear of 200 s⁻¹ during 3 min. After 14 s of rest, time sweep measurements were carried out. This consisted in applying a SAOS during 20 min at an angular frequency of 10 rad/s and a shear strain value within the LVED (Mezger, 2011). This allowed monitoring the evolution of storage (G′), loss (G″) moduli, and phase angle (δ) with time at rest (Mostafa and Yahia, 2016). The hydration heat was also assessed using a semi-adiabatic TAM air calorimeter. For each of the investigated suspensions, a sample of 9.78 g is placed in the calorimeter to assess the change in heat flow for 48 h. Various 50×50×50 mm³ cubic molds were prepared to determine the compressive strength at 24 h and 7 days of age according to the ASTM C109 specifications.

### Results and Discussions

### Effect of (κ)-(ι)-Carrageenan Combination on Rheology and Viscoelastic Properties

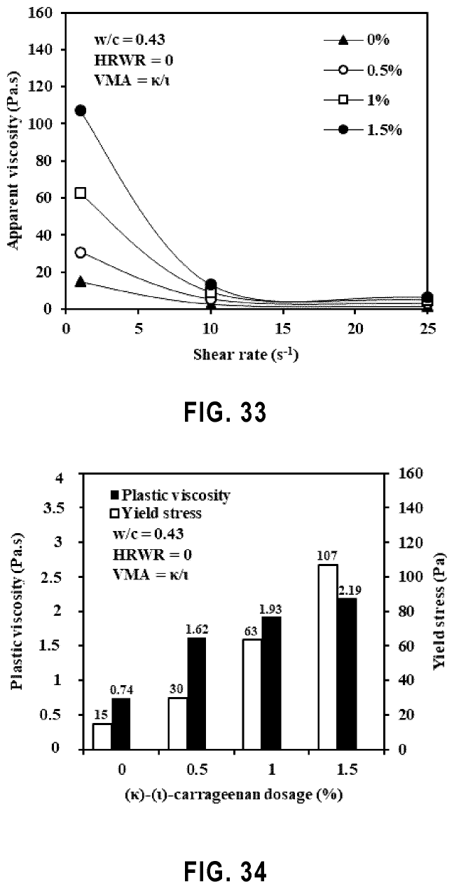

Typical flow curves and variation of the apparent viscosity of cement-paste mixtures containing different dosages of (κ)- and (ι)-carrageenan are shown in FIGS. 32 and 33. As can be observed, the incorporation of (κ)- and (ι)-carrageenan induced a shear-thinning behavior, which is characterized by a decrease in the apparent viscosity with the shear rate, regardless of the biopolymer's concentration. At low shear rates, the attractive forces dominate the hydrodynamic ones, hence leading to the formation of flocs. Increasing the shear rate, the long chain can align in the flow direction and an ordered state is established. The hydrodynamic forces overcome the attractive ones at high shear rates, thus decreasing the viscosity. The increase in (κ)-(ι)-carrageenan dosage resulted in higher pseudoplastic degree. The biopolymers combination possessing comparable density allowed to maintain the shear-thinning behavior observed with the (κ)-carrageenan alone. These two biopolymers, belonging to the hydrocolloid family, showed pseudoplastic behavior in a good solvent. From a functional point of view, the (κ)-(ι)-carrageenan combination do not act as thickening agents, but rather as gelling agents. The formed gel contributes to increase the rigidity of the system without causing a shear-thickening response. This made it possible to keep the shear-thinning behavior characteristic of cement suspensions.

The observed shear-thinning behavior can also be due to the dominant effect of (κ)-carrageenan gel. When it is used in combination with (ι)-carrageenan, the presence of the two biopolymers in aqueous solution resulted in dominant enthalpy interactions between similar chain segments than those between chains from different chains, thus inhibiting the mixing and interpenetration of different chains. It is important to note that (κ)-carrageenan polymer is composed of longer and more flexible polymer chains with a lower degree of sulfation compared to (ι)-carrageenan. These promote the shear-thinning of the investigated cement suspensions. Furthermore, diluted or concentrated NaCl or KCl ionic solutions containing (κ)- and (ι)-carrageenan tend to show a shear-thinning behavior, where the polysaccharide chains adopt a helical conformation.

The plastic viscosity and yield stress of cement-paste mixtures in the presence of carrageenan biopolymers combination were determined using a modified Bingham model (Yahia and Khayat, 2001). As can be observed, all the investigated cement suspensions exhibited a higher plastic viscosity compared to the reference mixture, regardless of the dosage of (κ)-(ι)-carrageenan. The increase in the dosage of (κ)-(ι)-carrageenan resulted in higher plastic viscosity. For example, the incorporation of 0.5% of (κ)-(ι)-carrageenan increased the plastic viscosity from 0.74 Pa·s to 1.62 Pa·s. The increase of dosage from 0.5% to 1.0%, and 1.5% enhanced the plastic viscosity to 1.93 and 2.19 Pa·s, respectively. This is in good agreement with the fact that the viscosity of NaCl solutions exhibits a strong dependence on the dosage of (κ)-(ι)-carrageenan, especially for concentrations below 1.5%.

The variations of the yield stress values of the investigated cement-paste mixtures with the dosage of (κ)-(ι)-carrageenan are shown in FIG. 34. The yield stress was highly affected by the dosage of (κ)-(ι)-carrageenan. Higher yield stress values were noted with higher dosage of (κ)-(ι)-carrageenan. For example, the increase in dosage from 0.5% to 1.0%, and 1.5% increased the yield stress from 30 Pa to 63 and 107 Pa, respectively. However, the (κ)-(ι)-carrageenan combination did not show important changes in yield stress compared to mixtures containing only (κ)-carrageenan.

The presence of (κ)- and (ι)-carrageenan biopolymers can contribute to the densification of the matrix by filling the interparticle voids and increase the bonding forces within the matrix. This leads to a more flocculated matrix with increasing the dosage of these VMAs. As a result, the higher the dosage of (κ)-(ι)-carrageenan, the higher the yield stress required.

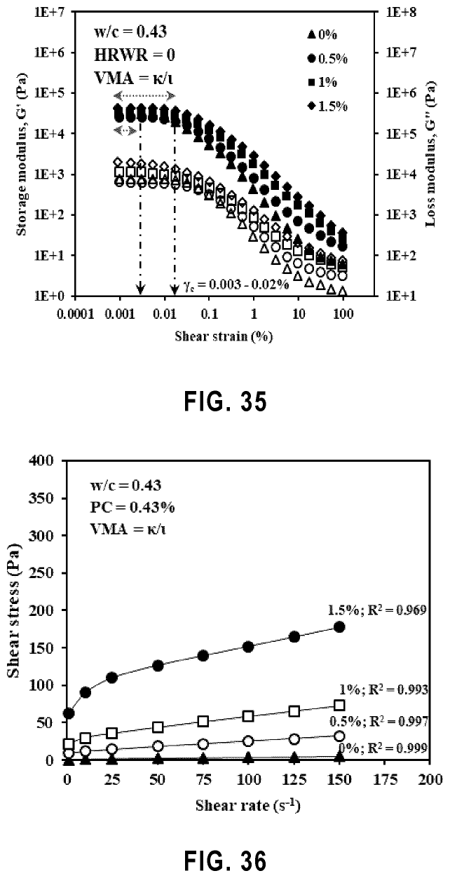

The variations of storage (G′) and loss (G″) moduli with shear strain are presented in FIG. 35. This allows to determine the critical shear strain, which is delimiting the linear viscoelastic domain (LVED). Within the LVED, the G′ is independent of the shear strain. As can be observed, the incorporation of (κ)-(ι)-carrageenan resulted in higher critical shear strain than 0.0030% of the reference mixture, regardless of the dosage of (κ)-(ι)-carrageenan. For example, the incorporation of 0.5% and 1.0% of (κ)-(ι)-carrageenan resulted in higher critical shear strain up to 0.0098%. However, the use of higher dosage of 1.5% resulted in higher critical shear strain of 0.0175%. The (κ)- and (ι)-biopolymers are formed of small-size colloidal spherical particles with high specific surface area, which contribute in densifying the system.

### Interaction between (κ)-(ι)-Carrageenan-SP and Its Effects on Rheology and Viscoelastic Properties

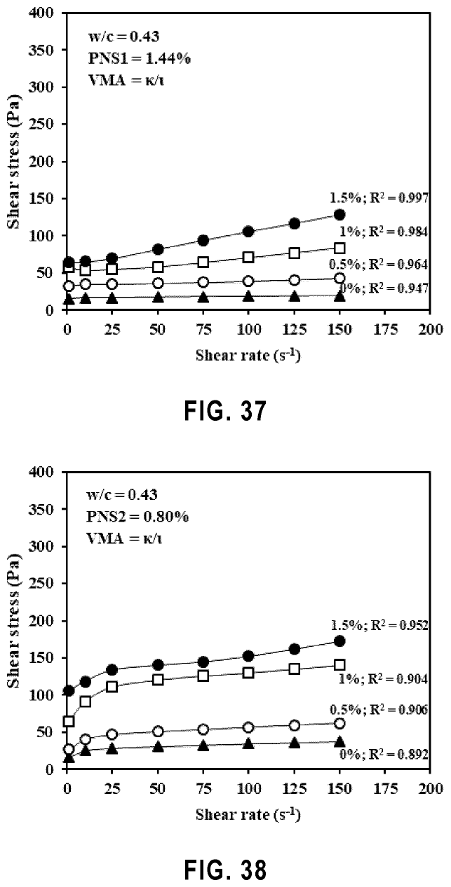

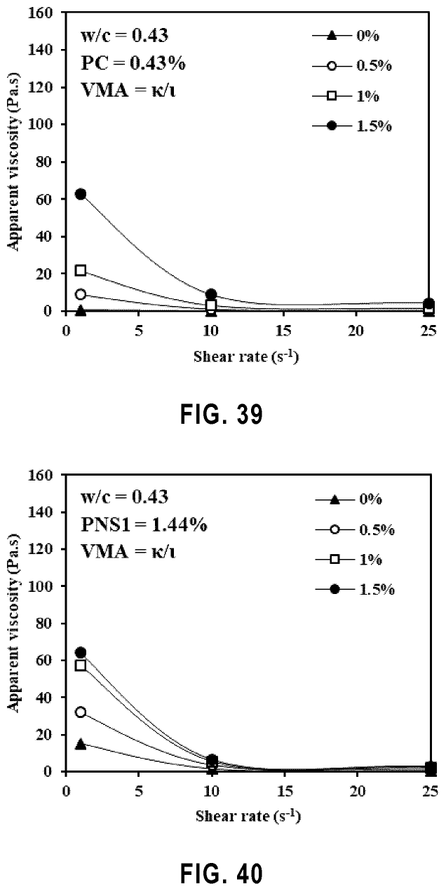

Typical flow curves of the investigated cement suspensions incorporating different dosages of (κ)-(ι)-carrageenan and high-range water-reducer (HRWR) are shown in FIGS. 36 and 37. The variations of the apparent viscosity with the shear rate are presented in FIGS. 39 to 41. As can be observed, the use of HRWR decreased the shear stress values, regardless of the (κ)-(ι)-carrageenan dosage. The use of PNS1 showed the most important variations of the rheology of the investigated cement suspensions compared to PC and PNS2 HRWR types, reflected by a transition from a shear-thinning to shear-thickening regime in the case of mixtures containing 1.0% and 1.5% of (κ)-(ι) carrageenan. The shear-thickening response observed in the case of mixtures containing relatively high concentration of biopolymers is probably due to the nature of (ι)-carrageenan chains that produce additional steric restrictions caused by the second anhydrous-galactose sulfate group.

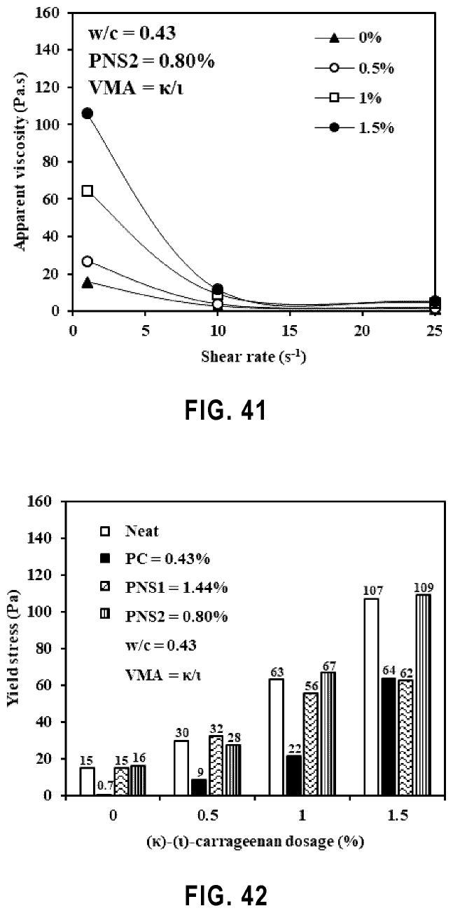

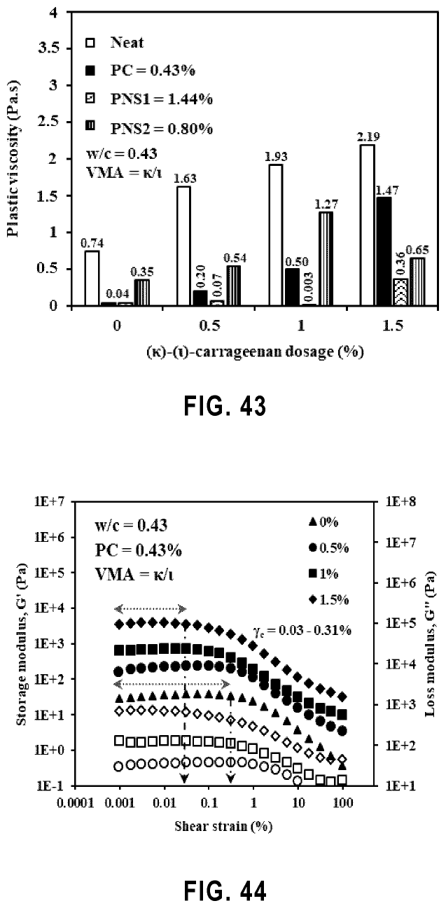

The yield stress and plastic viscosity values of cement suspensions containing different dosages of (κ)-(ι)-carrageenan and HRWR are shown in FIGS. 42 and 43. The incorporation of HRWR reduced the plastic viscosity of the investigated (κ)-(ι)-carrageenan mixtures compared to those made without HRWR, regardless of the HRWR type. The use of PNS1 resulted in a greater efficacy in decreasing the plastic viscosity than PC or PNS2 types. For example, the incorporation of PNS1 resulted in a 90% decrease in plastic viscosity. On the other hand, the use of PC type showed higher efficiency in the case of mixtures containing 0.5% and 1% of (κ)-(ι)-carrageenan, reflected by a decrease of viscosity by 88% and 74%, respectively. In the case of mixtures containing 1.5% of (κ)-(ι)-carrageenan, the incorporation of PC type resulted in 33% decrease in plastic viscosity. On the other hand, PNS2 decreased the plastic viscosity by up of 70% compared to mixtures containing only (κ)-(ι)-carrageenan.

The incorporation of HRWR resulted in a significant decrease of the yield stress values, regardless of the dosage of (κ)-(ι)-carrageenan. However, the incorporation of PNS1 induced higher yield stress compared to those obtained with mixtures incorporating only (κ)-(ι)-carrageenan. In contrast to PNS1, mixtures containing a low dosage of (κ)-(ι)-carrageenan showed a lower yield stress values than the mixture made without PNS2 HRWR. The increase in (κ)-(ι)-carrageenan dosage resulted in higher yield stress values despite of the presence of HRWR.

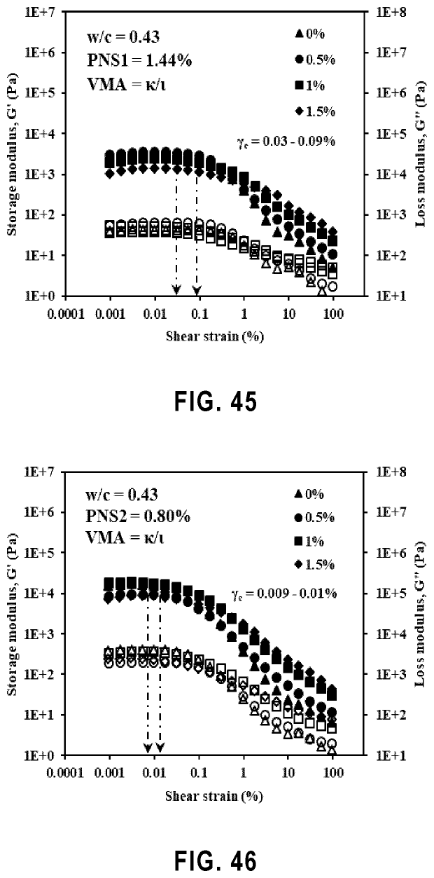

The FIGS. 44 to 46 show the results of small amplitude oscillatory shear (SAOS) measurements that carried out on the investigated cement suspensions incorporating different (κ)-(ι)-carrageenan dosages combination in the presence of HRWR. The incorporation of HRWR resulted in higher critical shear strains (i.e. wider LVED), hence reflecting better dispersion of the systems, regardless of the type of HRWR. The use of PC resulted in a wider LVED than PNS1 and PNS2 HRWR types. Critical shear strain values of 0.3080%, 0.0975%, and 0.0098% were obtained for mixtures containing PC, PNS1, and PNS2, respectively. This is mainly due to the mechanism of action of each HRWR type. Indeed, PC acting by steric effect ensure greater dispersion of cement particles than PNS type acting by electrostatic effect. The incorporation of HRWR decreased the rigidity of the investigated cement suspensions compared to those containing (κ)-(ι)-carrageenan alone. PC HRWR type showed the greatest reduction in rigidity compared to PNS types.

The addition of (κ)-(ι)-carrageenan polymers decreased the LVED even in the presence of HRWR. The use of higher dosage of (κ)-(ι)-carrageenan resulted in smaller LVED. This is probably due to the high specific surface area of these biopolymers, hence contribute in filling the inter-particles space and densification of the matrix. The incorporation of (κ)-(ι)-carrageenan in combination of PC HRWR type resulted in higher rigidity levels. In the case of mixtures incorporating PNS1 HRWR type, the increase of (κ)-(ι)-carrageenan dosage decreased the rigidity within the LVED. However, beyond the critical shear strain value, the storage modulus increased with the (κ)-(ι)-carrageenan dosage. The addition of PNS2 showed a different behavior than PC type. For example, the mixtures containing 0.5% and 1.5% of (κ)-(ι)-carrageenan used in combination with PNS2 exhibited lower storage modulus than those made without biopolymers.

It is admitted that the replacement of certain amount of (ι)-carrageenan by (κ)-carrageenan in aqueous solutions tend to result in the formation of less elastic and brittle gels, which require lower polysaccharide concentrations for their formation due to the decrease in the total sulfate content in the solution. This is due to the high content of sulphate ester contained in the main carrageenan chains which decreases their ability to form a rigid gel. This confirms that the effect of (κ)-carrageenan is dominant on the gel formation compared to (ι)-carrageenan. Therefore, the increase in the rigidity observed at low dosage of (κ)-(ι)-carrageenan is mainly due to the presence of (κ)-carrageenan chains. However, the decrease in the rigidity observed at high dosage of (κ)-(ι)-carrageenan is due to the presence of ι-ι double helices, which contribute to a fragile and soft gel despite of the presence of κ-κ double helices. Thus, as the percentage of sulfate groups provided by (ι)-carrageenan increases, the sensitivity of K⁺ cations decreases, and the properties of the gel weaken.

### Effect of (κ)-(ι)-Carrageenan on the Structural Build-Up Kinetics of Cement Suspensions

The structural build-up kinetics of cement suspensions containing different dosages of (κ)-(ι)-carrageenan was determined by monitoring the evolution of storage modulus (G′) and the phase angle (δ) during 20 min of rest. The phase angle “δ=tan⁻¹(G″/G′)” vary between 0° and 90°. The value of 0° corresponds to a perfect solid state (i.e. elastic), in which there is no delay between the induced strain and the measured stress response. In the case of a perfectly viscous structure, the value of δ is 90°.

Two independent indices can be used to describe the structural build-up kinetics of cement suspensions. The first index corresponds to the rest time required to form a percolated elastic network. This time can be referred to the percolation time (t_{perc.}). The second index consists of the rigidification rate (G_{rigid.}), which describes the capacity of the formed percolated network to support loads.

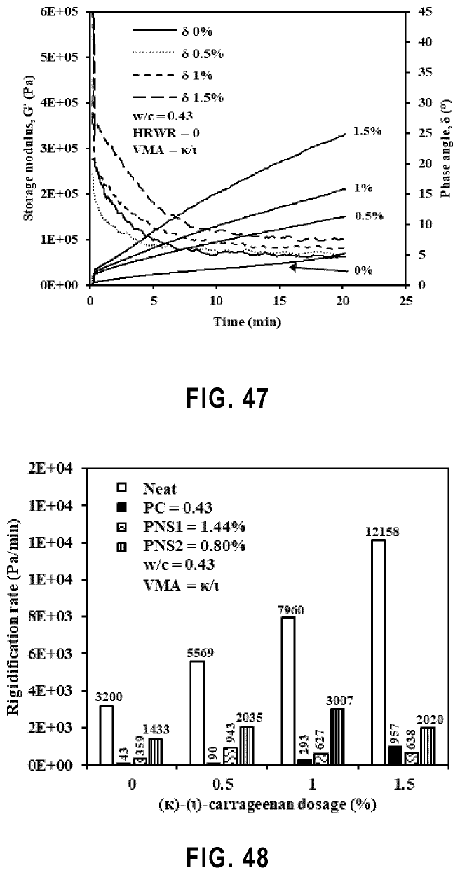

The evolution of storage modulus and phase angle with the resting time is shown in FIG. 47. As can be observed, immediately after the dispersion, all the investigated mixtures showed low storage modulus and high phase angle. This means that the applied pre-shear induced an efficient rupture of initial existing bonds between the particles. An increase in storage modulus (G′) with time was then observed, hence reflecting the saturation of the network. Simultaneously, the phase angle decreased until reaching a stationary state. This behavior reflects a transition from a liquid state to a solid state.

The addition of (κ)-(ι)-carrageenan showed a higher evolution of the storage modulus than the reference mixture, regardless of the dosage of (κ)-(ι)-carrageenan. This is mainly due to the participation of both (κ)- and (ι)-carrageenan gels in strengthening the formed network. Furthermore, the increase in the dosage of (κ)-(ι)-carrageenan resulted in higher build-up kinetics of the cement suspensions, and after a certain resting time, the phase angle did not show any change.

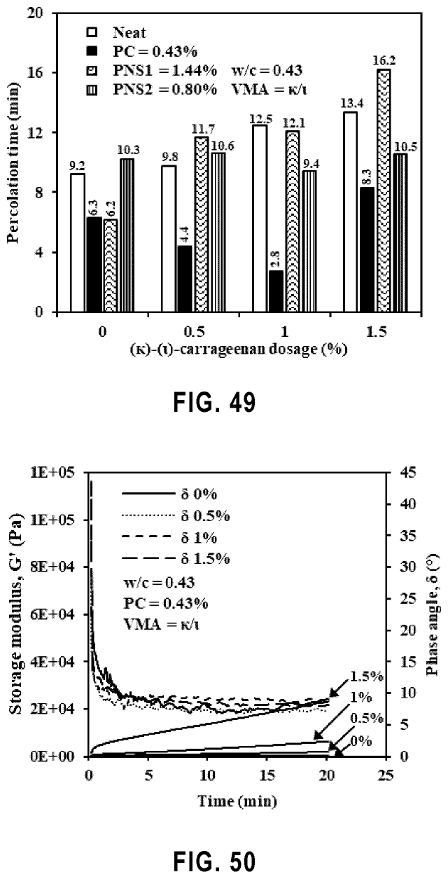

The variations of t_{perc.} and G_{rigid.} Values measured on cement suspensions incorporating different dosages of (κ)-(ι)-carrageenan are presented in FIGS. 48 and 49. The increase in (κ)-(ι)-carrageenan dosage increased the G_{rigid.} from 3200 to 12160 Pa/min. However, the use of higher dosages allowed a slower formation of the elastic network reflected by a longer t_{perc.} (9.2 min vs. 13.4 min). This is probably due to the longer relaxation time of the weak (ι)-carrageenan gels, which is caused by the topological entanglement between the two helices.

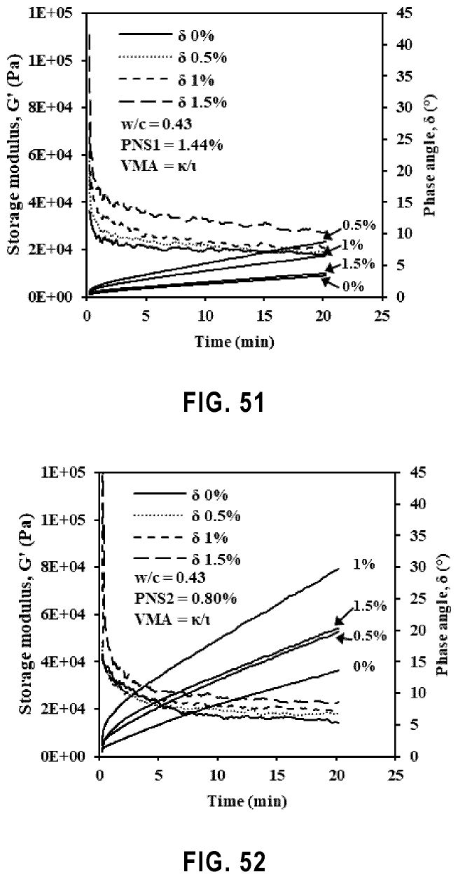

The evolution of storage modulus and phase angle of cement suspensions containing different dosages of (κ)-(ι)-carrageenan in the presence of HRWR during a rest period of 20 min shown in FIGS. 50 to 52 was used to determine t_{perc.} and G_{rigid.} indices. The incorporation of HRWR reduced the G_{rigid.}, regardless of the HRWR type. However, the formation of the elastic network was faster in the case of mixtures containing PC and PNS1 HRWR types than the reference mixture. In the case of the mixture containing PNS2, the t_{perc.} showed a greater increase with resting time than that of the reference mixture.

At low dosages of (κ)-(ι)-carrageenan of 0.5% and 1.0%, the addition of PC resulted in lower storage modulus compared to PNS1 and PNS2. The increase in the dosage to 1.5%, higher G_{rigid.} values were observed with PC mixtures than PNS1 ones. However, the addition of PNS2 maintained a higher rigidity than PC and PNS1 HRWR types, regardless of the dosage of (κ)-(ι)-carrageenan. The incorporation of PC HRWR resulted in a significant decrease of t_{perc.}, while PNS1 increased this index, regardless of the (κ)-(ι)-carrageenan dosage.

### Effect of (κ)-(ι)-Carrageenan Combinations and HRWR on the Hydration Kinetics of Cement Suspensions

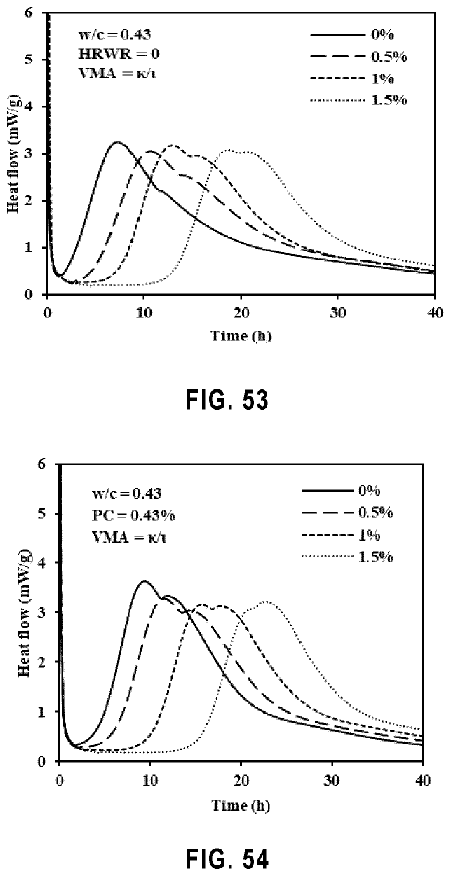

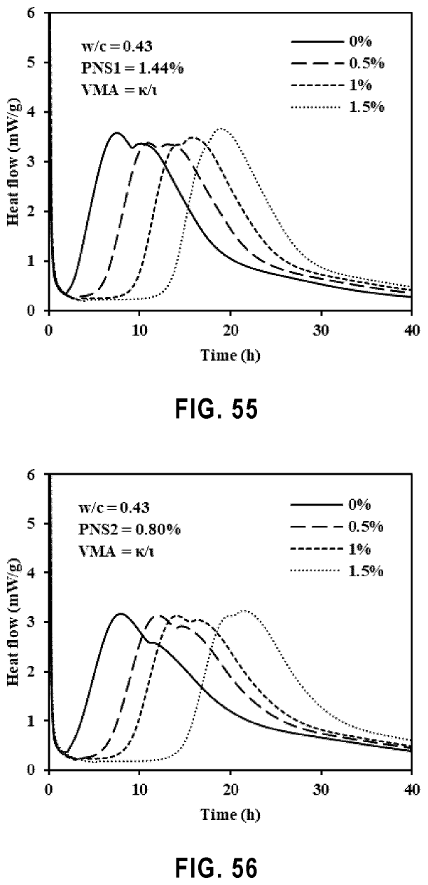

The heat fluxes of cement-paste mixtures containing different dosages of (κ)-(ι) are shown in FIG. 53. As can be seen, an extension in the dormant period was recorded, regardless of the dosage of (κ)-(ι)-carrageenan. For example, the dormant period increased from 3.6 h for a dosage of 0.5% to 4.8 h and to 10 h for dosages of 1.0% and 1.5%, respectively. A higher dosage resulted in a longer dormant period. The delay in cement hydration is probably due to the decrease in the concentration of Ca²⁺ ions, which are used by (ι)-carrageenan polymer to stabilize its junction sites in the brittle gel. In addition, the increase in the dosage of (κ)-(ι)-carrageenan decreased the maximum value of the second heat peak. These values decreased from 3.225 mW/g for the reference paste to 3.05 mW/g, 3.20mW/g, and, 3.10 mW/g for the mixtures containing 0.5, 1.0, and 1.5% of (κ)-(ι)-carrageenan, respectively.

In the case of PNS1 HRWR type, the incorporation of 0.5% (κ)-(ι)-carrageenan increased the dormant period to 4 h:12 min. The increase of dosages to 1.0% and 1.5% increased the dormant period to 6 h:48 min and 11 h, respectively. The second peak also showed a significant increase compared to mixtures containing only (κ)-(ι)-carrageenan without HRWR. The measured values were 3.40 mW/g for the PNS1/0.5%κ.ι and PNS1/1%κ.ι combinations, and 3.30 mW/g for the PNS1/1.5%κ.ι combination. In the case of PNS2, the dormant period also increased. The measured values were 5 h, 7 h, and 13 h for PNS2/0.5%κ.ι, PNS2/1%κ.ι, and PNS2/1.5%κ.ι combinations, respectively. However, the second peaks of cement suspensions containing PNS2 HRWR had a similar intensity of 3.10 mW/g, regardless of the dosage of (κ)-(ι)-carrageenan.

### Effect of (κ)-(ι)-Carrageenan on the Compressive Strength of Cement Suspensions

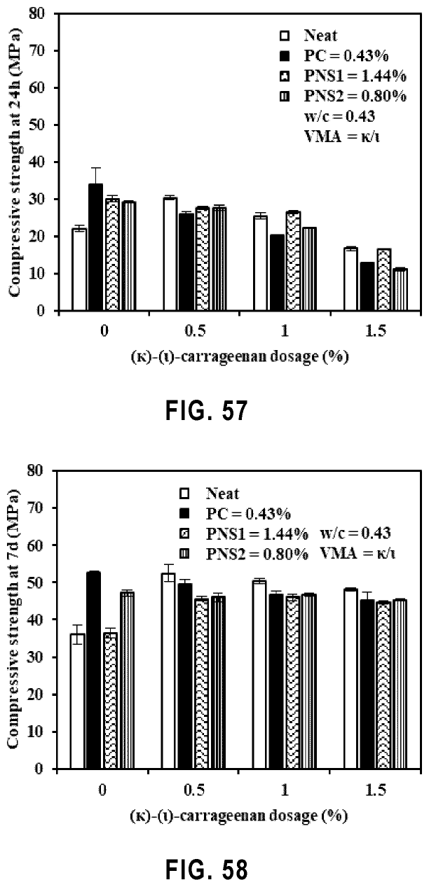

The compressive strength values measured on reference mixtures and those containing different dosages of (κ)-(ι)-carrageenan after 24 h of curing is shown in FIG. 57. The addition of carrageenan biopolymers positively influenced the compressive strength development. At low dosages of (κ)-(ι)-carrageenan, the compressive strength showed a significant increase compared to the reference mixture. This can be due to the high rigidity of the formed gel, despite the delay of the hydration reaction compared to the reference mixture. However, the use of higher dosages of (κ)-(ι)-carrageenan decreased the strength development. This can be explained by the fact that the delay effect dominates the positive contribution of the gel rigidity.

The addition of PC HRWR type showed a significant increase in the early-age compressive strength of the mixtures containing (κ)-(ι)-carrageenan, PNS1, and PNS2. Mixtures containing PC HRWR type tend to achieve greater compressive strength than those incorporating PNS type, regardless of the age of mixtures. In the case of mixtures containing (κ)-(ι)-carrageenan, the addition of HRWR significantly reduced the compressive strength. In addition, increasing the dosage of (κ)-(ι)-carrageenan resulted in further reduction of the compressive strength. This is probably due to the additional hydration delay and the weakness of the gels formed in the presence of the HRWR.

The compressive strength of mixtures containing different dosages of (κ)-(ι)-carrageenan determined after 7 days hardening are shown in FIG. 58. In the absence of HRWR, the use of (κ)-(ι)-carrageenan increased the compressive strength, regardless of the dosage of (κ)-(ι)-carrageenan, compared to the reference mixture. However, the addition of PC and PNS2 types decreased the compressive strength. In the case of mixtures containing PNS1, the addition of (κ)-(ι)-carrageenan increased the compressive strength, regardless of the dosage of (κ)-(ι)-carrageenan, compared to the mixtures containing PNS1.

### Conclusions

The effect of binary hydrocolloid gelling systems as VMA on the properties of cement-based suspensions is evaluated. Based on the results presented herein, the following conclusions can be pointed out:
Cement suspensions containing (κ)-(ι)-carrageenan exhibited higher plastic viscosity and yield stress values compared to the reference mixture. The use of (κ)-(ι)-carrageenan combination resulted in higher plastic viscosity that (κ)-carrageenan;
The use of HRWRs reduced the plastic viscosity of cement suspensions containing (κ)-(ι)-carrageenan, regardless of the concentration of biopolymer and the type of HRWR;
Cement suspensions incorporating (κ)-(ι)-carrageenan showed higher rigidity and longer linear viscoelastic domain (LVED) compared to the reference mixture. Therefore, for a given dosage of 1.5% of (κ)-(ι)-carrageenan, longer LVED than that of cement suspensions containing the same dosage of (κ)-carrageenan was observed;
A low (κ)-(ι)-carrageenan dosage of 0.5% greatly increased the rigidity of the investigated cement suspensions compared to those containing an equal dosage of (κ)-carrageenan;
The incorporation of (κ)-(ι)-carrageenan increased the rigidity but decreased the length of the LVED of cement suspensions containing HRWRs, regardless of the type of HRWR and the dosage of (κ)-(ι)-carrageenan;
The incorporation of (κ)-(ι)-carrageenan increased the structural build-up kinetics of cement suspensions, reflected by higher G_{rigid.}. However, the increase in (κ)-(ι)-carrageenan dosage resulted in higher t_{perc.};
The use of HRWR reduced the structural build-up kinetics of cement suspensions containing (κ)-(ι)-carrageenan, regardless of the type of HRWR;
The incorporation of (κ)-(ι)-carrageenan in cement suspensions resulted in higher dormant period. Higher dormant period was observed in the presence of HRWR. However, compared to (κ)-carrageenan, the (κ)-(ι)-carrageenan combination reduced the duration of the dormant period by about 50%; and
The use of (κ)-(ι)-carrageenan resulted in higher compressive strength compared to (κ)-carrageenan. Higher dosages of (κ)-(ι)-carrageenan decreased the compressive strength. Also, the addition of HRWRs reduced the compressive strength of mixtures containing (κ)-(ι)-carrageenan compared to mixtures without HRWR.

### Example 3—Comparative Study of the Effect of Kappaphycus alvarezii Seaweed Powder and (κ)-Carrageenan on Rheology, Stability, Microstructure, and Mechanical Performance

The objective of this study is to valorize the Kappaphycus alvarezii seaweed powder as a VMA in cement matrices. The determination of the physical characteristics of K. alvarezii seaweed powder as well as (κ)-carrageenan (e.g., density, Blaine fineness, morphology, and chemical composition) was performed. More specifically, we compared the effects of K. alvarezii seaweed and (κ)-carrageenan powders on the rheology, stability, and hydration kinetics of cement suspensions.

We first evaluated the effect of K. alvarezii seaweed powder and refined (commercial) (κ)-carrageenan on the rheology of aqueous solutions by determining the rheological parameters of these solutions (i.e. the yield stress and plastic viscosity). This was carried out in order to identify the dosage of K. alvarezii seaweed powder and cooking conditions, which can give the same rheological properties determined from solutions containing different dosages of (κ)-carrageenan. Therefore, different K. alvarezii seaweed powder dosages, times, and cooking temperatures are considered to ensure comparable rheological performances to that of (κ)-carrageenan. Obtaining comparable rheological behaviors confirmed the feasibility of using K. alvarezii seaweed powder as a VMA instead of refined (κ)-carrageenan in cement-based materials.

Then, after selecting the solutions having a rheological behavior comparable to that of solutions containing (κ)-carrageenan, we evaluated the effect of these solutions containing K. alvarezii seaweed powder on the cement systems. The rheological and viscoelastic properties, the structural build-up kinetics at rest, the forced bleeding, and the cement hydration kinetics were determined.

### Materials

A general use (GU) cement complying with ASTM C150M standard was used. This cement had a density of 3.15. The chemical and physical properties of cement are reported determined in Table 3.1. All the investigated cement paste mixtures were proportioned using a water to cement ratio (w/c) of 0.43.

TABLE 3.1
Chemical and physical characteristics of cement used

| SiO₂ | TiO₂ | Al₂O₃ | Fe₂O₃ | MgO | CaO | Na₂O | K₂O | SO₃ | BET | Blaine | Gs |
|---|---|---|---|---|---|---|---|---|---|---|---|
| (%) | | | | | | | | | (m²/kg) | | (g/cm³) |
| 20.4 | 0.2 | 4.4 | 2.5 | 2.1 | 62.0 | 0.0 | 0.8 | 3.8 | 1557 | 444 | 3.15 |

Different varieties of K. alvarezii seaweeds (brown, green, and red) were obtained from a commercial farm in Indonesia (PT Alamindo Makmur Cemerlang, 2020). Moreover, a food grade (κ)-carrageenan was obtained from the company Sigma-Aldrich® in order to compare the properties of the native K. alvarezii seaweed powder with those of the reference product (i.e. the commercial (κ)-carrageenan). The (κ)-carrageenan used in this example was the same product used in the two previous examples.

### Methods

### Treatment and Conditioning of K. alvarezii Seaweeds

K. alvarezii seaweeds were supplied from a commercial farm in Indonesia (PT Alamindo Makmur Cemerlang, 2020). According to this seaweed provide, after harvesting, the seaweeds were sundried to reduce their moisture content to less than 36% and mixed with sea salt. Indeed, sea salt is a natural conservative that protects seaweeds against microbial contaminations. After receiving these seaweeds, a pre-treatment was carried out as follows.

First, the dried K. alvarezii seaweeds were carefully washed with tap water to remove salt and impurities, such as epiphytes (other seaweeds), mollusks shells, small stones, sand, etc. The wet seaweeds were then dried in an oven at 60° C. for 72 h to remove the excess moisture. The dried seaweeds were minced using a blender, then ground in a ball mill for 1 h. After grinding, the resulting seaweed powder was sieved through a series of sieves with 315, 160 and 100 μm and then stored until characterization. Any fraction greater than 160 μm was eliminated. Two powder fractions (particles ≤160 μm and ≤100 μm) were chosen for characterization and rheological measurements.

### Homogenization of the K. alvarezii Seaweed Powder

In order to avoid an inadequate particle size distribution of K. alvarezii powder, the powder was homogenized using a V-blender type. The V-blender consisted of two hollow cylinders joined at a typical angle of 75° to 90°. As the V-blender rotated, the material continuously divided and recombined. The powder was mixed as it fell freely and randomly inside the container, which resulted in a homogeneous mixture. A rotational speed of 12 rpm for 30 min was used to homogenize the powder. These parameters were chosen to avoid powder segregation due to the high centrifugal forces.

### Characterization of the K. alvarezii Seaweed Powder

Physical characterization of the K. alvarezii seaweed powder and of (κ)-carrageenan, including density measurements, Blaine fineness as well as Scanning Electron Microscopy and Energy Dispersive Spectroscopy (SEM-EDS), was carried out in order to determine the similarities and differences between the particles of the two types of studied powders.

The density of the studied powders was determined using a Helium® pycnometer. This instrument measures the volume of a powder for which the mass is known.

Blaine fineness was determined using a Blaine permeability meter according to ASTM C204 standard. The test consisted of measuring the passing time of a volume of air through a volume of powder placed and compacted in a cell.

Particle morphology of was examined by SEM (Hitachi® S-4700), which operated with an accelerating voltage that can vary from 1 kV to 30 kV. This microscope had a magnification capacity of up to 500,000× with a resolution of up to 5 nm. In this study, a magnification of 250× and 1000× and voltage of 5 kV were used.

### Cement Pastes Mixing Sequence

The investigated cement paste mixtures were prepared in batch of 1 liter using a high shear blender and the mixing procedure described in the ASTM C1738 M standard. The temperature of mixing water was controlled and maintained at 11±2° C. to compensate for heat generation during mixing. After mixing, all mixtures had constant temperatures of 21±2° C. Water and either (κ)-carrageenan powder or aqueous solution containing a precise dosage of K. alvarezii seaweed powder was first added into the blender. The cement was then gradually introduced over 1 min, while the mixer operated at a rotational speed of 4 000 rpm. Then, the mixing speed was increased to 10 000 rpm for 30 seconds. After a rest period of 150 s, the mixing was resumed at a rotating speed of 10 000 rpm for 30 s. The sample was then left at rest for 10 min before carrying the rheological measurements.

### Rheological Measurements

### Preparation of Aqueous Solutions of K. alvarezii

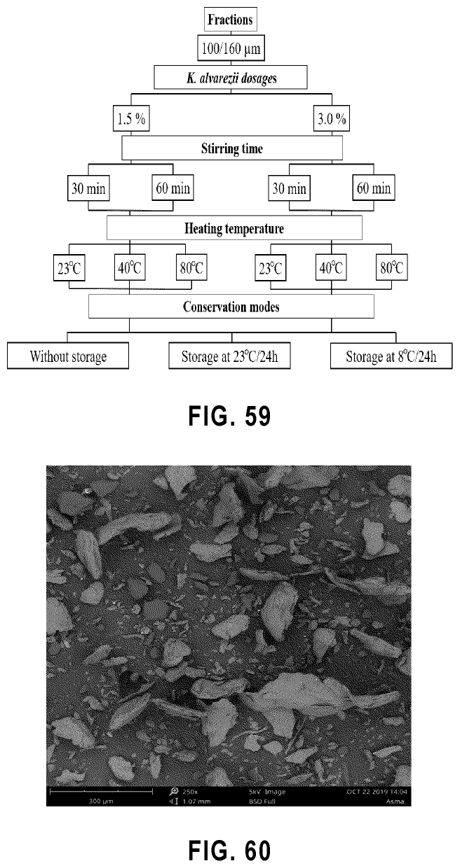

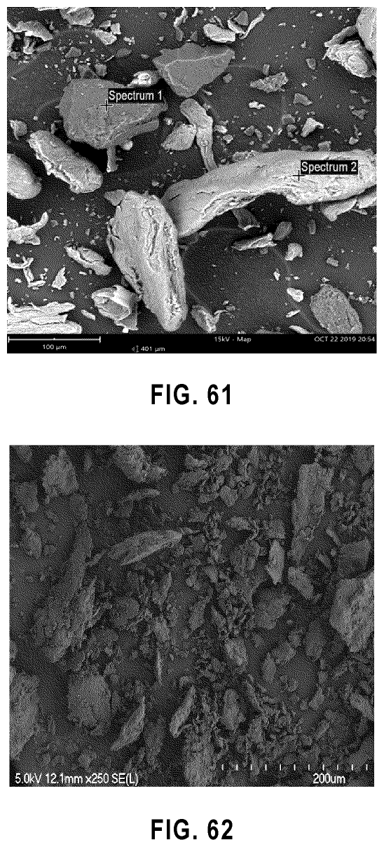

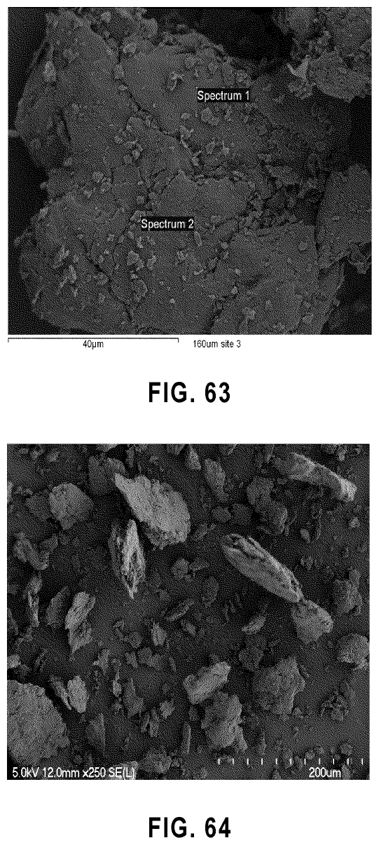

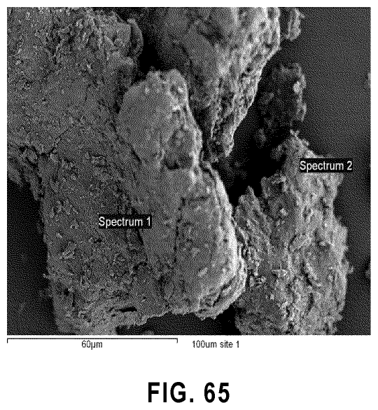

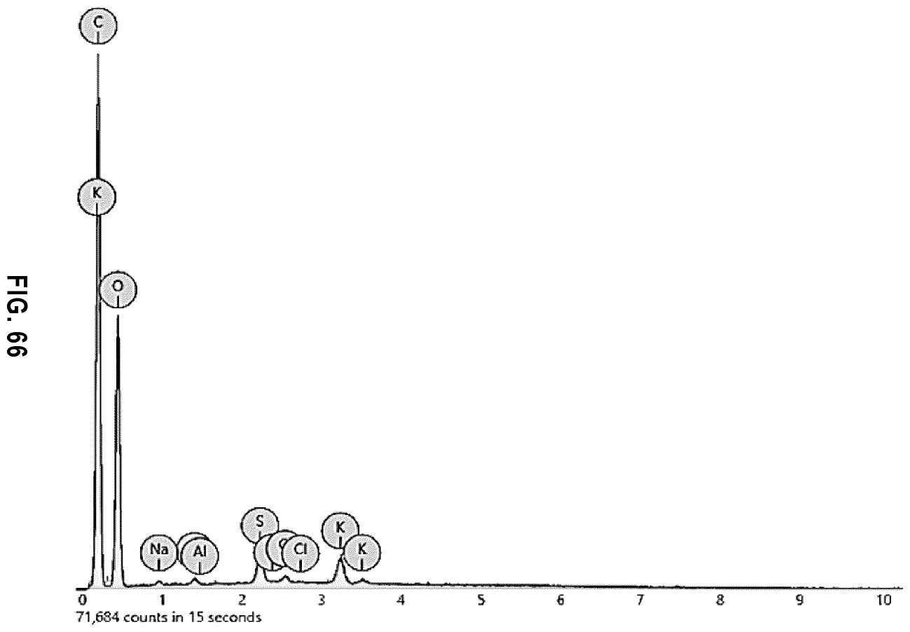

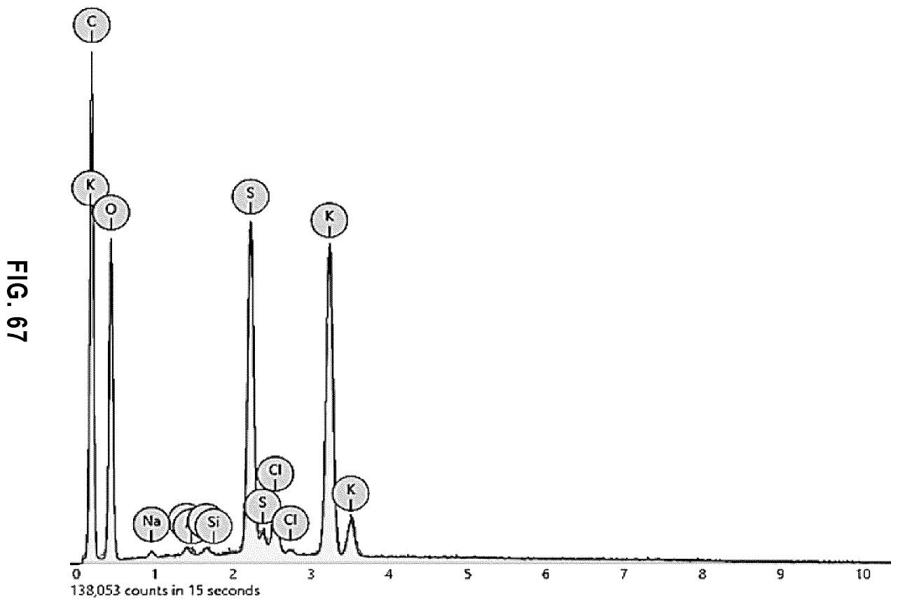

In order to determine the effect of K. alvarezii seaweed powder on the rheological properties of aqueous solutions, an exhaustive experimental program (72 experiments) was carried out (see FIG. 59). These 72 mixtures were prepared by dissolving either 1.5 g and 3 g weight/weight (w/w) of K. alvarezii seaweed powder in 100 ml of distilled water maintained under continuous magnetic stirring for 30 min and 60 min at 23, 40, and 80° C. For all prepared solutions, K. alvarezii seaweed powder was not added to the water until the desired temperature was reached. Time zero corresponded to the introduction time of the powder. The solutions were then cooled for 15 min and finally directly either tested or stored at room temperature (˜23° C.) or in the refrigerator (8±2° C.) for about 24 h before performing the rheological measurements. In addition, solutions containing different dosages of (κ)-carrageenan corresponding to 0.5%, 1.0%, and 1.5% w/w were prepared by dispersing the required amount of the (κ)-carrageenan powder in distilled water maintained at room temperature. These solutions were magnetically stirred until dissolution of the powder.

### Rheological Measurement Procedures

The rheological properties of the above various mixtures were assessed using a high precision Anton Paar MCR 302 coaxial cylinders rheometer equipped with a Peltier system capable of varying the temperature from −160 to +1000° C. In this study, the sample temperature was maintained at 23° C. for all rheological measurements. The configuration used consisted of a profiled inner cylinder connected to a motor that measured the torque through the application of different rotational speeds, while the outer cylinder remains stationary. The profiled cylinders were used to reduce the wall slip. The inner and outer cylinders have 26.660 mm and 28.911 mm diameters, respectively, resulting in a narrow gap of 1,126 mm, thus allowing to ensure constant shear rate across the gap.

The rheological measurements reported hereinbelow were carried out on each sample to determine the flow curves, the strain sweep (i.e. the determination of the viscoelastic properties), and the time sweep (i.e. the determination of the structural build-up kinetics at rest) of the studied cement suspensions.

### Flow Curves

The test procedure used to determine the flow curves consisted in pre-shearing the sample at 50 s⁻¹ for 30 s to ensure homogeneous distribution of the sample in the shear gap. The sample was then allowed a rest period of 30 s to allow the temperature stabilization of the tested sample. The descending curve was determined by applying a pre-shear of 150 s⁻¹ during 2 min, then by decreasing the shear rate from 150 s⁻¹ to 1 s⁻¹ during 160 s (8 steps, 20 s for each step). Each point was an average of 6 simultaneously measured values (analytical replicates). As a result, this rheological protocol was reproducible, thus giving high precision measurements. Despite this, to be more precise, all the tests are repeated three times.

The rheological parameters, yield stress and plastic viscosity, were determined from the descending curve using the modified Bingham model (Equation 1). This model can solve the problems of the low shear rate non-linearity observed in highly pseudoplastic mixtures flow curves (Yahia and Khayat, 2001). Therefore, it provides a better description of the non-linear behavior, without increasing calculation complexities. The shear stress of modified Bingham model follows a second-degree polynomial law beyond a yield stress point (T_{0, MB}):

$$\{ \begin{matrix}τ = {τ}_{0 , MB} + {μ}_{p , MB} \cdot \dot{γ} + {c}_{MB} \cdot {\dot{γ}}^{2} & si τ > {τ}_{0} \\ \dot{γ} = 0 & si τ \leq {τ}_{0}\end{matrix} \qquad Equation 1$$

where c_{MB}(Pa·s²) is a second order parameter.

### Strain Sweep

In addition to the flow curves, for each cement paste mixture, the linear viscoelastic domain (LVED) was identified using a shear strain sweep test, in which the sample is subjected to an increasing shear strain of 0.0001% to 100% at a constant angular frequency of 10 rad/s (Joshi et al., 2013; Lootens et al., 2004; Mezger, 2011; Mostafa and Yahia, 2016) allowing to follow the evolution of the storage (G′) and loss (G″) moduli with the shear strain.

The main objective of this test is to determine three major parameters: (1) the maximum rigidity (G′ₘₐₓ), which represents an indication of cement paste elasticity or rigidity. (2) the linear viscoelastic domain (LVED), which represents an indication of the distance between cement paste particles. The longer the LVED, the greater the distance between suspension particles (and vice versa). (3) the critical shear strain (γ_{c}), which corresponds to the shear strain value at which the G′ values begin to deviate noticeably from the preceding constant values (Mezger, 2011) by more than 5%. When the sample is subjected to a shear strain less than the critical strain, it behaves like a solid structure, thus the imposed shear strain is insufficient to induce the material flow. However, when the imposed shear strain is greater than the critical shear strain value, the material flow may occur.

The static yield stress is another important parameter that can be used as a measure of the strength and number of inter-particle bonds that are ruptured due to the applied shear strain (Mostafa and Yahia, 2016). Indeed, the static yield stress can also be determined by applying an increasing shear strain from 0.0001% to 100% at a constant angular frequency of 10 rad/s (i.e. the same measuring procedure used to determine the above three aforementioned parameters). The shear stress increases up to a certain critical strain (γ_{c}). The shear stress that corresponds to this critical strain indicates the static yield stress (T₀ₛ), which is defined as the energy required to induce a significant displacement between two particles. If the bonds between particles are broken, the interparticle attractive forces are eliminated and the material begins to flow.

### Time Sweep

Time sweep measurements were carried out to determine the structural build-up kinetics. Indeed, time sweep measurements can also be used for determining the thixotropy of cement suspensions. The test procedure consisted of applying a pre-shear at 50 s⁻¹ during 10 s to ensure a homogenous distribution of the sample in the gap. The sample is then allowed a rest period of 30 s. Then, a small-amplitude oscillatory shear (SAOS) at a constant angular frequency of 10 rad/s and a shear strain value within the LVED during 60 s was applied (Mezger, 2011). A disruptive shear regime is applied before determining the kinetic of build-up. It consisted in applying a pre-shear of 200 s⁻¹ during 3 min. After 14 s of rest, time sweep measurements were carried out. This consisted in applying a SAOS during 20 min at an angular frequency of 10 rad/s and a shear strain value within the LVED (Mezger, 2011). This allowed monitoring the evolution of the storage (G′), loss (G″) moduli, and phase angle (δ) with time at rest (Mostafa and Yahia, 2016).

Two independent indices can be determined to describe the structural build-up kinetic and thixotropy of cement suspensions (Mostafa and Yahia, 2016). The first index corresponds to a rest time necessary to form an elastic colloidal percolated network. This time can be defined as the percolation time (t_{perc.}). The percolation time was determined from the phase angle curve, where this curve begins to stabilize over time by more than 5%. The second index represents the increase in the ability of the formed structure to support loads after the formation of the percolate network. This index corresponds to a rigidification rate (G_{rigid.}) corresponding to the slope of the curve G′ after the t_{perc.} (Mostafa and Yahia 2016).

### Forced Bleeding

The ability of the cement paste to retain part of its free water in suspension under sustained pressure was determined using a cylindrical steel vessel containing a standard Guelman filter capable of retaining 99.7% of solid particles with diameters greater than 0.3 μm (method adapted from standard ASTM D5891—“API 1991”). The method consists in introducing 200 ml of cement paste in the container. Then a sustained pressure of 80 psi (equivalent to 0.55 MPa), for 10 min, was applied using nitrogen gas. The resistance of the cement-paste mixtures to forced bleeding is evaluated by calculating the percentage of the forced bleeding water relative to the mixing water present in the tested sample.

### Hydration Kinetics of Cement

A calculated mass of each cement-paste mixture equivalent to 9.78 g was weighed in an ampoule. The ampoule was then closed and placed in the calorimeter. The evolution of heat release was recorded for 72 h. The resulting heat flow curve can reflect the cement hydration process as well as the different hydration phases.

### Statistical Analysis

Analysis of variance (ANOVA) was performed to determine significant differences between the studied mixtures. This analysis was carried out considering a confidence interval of 95%. The significance of the control factors was assessed by calculating the degree of freedom (DDL), sum of squares (SS), and mean of squares (MS).

The objective of this analysis is to determine which of the considered factors can have a significant effect on the rheological parameters of studied mixtures.

To determine which of the means are significantly different from each other, multiple pairwise comparisons are carried out. There are different methods that can be used to perform this comparison. In the case of this study, Tukey Kramer's method was used. The letters A, B, C, etc. presented above or beside each average help identify the significant differences between the means. Two means with, at least, one letter in common are not significantly different. In contrast, two means with no letters in common are significantly different.

### Results

### Physical Properties

The physical properties of the commercial (κ)-carrageenan and K. alvarezii seaweed powders are shown in Table 3.2. The two fractions (particles≤160 μm and ≤100 μm) of K. alvarezii seaweed powder have the same density (1.62 g/cm³). Nevertheless, the density of (κ)-carrageenan powder is significantly higher (1.66 g/cm³) compared to that of the two aforementioned fractions. As far as, the two fractions of K. alvarezii seaweed studied powder have a lower density than that presented in Jumaidin's et al. (2017) work. This is probably due to the different processing and conditioning methods as well as the different growth locations of these seaweeds. In the case of Blaine fineness, the finer fraction (particles≤100 μm) has a significantly higher fineness (435 m²/kg) than that of the less fine fraction (particles≤160 μm) (374 m²/kg) and commercial (κ)-carrageenan (203 m²/kg), which gives it a fineness close to that of GU Portland cement (˜400 m²/kg).

TABLE 3.2
Physical properties of commercial (κ)-carrageenan,
K. alvarezii powders, and other materials

| | | Blaine | |
|---|---|---|---|
| | Density | fineness | |
| | (g/cm³) | (m²/kg) | References |
| Commercial (κ)-carrageenan | 1.66 ± 0.00 | 203 ± 6 | The present study |
| K. alvarezii - 160 μm | 1.62 ± 0.00 | 374 ± 5 | The present study |
| K. alvarezii - 100 μm | 1.62 ± 0.00 | 435 ± 8 | The present study |
| Low industrial grade semi- | 1.65 ± 0.00 | — | Norhazariah et al. |
| refined carrageenan | | | (2018) |
| High industrial grade semi- | 1.65 ± 0.00 | — | Norhazariah et al. |
| refined carrageenan | | | (2018) |
| K. alvarezii (raw) | 1.70 ± 0.01 | — | Jumaidin et al. |
| | | | (2017) |

The particle morphology of commercial (κ)-carrageenan and K. alvarezii seaweed powders (two fractions: particles≤160 μm and ≤100 μm) was analyzed using SEM. SEM images (250× and 1000× magnification) are shown in FIG. 60. As can be observed, the particles of commercial (κ)-carrageenan (a and b) and K. alvarezii (c-f) exhibit an amorphous, irregular and flake-like shape. However, it is important to mention that the particles of K. alvarezii show mainly heterogeneous and rough surfaces. However, commercial (κ)-carrageenan particles have a granular shape with less rough surfaces than those of K. alvarezii particles. The two K. alvarezii fractions analyzed particles show a similar morphology with a higher number of smaller particles in the finer fraction (particles≤100 μm) compared to the coarser fraction (particles≤160 μm). However, the fraction containing the coarse particles appears denser due to the fact that this matrix comprises, at the same time, proportions of small and large particles, which decrease the intergranular voids. This difference in morphology and size of K. alvarezii or (κ)-carrageenan particles is essentially due to the processing and preparation methods, particularly the grinding methods.

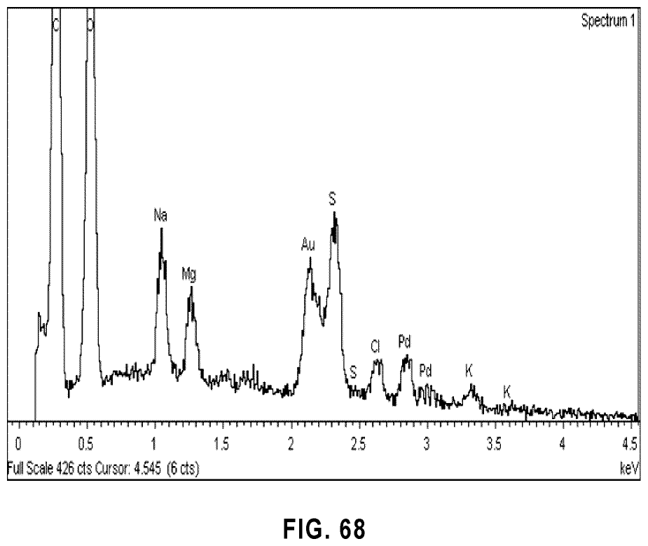

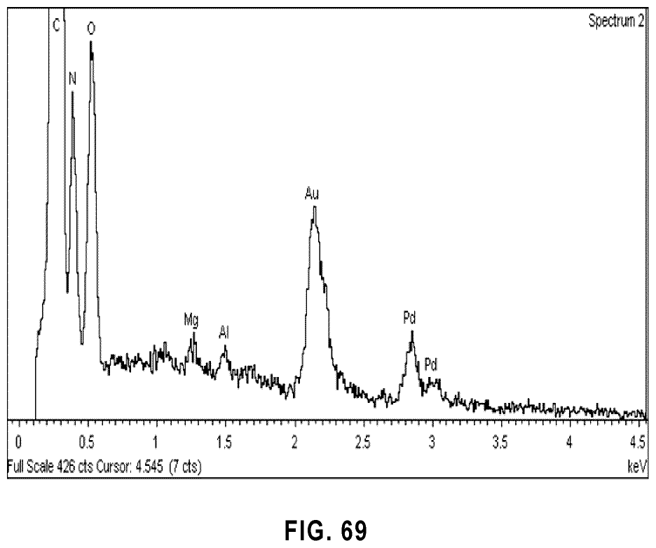

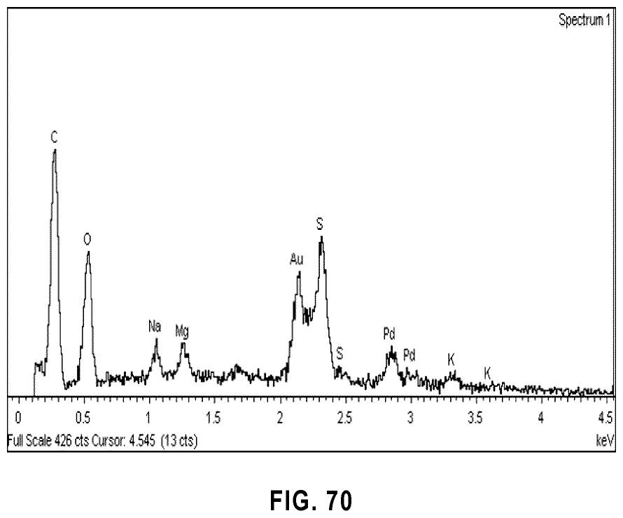

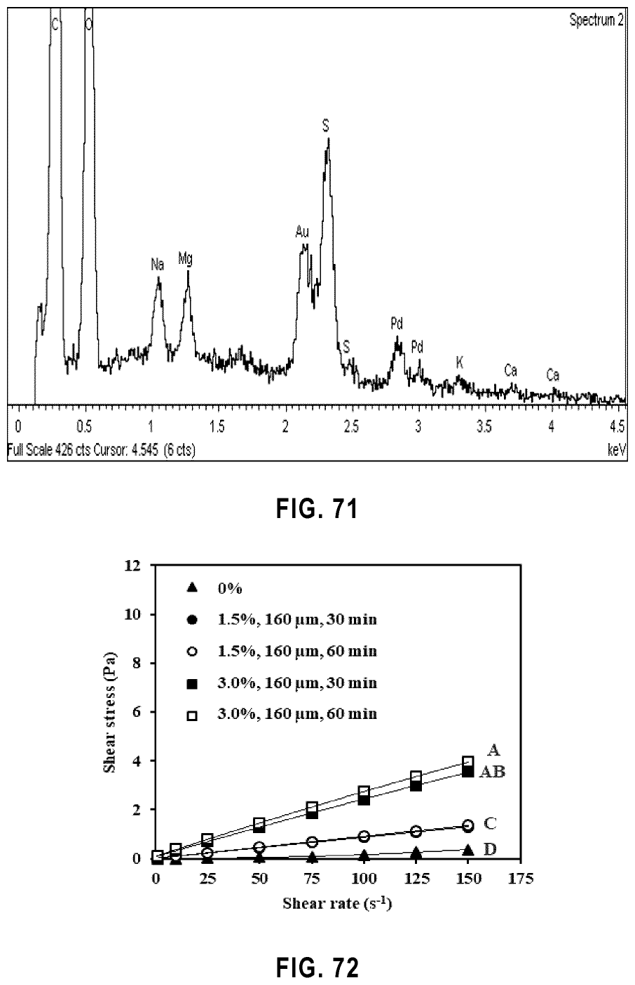

FIGS. 66 to 71 present the results of elemental analysis (EDS: energy dispersion spectrometry) of K. alvarezii and commercial (κ)-carrageenan particles. As can be observed, the two powders have higher carbon and oxygen contents due to the organic nature of the seaweed. In addition to these major elements, the analyzed powders contain other minor elements, such as Na, Ca, Si, K, S, CI, and Mg.

### Rheological Properties of Aqueous Solutions Containing K. alvarezii Seaweed Powder

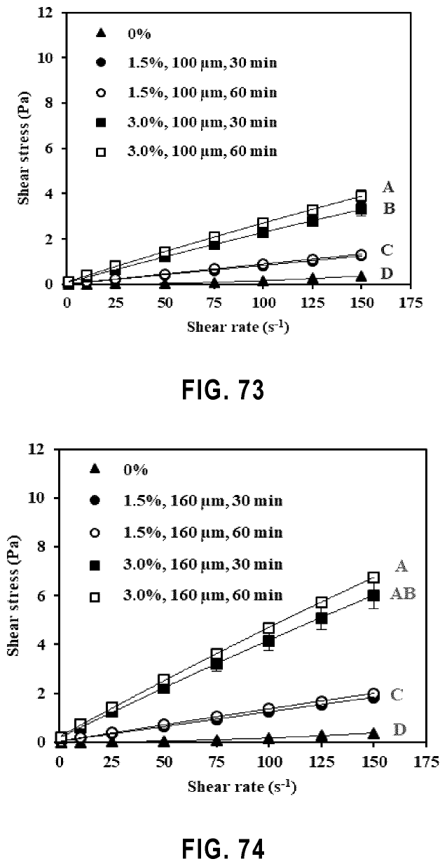

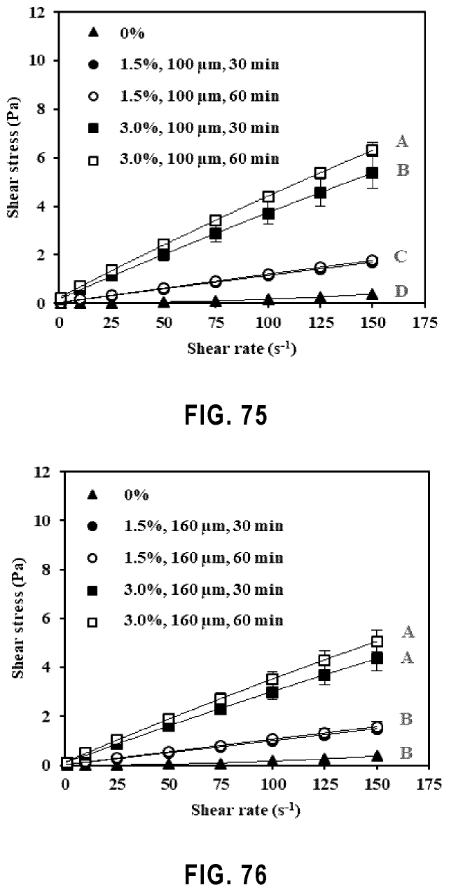

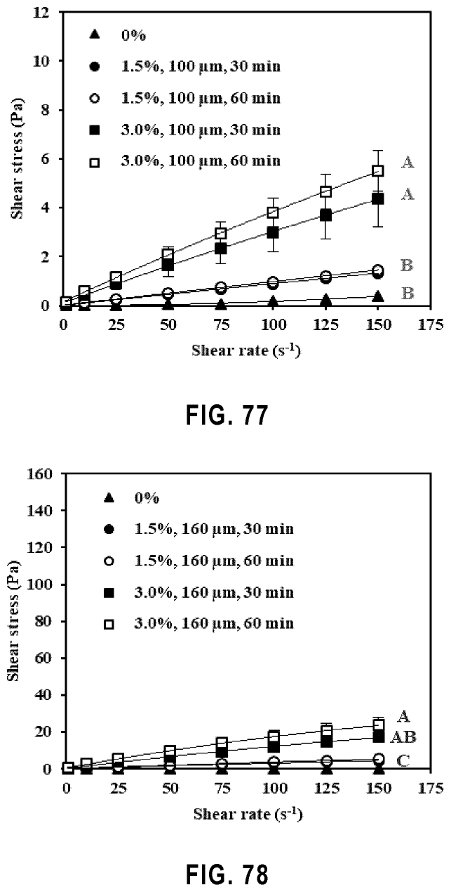

The effect of different factors, such as dosage (1.5% and 3% w/w), particle size (≤160 μm and ≤100 μm), stirring time (30 and 60 min), heating temperature (ambient, 40° C., and 80±2° C.), and storage mode (without storage or stored for 24 h at room temperature or at 8±2° C.) on the rheology of different aqueous solutions containing K. alvarezii seaweed powder was evaluated. The flow curves presented in FIGS. 72 to 77 show that, without heating, all flow curves exhibit a linear Bingham behavior, regardless of the employed K. alvarezii powder dosage, particle size, stirring time, and storage modes. However, a significant increase in the shear stress was observed in the case of solutions directly tested and solutions stored for 24 h at room temperature compared to that of water (control medium), regardless of the employed K. alvarezii powder dosage, particle size, and stirring time. For example, for a dosage of 1.5% of K. alvarezii, particle size less than 160 μm, and stirring time of 60 min, the shear stress increases from 0.4 Pa (control) to 1.4 Pa (solutions without storage) and 2.0 Pa (solutions stored for 24 h). In addition, a higher K. alvarezii dosage of 3.0% results in a significant increase in shear stress compared to a lower dosage of 1.5%. In the case of solutions stored at 8° C., a dosage of 1.5% of K. alvarezii does not cause a significant increase in the shear stress compared to that of water, regardless of the stirring time and particle size. However, a dosage of 3.0% increases significantly the shear stress, regardless of the stirring time and particle size. Furthermore, it is important to mention that the dosage of K. alvarezii and the mode of storage significantly influence the shear stress. Indeed, a higher dosage of K. alvarezii and storage for 24 h lead to an increase in the shear stress compared to the control (water), regardless of the employed particle sizes, stirring time, and storage temperature.

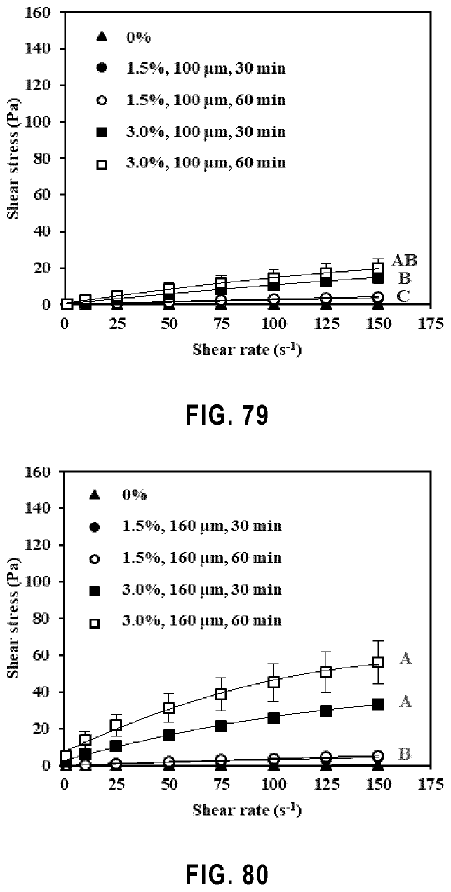

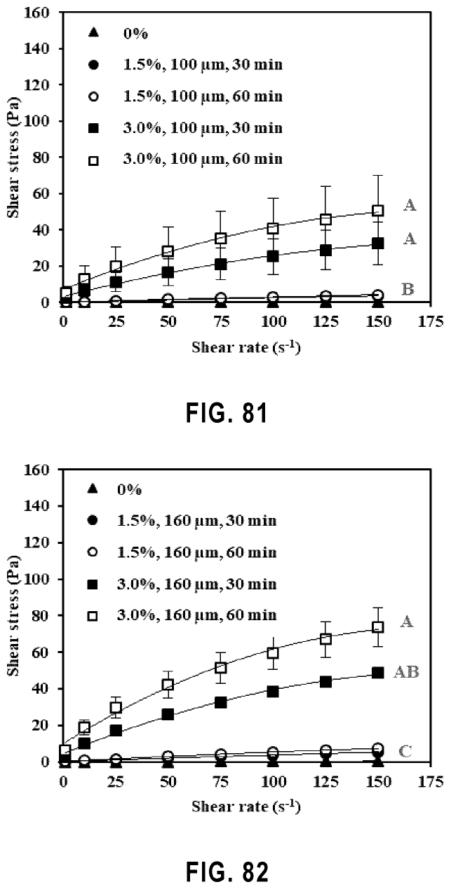

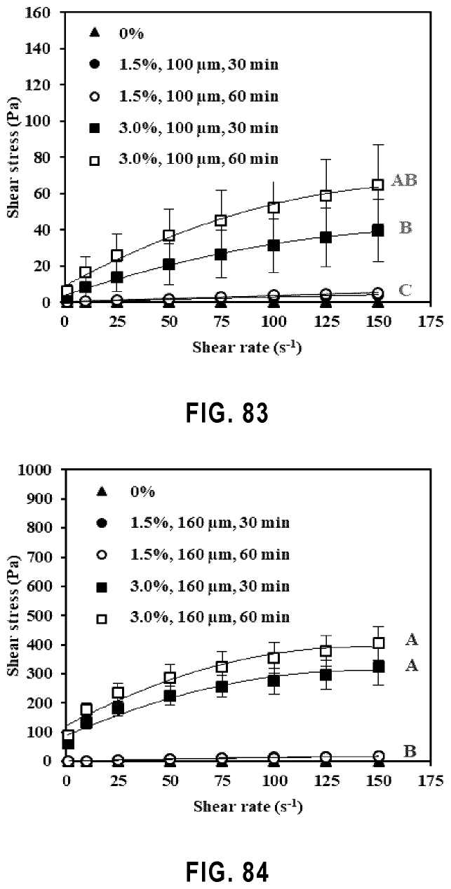

In FIGS. 72 to 85, the letters presented beside each curve indicate the significant differences between the means. Two means with, at least, one letter in common are not significantly different, while two means with no letter in common are significantly different. N.B. the statistical tests are carried out between the curves of the two fractions and of the same storage method.

At a heating temperature of 40° C. (FIGS. 78 to 83), all K. alvarezii aqueous solutions exhibited a pseudoplastic behavior like most hydrocolloids. Among the four studied factors, dosage is generally the most influencing factor on the shear stress, regardless of the employed heating time, particle size, and storage mode. However, in the case of solutions containing 1.5% of K. alvarezii, the shear stress does not show a significant increase compared to that of control solution, regardless of the particle size, heating time as well as storage mode. At a dosage of 3.0% of K. alvarezii, heating for 60 min and storage for 24 h increase the shear stress compared to those of the directly tested solutions without storage. For example, the shear stress increases respectively from 24 Pa (without storage) to 56 Pa (stored at room temperature) and to 74 Pa (stored at 8° C.) in the case of solutions containing 3.0% of K. alvarezii with a particle size less than 160 μm. In addition, a large increase in the shear stress was observed compared to that of aqueous solutions without heating for high dosages of 3.0% of K. alvarezii and storage at 8° C., regardless of the particle size and heating time.

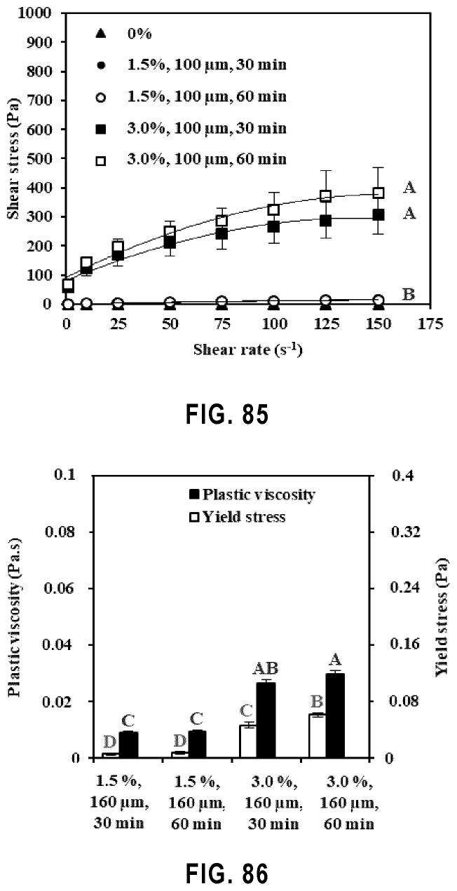

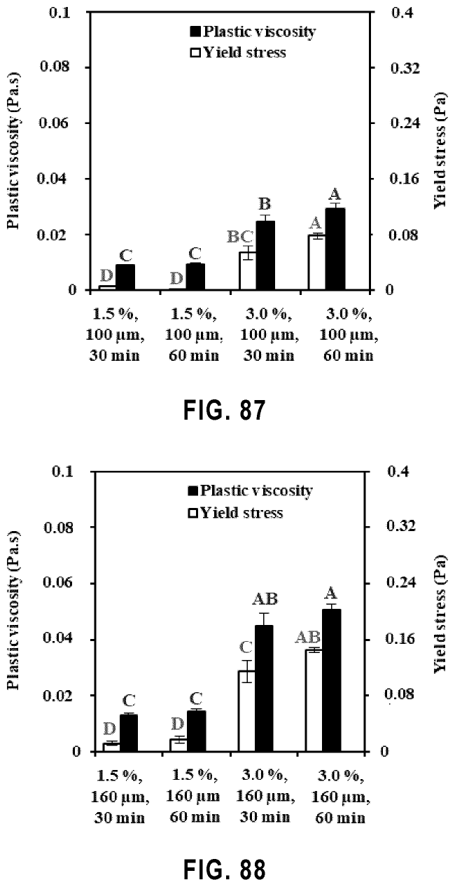

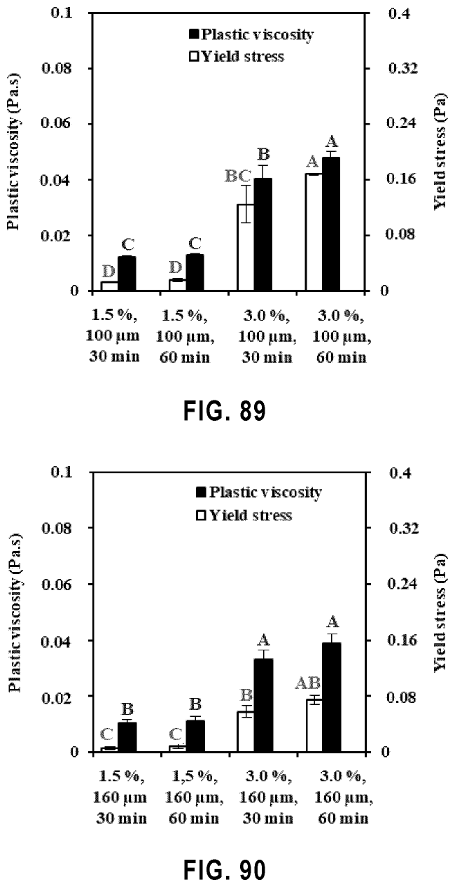

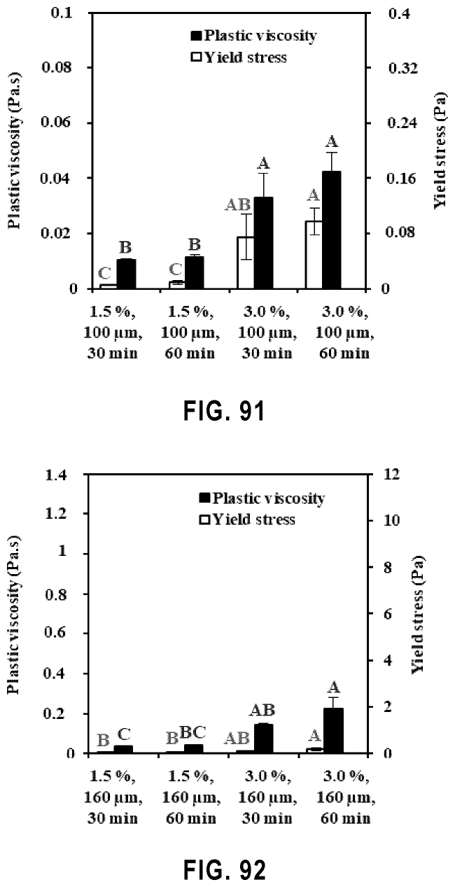

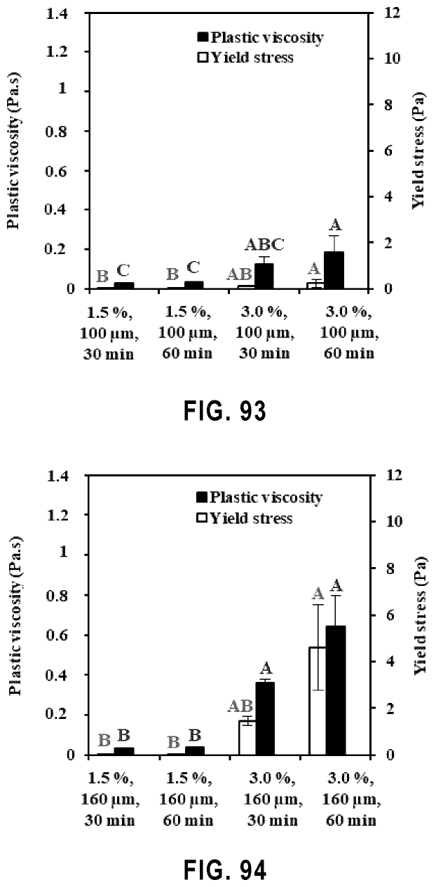

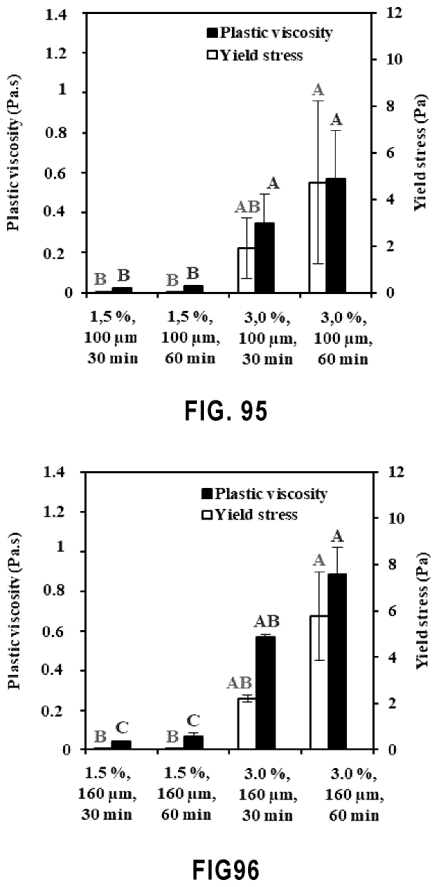

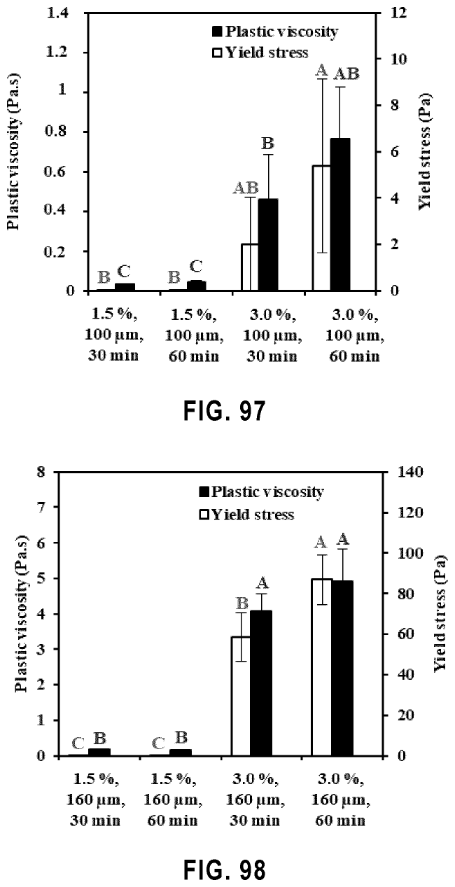

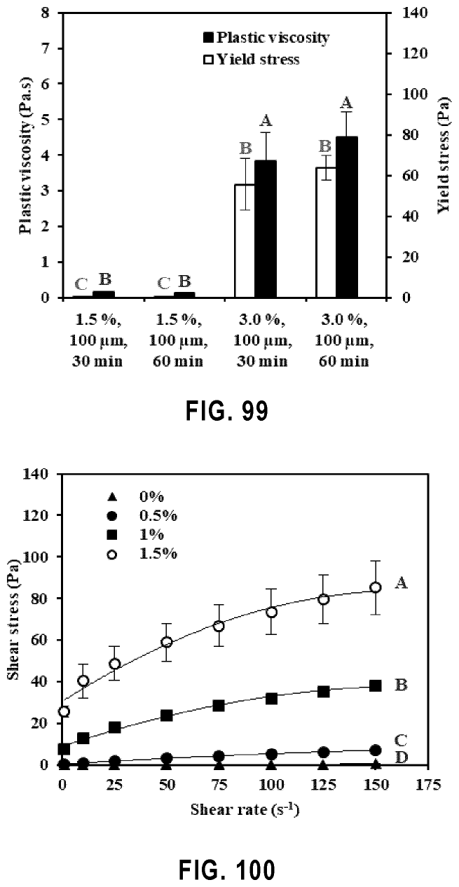

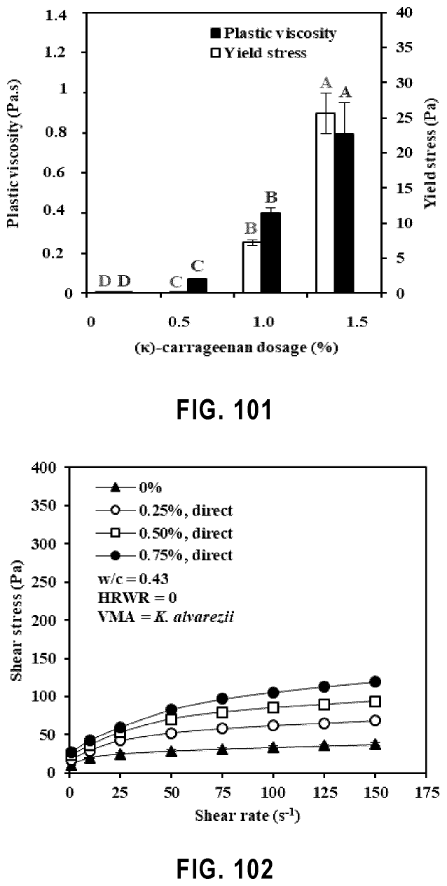

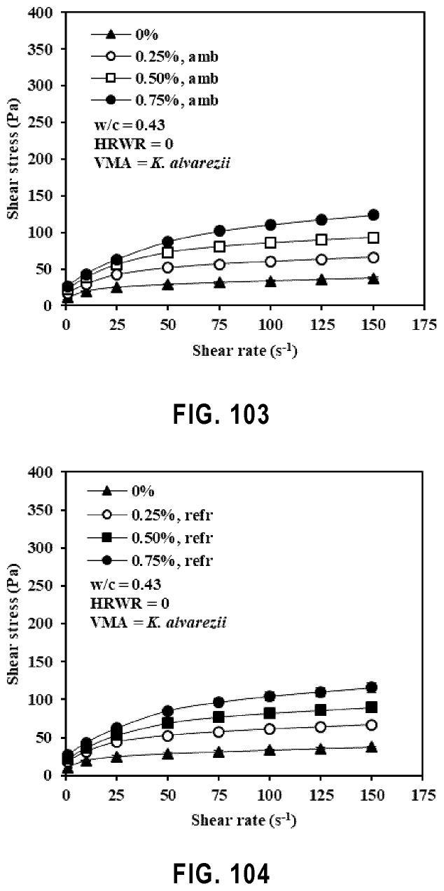

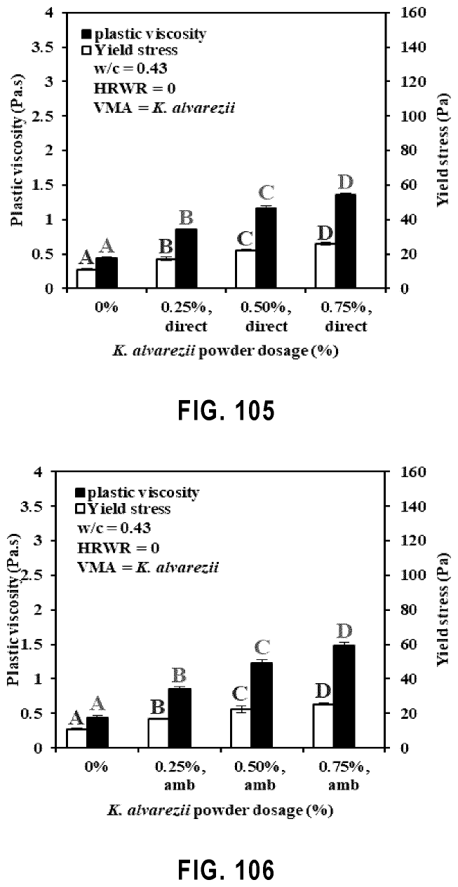

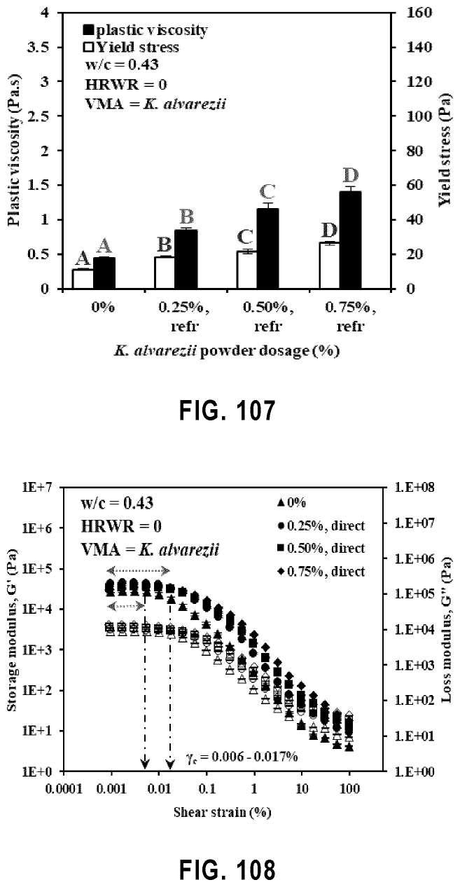

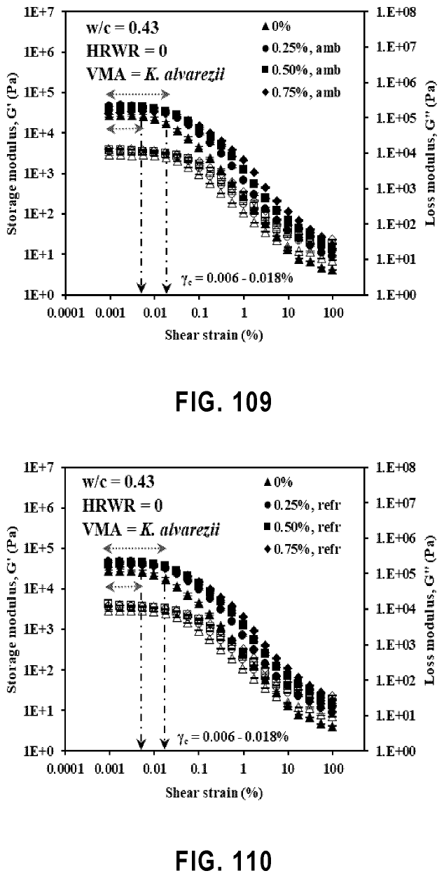

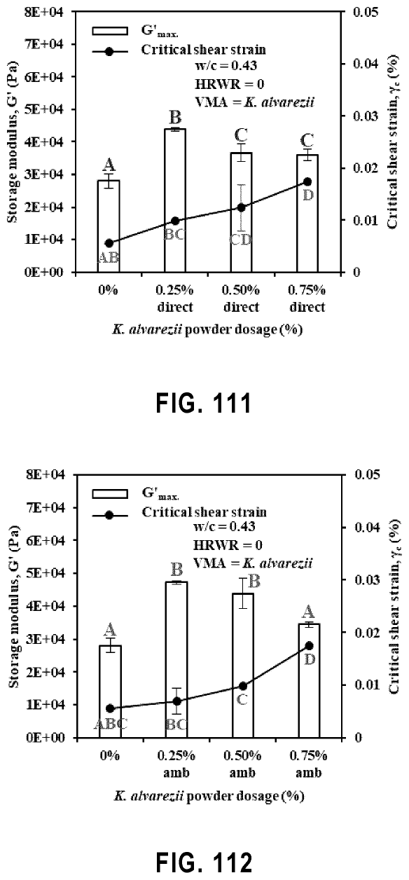

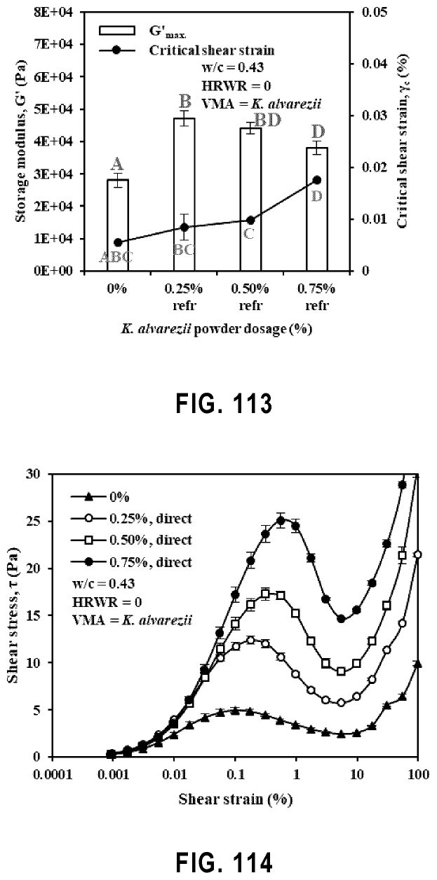

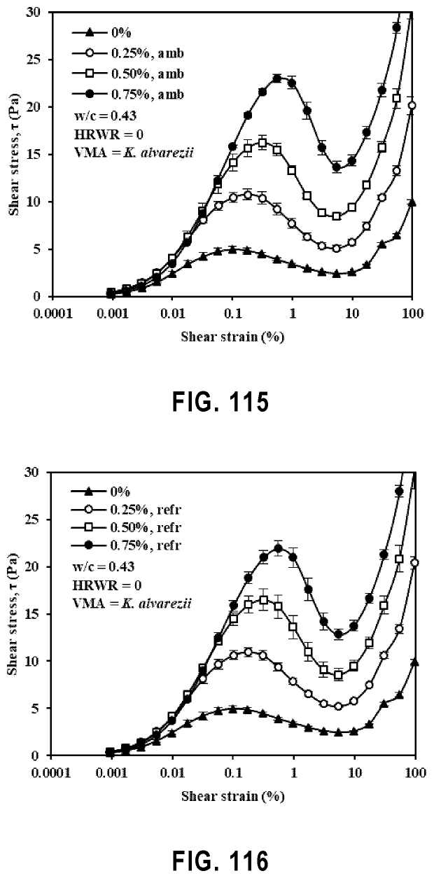

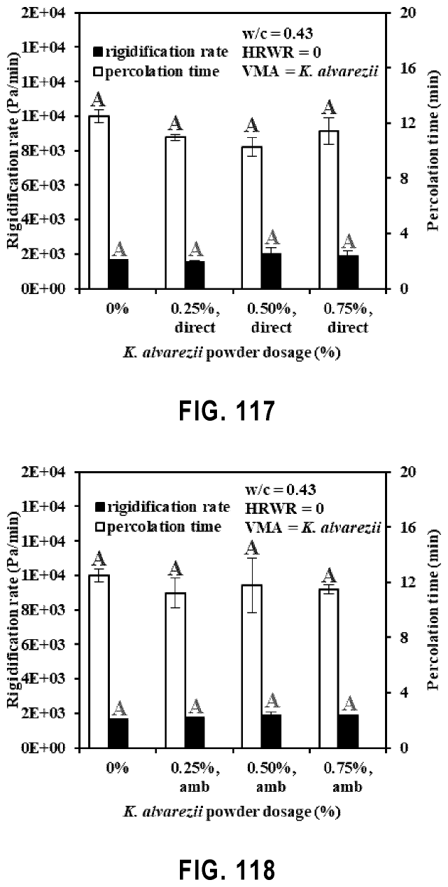

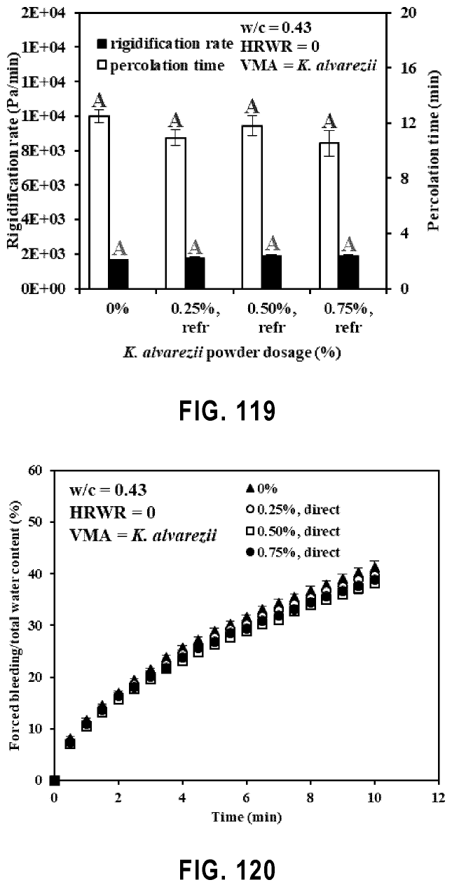

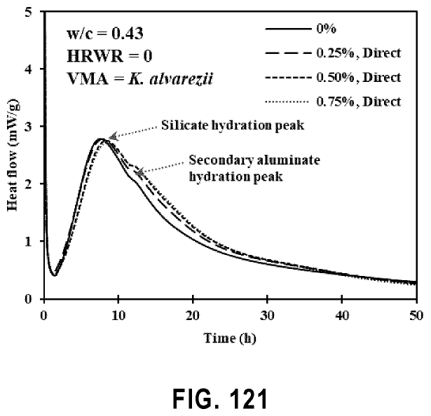

At a heating temperature of 80° C. (FIGS. 84 and 85), a significant increase in the shear stress was observed in the case of non-storing solutions containing 3.0% of K. alvarezii powder compared to that of solutions containing 1.5% of K. alvarezii powder, regardless of the particle size and stirring time. For example, for solutions containing 1.5 and 3.0% of K. alvarezii powder with a particle size less than 160 μm and heating time of 60 min, the shear stress increases from 17 Pa to 405 Pa, respectively. However, in the case of solutions stored at room temperature or at 8° C., the shear stress was greater than the detection limit of the rheometer. Therefore, these solutions have not been studied. Moreover, it is important to mention that only at dosages of 3.0% of K. alvarezii powder, the shear stress shows a significant increase compared with the solutions heated at 40° C., regardless of the particle size and heating time.

As can be observed in FIGS. 86 to 91, the use of K. alvarezii seaweed powder increases both yield stress and plastic viscosity values of aqueous solutions. These parameters were determined by fitting the flow curves using the modified Bingham model (Yahia and Khayat, 2001). Without heating, the plastic viscosity shows a significant increase with the K. alvarezii dosage, regardless of the storage mode. However, for storage at 8° C., a dosage of 1.5% of K. alvarezii powder shows no significant difference in plastic viscosity compared to that of the control medium. In addition, it is important to indicate that the storage method does not significantly influence the plastic viscosity of solutions containing 1.5% of K. alvarezii powder, regardless of the particle size and storage mode. However, in the case of solutions containing 3.0% of K. alvarezii powder, a storage at room temperature results in a significantly higher viscosity than a storage at 8° C. For example, for a solution containing 3.0% of K. alvarezii powder with a particle size less than 160 μm and stirring time of 60 min, the plastic viscosity increases from 0.04 to 0.05 Pa·s, respectively for storage at 8° C. and room temperature.

In FIGS. 86 to 91, the letters presented above each bar indicate significant differences between the means. Two means with, at least, one letter in common are not significantly different, while two means with no letter in common are significantly different. N.B. the statistical tests are carried out between the bars of the same color in each graph and between the two fractions for each storage mode

Heating of aqueous solutions of K. alvarezii up to 40° C. (FIGS. 92 to 97) significantly increases the plastic viscosity values, especially at high dosages of 3.0% of K. alvarezii, although no significant increase was observed in the case of solutions containing 1.5% of K. alvarezii powder compared to that of the control medium, regardless of the storage mode, particle size, and stirring time. In addition, at a dosage of 3.0% of K. alvarezii, storage at room temperature or at 8° C. generally increases the plastic viscosity compared to that of solutions without storage, regardless of the particle size and heating time. Furthermore, regardless of the storage mode, a significant increase in plastic viscosity was observed in the case of solutions containing 3.0% of K. alvarezii compared to that of solutions incorporating the same dosage without heating.

It is admitted in the literature that aqueous extraction of (κ)-carrageenan increases their yield, but solutions containing 1.5% of native (κ)-carrageenan could not form a gel (Distantina et al., 2011). This means that the native (κ)-carrageenan extracted with distilled water exhibits poor gelation property in 1.5% solution. The authors Distantina et al. (2011) referred these observations to the lower cation content in native (κ)-carrageenan, which is in agreement with our present study results.

At a heating temperature of 80° C. (FIGS. 98 and 99) and as in the case of the shear stress values, increasing the dosage of K. alvarezii up to 3.0% has a considerable effect on increasing the plastic viscosity of studied solutions. The highest values of this parameter are observed in the case of solutions containing 3.0% of K. alvarezii powder, regardless of the particle size and heating time.

It is well established that the heating of water to temperatures above 75° C. solubilizes the seaweed materials, thus giving a very high viscosity even at low concentrations (0.1-0.5%) (Landry, 1987), which is in agreement with our results.

As in the case of plastic viscosity and regardless of the storage mode, the dosage of K. alvarezii is the most influencing yield stress factor of unheated solutions (FIGS. 86 top 91). However, the yield stress values of solutions containing 3.0% of K. alvarezii, stored at room temperature or not, appear to significantly affect by the stirring time, regardless of the particle size. In addition, at a same dosage of 3.0% of K. alvarezii, the use of the fine fraction (particles≤100 μm) significantly increases the yield stress compared to that of solutions containing a coarse fraction (particles≤160 μm). However, these claims are only valid for directly tested solutions without storage. Storage for 24 h at room temperature leads to an increase in yield stress compared to that of solutions containing 3.0% of K. alvarezii directly tested without storage or stored at 8° C. This may due to the lack of heating of the solutions. Indeed, K. alvarezii powder does not dissolve in cold water. Therefore, further cooling may inhibit the pre-hydration of the particles of K. alvarezii powder.

Heating (40° C.) (FIGS. 92 to 97) of solutions containing 3.0% of K. alvarezii powder stored at room temperature or at 8° C. also causes a significant increase in the yield stress compared to that of non-stored solutions incorporating the same dosage, regardless of the particle size and heating time. However, no significant difference in the yield stress was observed between the heated and unheated solutions directly tested. Furthermore, heating causes a significant difference in the yield stress between solutions containing 3.0% of K. alvarezii, heated for 60 min and stored at room temperature or refrigerated and unheated solutions incorporating the same dosage, stirred and stored in the same conditions.

The yield stress values increase drastically up to 87 Pa in the case of solutions containing 3.0% of K. alvarezii (fraction≤160 μm), heated at 80° C. for 60 min and non-stored (FIGS. 98 and 99). However, it is not possible to use these solutions as mixing water for cement suspensions due to their high yield stress values.

In FIGS. 3.12A and B, the letters presented beside each curve and above each bar indicate the significant differences between the means. Two means with, at least, one letter in common are not significantly different, while two means with no letter in common are significantly different. N.B. the statistical tests are carried out between the bars of the same color in the graph (b).

FIGS. 100 and 101 present the flow curves and variation of yield stress and plastic viscosity values of aqueous solutions containing different dosages of (κ)-carrageenan corresponding to 0.5%, 1.0%, and 1.5% w/w. As can be observed, these solutions also exhibit pseudoplastic behavior, regardless of the dosage of (κ)-carrageenan. The values of the yield stress and plastic viscosity increase from 0.07 to 26 Pa and from 0.071 to 0.8 Pa·s, respectively in the case of solutions containing 0.5% and 1.5% of (κ)-carrageenan.

Based on the yield stress and plastic viscosity values of aqueous solutions containing (κ)-carrageenan and comparing these values with those obtained using K. alvarezii powder, 11 solutions can be chosen. These solutions are: any solution with a dosage of 3.0%, stirred for 30 or 60 min and heated at 40° C., directly tested or stored for 24 h at room temperature or at 8° C., regardless of the particle size, except the solution containing 3.0% of the particle fraction≤160 μm, stirred for 60 min, heated to 40° C., and maintained at 8° C. However, since the particle size and stirring time did not significantly affect the rheological properties of studied solutions, only the fraction of particles≤160 μm with a stirring time of 30 min were chosen. This could optimize the test time as well as the heating energy used.

### Rheological Properties of Cement Suspensions

Effect of K. alvarezii seaweed powder on rheology and viscoelastic properties

The rheology and viscoelastic properties of different cement-paste mixtures containing different dosages of K. alvarezii powder were evaluated. Indeed, it is necessary to mention that the use of solutions containing 1.5% or 3.0% of K. alvarezii powder, stirred for 30 min and heated at 40° C., directly tested or pre-hydrated for 24 h at room temperature or at 8° C. as mixing water for the preparation of cement suspensions caused a mixing blockage. This can be referred to the (1) phenomena of adsorption of certain components of seaweed powder on the cement particles, which leads to the formation of flocs, (2) phenomena of water absorption by other components of seaweed powder or (3) entanglement of polymers containing in K. alvarezii powder in the cement pore solution. In addition, K. alvarezii powder may contain components other than (κ)-carrageenan, which may contribute to the increase in viscosity of cement suspensions.

In this regard, a decrease in the dosage of the studied seaweed powder should be recommended. Therefore, other solutions containing 0.25%, 0.50%, and 0.75% w/w of K. alvarezii powder (particle fraction≤160 μm) were prepared using the same conditions of heating (40° C.), stirring (30 min), and pre-hydration (direct test, pre-hydration for 24 h at room temperature or at 8° C.) chosen in the previous step. These solutions were again used as mixing water to prepare different cement suspensions.

The flow curves presented in FIGS. 102 to 104 show that mixtures containing different dosages of K. alvarezii powder exhibit a shear-thinning behavior (characteristic of cement suspensions), in which the apparent viscosity decreases significantly with the increase of the shear rate, regardless of the dosage of K. alvarezii powder and solutions pre-hydration method. At low shear rates, the attractive forces between cement particles predominate over the hydrodynamic forces leading to the formation of flocs. As the shear rate increases, the hydrodynamic forces become higher than the attractive forces. Therefore, the flocs are broken down into smaller units allowing to release the water trapped in the flocs and decrease the viscosity of the system. However, the shear stress shows a significant increase with the dosage of K. alvarezii powder, regardless of the pre-hydration method used. For example, in the case of cement suspensions prepared from solutions containing 0.25%, 0.50%, and 0.75%, by masse of water, of K. alvarezii powder directly tested without pre-hydration, the shear stress at 150 s⁻¹ increases from 38 Pa in the case of reference cement-paste mixture to 69 Pa, 94 Pa, and 119 Pa, respectively. However, the pre-hydration of solutions containing K. alvarezii powder does not lead to significant differences in the shear stress, regardless of the dosage of K. alvarezii powder used.

In FIGS. 102 to 104, the letters presented beside each curve indicate the significant differences between the means. Two means with, at least, one letter in common are not significantly different, while two means with no letter in common are significantly different. N.B. the statistical tests are carried out between the entire curves, regardless of the dosage of K. alvarezii and pre-hydration method.

As can be observes in FIGS. 105 to 107, the use of K. alvarezii powder increases both yield stress and plastic viscosity values of cement-paste mixtures. For example, in the case of mixtures prepared from non-pre-hydrated solutions, using a dosage of 0.25% of K. alvarezii powder increases the yield stress from 11 Pa to 17 Pa and plastic viscosity from 0.44 Pa·s to 0.86 Pa·s. An increase in the dosage of K. alvarezii powder to 0.50% and 0.75% results in a higher yield stress of 22 Pa and 26 Pa and plastic viscosity of 1.17 Pa·s and 1.36 Pa·s, respectively. However, the pre-hydration of K. alvarezii powder also did not lead to significant differences in these two rheological parameters (i.e. the yield stress and plastic viscosity), regardless of the dosage of K. alvarezii powder used.

In FIGS. 105 to 107, the letters presented above each bar indicate significant differences between the means. Two means with, at least, one letter in common are not significantly different, while two means with no letter in common are significantly different. N.B. the statistical tests are carried out between the entire bars of the same color in each graph, regardless of the dosage of K. alvarezii and pre-hydration method

The viscoelastic behavior of cement-paste mixtures was also evaluated by performing strain sweep measurements, in which the sample is subjected to increasing shear strain from 0.0001% to 100% at a constant angular frequency of 10 rad/s. This aims to characterize the flocculated microstructure of the studied cement suspensions in the region where the rigidity of the system is independent of the imposed shear strain (i.e. in the LVED).

FIGS. 108 to 110 shows the storage modulus (G′), which characterize the elastic energy storage, and the loss modulus (G″), which characterize the energy dissipation, determined as a function of the shear strain for cement-paste mixtures containing different dosages of K. alvarezii powder. As can be observed, all studied mixtures exhibit a linear viscoelastic behavior up to a certain critical shear strain, beyond which a decrease in shear moduli is observed with the shear strain, thus reflecting the destruction of the material. As illustrate in FIGS. 111 to 113, increasing the dosage of K. alvarezii powder up to 0.75% increases the value of the critical shear strain from 0.0055% in the case of reference mixture to 0.0174% in the case of mixtures prepared from non-pre-hydrated solutions and 0.0175% in the case of mixtures prepared from pre-hydrated solutions at room temperature or at 8° C. However, increasing the dosage of K. alvarezii to 0.25% and 0.50% does not significantly increase the critical shear strain compared to the reference mixture, regardless of the method of pre-hydration used, except for the mixture prepared from non-pre-hydrated solution containing 0.50% of K. alvarezii. In addition, the pre-hydration does not lead to significant differences in the values of the critical shear strain. Nevertheless, it is necessary to mention that there are no significant differences in the values of the critical shear strain between the mixture prepared from a non-pre-hydrated solution containing 0.25% of K. alvarezii and mixtures prepared from a solution containing 0.50% of K. alvarezii, regardless of the method of pre-hydration.

The maximum rigidity (G′ₘₐₓ) corresponding to the highest value of G′ located in the LVED, was also determined. As shown in FIGS. 111 to 113, the use of K. alvarezii powder generally increases the rigidity of cement-paste mixture, regardless of the dosage of K. alvarezii and the method of pre-hydration. However, in this case, the pre-hydration method has a significant effect on increasing the rigidity of cement-paste mixtures prepared from solutions containing 0.50% of K. alvarezii. Indeed, the G′_{max.} increases from 28000 Pa in the case of the reference mixture to 36600 Pa, 43867 Pa and 44167 Pa, respectively, in the case of mixtures prepared from non-pre-hydrated and pre-hydrated solutions at room temperature or at 8° C. On the other hand, the pre-hydration of solutions containing 0.25% or 0.75% of K. alvarezii powder does not lead to significant differences in the values of G′_{max.} of the studied mixtures.

In FIGS. 114 to 116, the letters presented above each bar or under each curve point indicate significant differences between the means. Two means with, at least, one letter in common are not significantly different, while two means with no letter in common are significantly different. N.B. the statistical tests are carried out between the bars or curve points of the same color for each pre-hydration method

Although the use of K. alvarezii powder increases the rigidity of cement-paste mixtures, it is important to mention that increasing the dosage of K. alvarezii powder from 0.25% to 0.75% decreases generally the values of the G′_{max.}, regardless of the method of pre-hydration. In addition, the use of a non-pre-hydrated solution containing 0.25% of K. alvarezii leads to an increase in the rigidity of the cement paste in a similar manner to the use of a solution containing 0.50% or 0.75% of K. alvarezii pre-hydrated at 8° C. Using a non-pre-hydrated solution containing 0.50% of K. alvarezii powder also increases the rigidity of the cement paste in a similar fashion to the use of a non-pre-hydrated solution containing 0.75% of K. alvarezii or pre-hydrated at room temperature or at 8° C.

It is admitted in the literature that the aqueous gelation of carrageenans depends on the type of carrageenan, the temperature, and the type of cations dissolved in solution and their concentrations. This ability to form a gel is mainly due to the presence of the 3,6-anhydro bridge of the 4-linked-α-D-galactose unit, which adopts a ¹C₄ conformation thereby forming a helical structure. As the aqueous extraction with hot water of red seaweed lead to retain the native structure of carrageenan due to the lack of chemical treatment with alkalis (such as potassium hydroxide “KOH”), the structure of carrageenan chains may be devoid of any 3,6-anhydro bridges. This is due to the presence of sulfate at the C₆ of α-L-galactose residues in the precursor units, which acts as a “Kink” preventing the formation of the double helix. On the other hand, the alkaline base is used due to their double action. The hydroxyl transforms the biological (κ)-carrageenan form found in the thallus of red seaweeds into commercial quality (κ)-carrageenan (Distantina et al., 2011), while potassium plays an essential role in the gel formation (van De Velde et al., 2002). Indeed, alkalis can induce desulfation of the polysaccharide by causing the formation of the 3,6-anhydrogalactose bridge between C₃ and C₆ in 4-linked-α-L-galactose units by changing the conformation of the 4-linked-α-L-galactose unit from ⁴C₁ to ¹C₄, which leads to the formation of the 3,6-anhydro-D-galactose unit. The formation of this unit increases the gel strength (Rees et al., 1970; Hernandez-Carmona et al., 2013; Distantina et al., 2011). When this sulfate group is removed, the chain becomes flexibles, which leads to great regularity in the polymer. Therefore, our native (κ)-carrageenan contained in K. alvarezii seaweed may present a high sulfate ester and probably low 3,6-anhydro bridge contents, thus exhibiting high viscosity but low rigidity (Rees, 1970; Normah and Nazarifah, 2003; Bono et al., 2014; Heriyanto et al., 2018), which influence the rigidity of cement-paste mixtures. On the other hand, the electrostatic repulsion between the negatively charged sulfate groups can contribute in increasing the distance between chains, which lead to greater distance between the cement particles, hence longer LVED (Watase and Nishinari, 1982).

The stress-strain curves and static yield stress of studied cement-paste mixtures are presented in FIGS. 114 to 116. This parameter can be used as a measure of the resistance and the number of inter-particle broken bonds due to the application of increasing shear strain (Mostafa and Yahia, 2016). Destruction of the bonds between the particles can be correspond to the beginning of the microscopic flow of the material.

As can be observed, for each pre-hydration method, increasing the dosage of K. alvarezii powder leads to an increase in the static yield stress, regardless of the dosage of K. alvarezii used. However, the pre-hydration of solutions containing 0.75% of K. alvarezii results in a significant decrease in the static yield stress of the mixtures prepared from these solutions. This effect was not observed in the case of mixtures prepared from solutions containing 0.25% and 0.50% of K. alvarezii. It is worthy to mention that these claims are opposite to the classification based on G′_{max.} and critical shear strain indices. Therefore, the increase in static yield stress with the dosage of K. alvarezii was not due to an increase in rigidity or an interparticle space filler, but was notably due to the increase in the volume of the pore solution, which is in agreement with the above results of the plastic viscosity and dynamic yield stress determined from the flow curves.

### Effect of K. alvarezii Seaweed Powder on the Structural Build-Up Kinetics

The structural build-up kinetics of cement-paste mixtures containing different dosages of K. alvarezii powder was determined using time sweep measurements, which is carried out in a small amplitude oscillatory shear (SAOS) with a constant angular frequency of 10 rad/s and a shear strain value within the LVED (i.e. a shear strain lower than the critical shear strain value), allowing to monitor the evolution of the storage modulus (G′) and phase angle (δ) during 20 min of rest in a non-destructive regime. Two major indices can be determined through these measurements, the percolation time (t_{perc.}) and rigidification rate (G_{rigid.}).

Indeed, although the use of K. alvarezii powder significantly increases the viscosity and rigidity of cement-paste mixtures, no significant effect was observed on the increase of structural build-up kinetics. Therefore, the addition of K. alvarezii did not lead to any significant increase/decrease in the t_{perc.} and G_{rigid.} values (FIGS. 117 to 119), which is in agreement with strain sweep measurements.

In FIGS. 117 to 119, the letters presented above each bar indicate significant differences between the means. Two means with, at least, one letter in common are not significantly different, while two means with no letter in common are significantly different. N.B. the statistical tests are carried out between the entire bars of the same color in each graph, regardless of the dosage of K. alvarezii and pre-hydration method

Moreover, these results confirm that the native (κ)-carrageenan present in K. alvarezii seaweed does not participate in the increase in the rigidity of cement suspensions over time. This is probably due to the lack of 3,6-anhydro bridges, which is responsible for the gel formation and the thixotropic effect observed in the case of the previous examples (Example 1 and 2). Therefore, an alkaline extraction should be required to maintain the thixotropic effect of (κ)-carrageenan in cement suspensions.

### Effect of K. alvarezii Seaweed Powder on the Forced Bleeding

The relative forced bleeding of cement-paste mixtures prepared from solutions containing different dosages of non-prehydrated K. alvarezii powder is summarized in FIG. 120. As can be seen, the use of K. alvarezii powder in cement pastes slightly decreases the kinetics of the forced bleeding (slope of the curve) and the total forced bleeding. No significant decrease in forced bleeding was observed at 2 min and 6 min, regardless of the dosage of K. alvarezii used. Nevertheless, the total forced bleeding after 10 min decreases significantly in the case of the mixtures prepared from solutions containing 0.50% and 0.75% of the K. alvarezii powder, although there was no significant difference in the decrease in total forced bleeding between the two aforementioned dosages.

It is well known that industrial-grade (κ)-carrageenan has a high capacity for free water retention of cement systems ranging from more than 50% (Example 1). However, the present results show that native (κ)-carrageenan may not retain this property. As mentioned above, despite the high viscosity observed with the use of K. alvarezii powder in the studied mixtures, the potential absence of the 3,6-anhydro bridge in the polymer chains of the native (κ)-carrageenan contained in K. alvarezii powder may result in a water retention failure.

### Effect of K. alvarezii Seaweed Powder on Cement Hydration Kinetics

The study of the effect of K. alvarezii powder on the hydration heat of cement pastes is necessary because most conventional VMA often interfere with the kinetics of cement hydration. This is due to the adsorption of the VMAs' polymer chains onto cement particles producing C—S—H which forms a film around the clinker particles. This leads to a delay in hydration of the cement by preventing the rate of solubilization of mineral species in the pore solution, and consequently, influencing the cement hydration kinetics. In addition, it has been observed in the Examples above that the refined (κ)-carrageenan significantly retards the hydration of cement. This has been attributed to the use of the Na⁺, Ca²⁺ and K⁺ ions necessary to initiate the acceleration period by the polymer of (κ)-carrageenan to stabilize its junction sites to form a rigid gel. This decreases the ions concentrations in the pore solution, thus delaying the hydration of the cement (Example 1).

FIG. 121 shows the evolution of the heat flux of cement-paste mixtures prepared from aqueous solutions containing different dosages of K. alvarezii corresponding to 0.25%, 0.50% and 0.75%, by mass of water. The heat flux of each of the studied cement pastes is determined for 72 h after mixing. As can be seen, despite the increase in the viscosity of the cement pastes, the addition the K. alvarezii seaweed powder does not show any significant effect on the hydration of the cement compared to the reference mixture, regardless of the dosage of K. alvarezii used. This is unusual for a VMA. The figure also shows that the time required to reach the silicates hydration peak of was comparable to that of the reference mixture. In addition, the hydration heat corresponding to the silicates hydration peak was generally comparable in all the mixtures. However, adding a dosage of 0.75% of K. alvarezii slightly decreases the intensity of this heat peak. The silicates hydration peak is often followed by a period of deceleration, in which a last peak of hydration appears which is linked to the transformation of ettringite into monsulfoaluminate. This peak was slightly higher for mixtures containing K. alvarezii powder.

Overall, in light of the results presented above, it can be concluded that the use of K. alvarezii seaweed powder as a VMA does not significantly affect the cement hydration kinetics. This is particularly advantageous because most common VMAs, such as cellulose ether and welan gum, have adverse effects on hydration kinetics, especially at high dosages of VMA.

### Conclusions

The effect of different dosages and pre-hydration methods of K. alvarezii seaweed powder on the rheological behavior (fluidity and viscosity), the viscoelastic properties and the structural buildup kinetics of cement-paste mixtures proportioned with a w/c ratio of 0.43 was evaluated. Based on the results presented herein, the following conclusion can be pointed out:
The cement-paste mixtures containing K. alvarezii seaweed powder show a pseudoplastic (shear-thinning) behavior, in which the shear stress increases with the increase of the K. alvarezii dosage, regardless of the pre-hydration method;
The pre-hydration method of aqueous solutions has no significant effect on the rheological behaviour of cement pastes. This confirms the stability of this VMA under various conditions;
The use of K. alvarezii enhanced both the plastic viscosity and yield stress values of cement pastes. The use of 0.50% of K. alvarezii resulted in both 2 times higher plastic viscosity and yield stress values than the reference mixture;
The LVED increase generally with the use of K. alvarezii seaweed powder, regardless of the pre-hydration method used despite the high rigidity obtained with the use of K. alvarezii aqueous solutions as mixing water for cement pastes;
The cement-paste mixtures containing the K. alvarezii seaweed powder showed a non-significant evolution in the structural buildup kinetics. This can be due the lack of the 3,6-anhydro bridges in the native (κ)-carrageenan present in K. alvarezii seaweed powder and, therefore, the inability to form a rigid gel over time;
A dosage of 0.50% of K. alvarezii results in a slight increase in the resistance to forced bleeding of the studied cement-paste mixtures; and

The use of K. alvarezii powder does not significantly affect the hydration kinetics of the studied cement-paste mixtures, regardless of the dosage of K. alvarezii used.

In conclusion, based on these results, we confirmed that K. alvarezii seaweed powder can be used as a VMA in fluid cement suspensions. However, regarding the lack of thixotropic effect of this seaweed powder in cement suspensions, an alkaline activation of the native (κ)-carrageenan present in these seaweeds should be required.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
Abdollahnejad, Z., Kheradmand, M. and Pacheco-Torgal, F. (2017a). Mechanical properties of hybrid cement-based mortars containing two biopolymers. International Scholarly and Scientific Research & Innovation, 11(9), 1237-1240.
Abdollahnejad, Z., Kheradmand, M. and Pacheco-Torgal, F. (2017b). Short-term compressive strength of fly ash and waste glass alkali-activated cement-based binder mortars with two biopolymers. J. Mater. Civ. Eng., 29(7), 04017045.
Aday, A. N., Osio-Norgaard, J., Foster, K. E. O. and Srubar III, W. V. (2018). Carrageenan-based superabsorbent biopolymers mitigate autogenous shrinkage in ordinary Portland cement. Materials and Structures, 51(2).
Ajithkumar, S., Krishnaraj, G., Abdul Haleem, M. I., Manivasagan, V., Ramesh Babu, N. G. and Pandi Durai, S. (2017). Optimization of carrageenan extraction process from seaweed. World journal of pharmacy and pharmaceutical sciences, 6(4), 2205-2213.
AU 2003227494 A1
Azevedo, G., Bernardo, G. and Hilliou, L. (2014). NaCl and KCl phase diagrams of kappa/iota-hybrid carrageenans extracted from Mastocarpus stellatus. Food Hydrocolloids, 37, 116-123.
Bajaj, I. B. Survase, S. A. Saudagar, P. S. and Singhal, R. S. (2007). Gellan gum: fermentative production, down stream processing and applications. Food Technology and Biotechnology, 45(4), 341-3-54.
Baussay, K. (2005). Influence de la gélification de polysaccharide sur les systèmes mixtes agrégats de protéine globulaire/polysaccharide. Le Mans-France, Université Du Maine: 156.
Blakemore, W. R. and Harpell, A. R. (2010). Food Stabilisers, Thickeners and Gelling Agents. Ch 5. Carrageenan, 73-94.
Bono, A., Anisuzzaman, S. M. and Ding. O. W. (2014). Effect of process conditions on the gel viscosity and gel strength of semi-refined carrageenan (SRC) produced from seaweed (Kappaphycus alvarezii). Engineering Sciences, 26, 3-9.
Bono, A., Anisuzzaman, S. M. and Ding. O. W. (2014). Effect of process conditions on the gel viscosity and gel strength of semi-refined carrageenan (SRC) produced from seaweed (Kappaphycus alvarezii). Engineering Sciences, 26, 3-9.
Caram-Lelham, N., Sundelof, L. O. and Andersson, T. (1995). Preparative separation of oligosaccharides from K-carrageenan, sodium hyaluronate, and dextran by Superdex™ 30 prep. Carbohydr. Res., 273, 71-76.
Chen, Y., Liao, M. L. and Dunstan, D. E. (2002). The rheology of K⁺-κ-carrageenan as a weak gel. Carboyadrate polymers, 50, 109-116.
Daniel-da-Silva, A. L., Ferreira, L., Gil, A. M. and Trindade, T. (2011). Synthesis and swelling behavior of temperature responsive κ-carrageenan nanogels. Journal of Colloid and Interface Science, 355, 512-517.
de Faria, G. S. M., Hayashi L. and Monteiro, A. R. (2014). Effect of drying temperature on carrageenan yield and quality of Kappaphycus alvarezii (Rhodophyta, Solieriaceae) cultivated in Brazil. J. Appl. Phycol., 26, 917-922.
Distantina, S., Wiratni, W., Fahrurrozi, M. and Rochmadi, R. (2011). Carrageenan properties extracted from Eucheuma cottonii, Indonesia. World Academy of Science, Engineering and Technology, 78, 738-742.
Ducatti, D. R. B., Colodi, F. G., Goncalves, A. G., Duarte, M. E. R. and Noseda, M. D. (2011). Production of agaro- and carra-oligosaccharides by partial acid hydrolysis of galactans. Brazilian Journal of Pharmacognosy, 21, 296-304.
Ebnesajjad, S. (2013). Handbook of Biopolymers and Biodegradable Plastics. Oxford: William Andrew.
Euclid Canada. (2020). Website. https://www.euclidchemical.com/products/admixtures/specialtyadmixtures/rheology-modifiers/.
García-Ochoa, F., Santos, V. E., Casas, J. A. and Gómez, E. (2000). Xanthan gum: production, recovery, and properties. Biotechnology Advances, 18(7), 549-579.
Ghezal, A. F. and Assaf, G. J. (2015). Restrained Shrinkage Cracking of Self-Consolidating Concrete. J. Mater. Civ. Eng., 27(10), 04014266.
Ghio, V. A., Monteiro, P. J. M. and Demsetz, L. A. (1994). The rheology of fresh cement paste containing polysaccharide gums. Cem. Cont. Res., 24(2), 243-249.
Ghio, V. A., Monteiro, P. J. M. and Gjorv, O. E. (1994). Effects of polysaccharide gums on fresh concrete properties. ACI Mate, J., 91(6), 602-606.
Green, K. M., Carter, M. A., Hoff, W. D. et Wilson, M. A. (1999). The effects oflime and admixtures on the water-retaining properties of cernent mortars, Cern. Caner. Res., 29(11).
Guibet, M., Colin, S., Barbeyron, T., Genicot, S., Kloareg, B., Michel, G. and Helbert, W. (2007). Degradation of λ-carrageenan by Pseudoalteromonas carrageenovora λ-carrageenase: a new family of glycoside hydrolases unrelated to κ- and ι-carrageenases. J. Biochem., 404, 105-114.
Heriyanto, H. Kustiningsih, I. and Sari, D. K. (2018). The effect of temperature and time of extraction on the quality of Semi Refined Carrageenan (SRC). MATEC Web of Conferences, 154, 01034.
Hernández-Carmona, G., Freile-Pelegrin, Y. and Hernández-Garibay E. (2013). Conventional and alternative technologies for the extraction of algal polysaccharides. In: Dominguez, H. editor. Functional ingredients from algae for foods and nutraceuticals. 475-509. Woodhead, Philadelphia.
Hilliou, L., Vlassopoulos, D. and Rehahn, M. (2001). Dynamics of non-dilute hairy-rod polymer solutions in simple shear flow. Macromolecules, 34, 1742-1750.
Hossain, K. S., Miyanaga, K., Maeda, H. and Nemoto, N. (2001). Sol-Gel transition behavior of pure ι-carrageenan in both salt-free and added salt states. Biomacromolecules, 2, 442-449.
Hu, X., Jiang, X., Aubree, E., Boulenguer, P. and Critchley, A. T. (2006). Preparation and In Vivo. Antitumor Activity of κ-Carrageenan Oligosaccharides. Pharmaceutical Biology, 44(9), 646-650.
International patent application publication no. WO 2014/062401 A1, MORTAR WITH HYDROXYETHYL METHYL CELLULOSE FOR SELF-COMPACTING CONCRETE. Grote et al. (2014).
International patent application publication no. WO 2017/119859. CEMENT-BASED COMPOSITIONS WITH IMPROV-ED RHEOLOGICAL PROPERTIES AND METHODS FOR PRODUCTION. Al, Basaran et al. (2017).
Isik, I. E. and Ozkul, M. H. (2014). Utilization of polysaccharides as viscosity modifying agent in self-compacting concrete. Construction and Building Materials, 72, 239-247. Doi: 10.1016/j.conbuildmat.2014.09.017
Joshi, C., Patted, A., Archana, M. and Amarnath, M. (2013). Determining the rheological properties of asphalt binder using dynamic shear rheometer (DSR) for selected pavement stretches. International Journal of Research in Engineering and Technology, 2(13), 192-196.
Jouanneau, D., Boulenguer, P., Mazoyer, J. and Helbert, W. (2010). Enzymatic degradation of hybrid ι-/v-carrageenan by Alteromonas fortis ι-carrageenase. Carbohydr. Res., 345, 934-940.
Jumaidin, R., Sapuan, S. M., Jawaid, M., Ishak, M. R. and Sahari, J. (2017). Characteristics of Eucheuma cottonii waste from East Malaysia: physical, thermal and chemical Composition. European journal of phycology, 52(2), 200-207.
Kalitnik, A. A., Barabanova, A. O. B., Nagorkaya, V. B., Reunov, A. V., Glazunov, V. P., Solov'eva and T. F., Yermak, I. M. (2013). Low Molecular Weight Derivatives of Different Carrageenan Types and Their Antiviral Activity. Journal of Applied Phycology, 25, 65-72.
Kawai, T., (1987). Non-dispersible underwater concrete using polymers. Marine Concrete, International Congress on Polymers in Concrete, Brighton, UK, Chapter 11.5.
Khayat, K. H. (1995). Effects of antiwashout admixtures on fresh concrete properties. AC1 Mater, J., 92(2), 164-171.
Khayat, K. H. (1996). Ejfect of silica fume on fresh and mechanical properties of cancre te. CANMET-ACI Intensive Course on Fly Ash, Slag, Silica Fume, Other Pozzolanic Materials and Super plasticizers in Concrete, Ottawa, Canada, p.34.
Khayat, K. H. (1998). Viscosity-enhancing admixtures for cement-based materials—An overview. Cement and Concrete Composites, 20(2-3), 171-188.
Khayat, K. H. and Yahia, A. (1997). Effect of welan gum-high-range water-reducer combinations on rheology of cement grout. ACI Materials Journal, 94(5), 365-372.
Kloareg, B. and Quatrano, R. S. (1988). Structure of the cell walls of marine algae and ecophysiological functions of the matrix polysaccharides. Oceanogr. Mar. Biol. Annu. Rev., 26, 259-315.
Knutsen, S. H., Myladobodski, D. E., Larsen, B. et Usov, A. I. (1994). A modified system of nomenclature for red algal galactans. Botanica Marina, 37, 163-169
Kraan, S. (2012). Algal polysaccharides, novel applications and outlook, in Chuan-FaChang (Ed.), Carbohydrates; Comprehensive Studies on Glycobiology and Glycotech-nology, 1^{st} ed., 99, 489-532.
Lachemi, M., Hossain, K. M. A., Lambros, V., Nkinamubanzi, P.-C. et Bouzoubaâ, N. (2004b). Self-consolidating concrete incorporating new viscosity modifying admixtures. Cernent and Concrete Research, 34(6), 917-926.
Landry, S. (1987). Relation entre la structure moléculaire et les propriétés mécaniques des gels decarraghénane. PhD thesis, Grenoble Scientific, Technological and Medical University. France.
Leemann, A. et Winnefeld, F. (2007). The effect ofviscosity modifying agents on mortar and concrete. Cernent and Concrete Composites, 29(5), 341-349.
Lemieux, M., Bertrand, F., Chaouki, J. and Gosselin P. (2007). Comparative study of the mixing of free-flowing particles in a V-blender and a bin-blender. Chemical Engineering Science, 62, 1783-1802.
Leôn-Martinez, F.M., Cano-Barrita, P. F. D. J., Lagunez-Rivera, L. et Medina-Torres, L. (2014). Study of nopal mucilage and marine brown algae extract as viscosity-enhancing admixtures for cernent based materials. Construction and Building Materials, 53, 109-202.
Lootens, D., Hebraud, P., Lecolier, E. and Van Damme, H. (2004). Gelation, shear-thinning and shear-thickening in cement slurries. Oil and Gas Science and Technology, 59(1), 31-40.
Majid, N. B., Ibrahim, I. S. B., Sarbini, N. N. B., Zakaria, Z. A. B., and Osman, M. H. B. (2019) The chemical properties of seaweed for modify concrete. IOP Conf. Series: Earth and Environmental Science, 220, 012026.
Memon, S. A., Shaikh, M. A. et Akbar, H. (2011). Utilization of Rice Husk Ash as viscosity modifying agent in Self Compacting Concrete. Construction and Building Materials, 25(2), 1044-1048.
Meunier, V., Nicolai, T., Durand, D. and Parker, A. (1999). Light Scattering and Viscoelasticity of Aggregating and Gelling K-carrageenan, Macromolecules, 32, 2610-2616.
Mezger, T. G. (2011). The rheology handbook: For users of rotational and oscillatory rheometers, Hanover, Germany: Vincentz Network. 432 p.
Millane, R P., Chandrasekaran, R., Arnott, S. et Dea, L. C. M. (1988). The molecular structure of Kappa-carrageenan and comparison with Iota-carrageenan. Carbohydrate research, 182, 1-17.
Miura, N., Takeda, N., Chikamatsu, R., and Sogo, S. (1993). Application of Super Workable Concrete to Reinforced Concrete Structures with Difficult Construction Conditions, High Performance Concrete in Severe Environments, SP-140, P. Zia, ed., American Concrete Institute, Farmington Hills, MI, pp. 163-186.
Mostafa, A. M. and Yahia, A. (2016). New approach to assess build-up of cement-based suspensions. Cement and Concrete Research, 85, 174-182
Narsimhan, G. (1992). Emulsions. In H. G. Schwartzberg, and R. W. Hartel (Eds.), Physical chemistry of foods (pp. 307-386). New York: Marcel Dekker.
Nehdi, M. (2000). Why some carbonate fillers cause rapid increases of viscosity in dispersed cement-based materials. Cernent Concr Res, 30(10), 1663-1669.
Nickerson, M. T. and Paulson, A. T. (2004). Rheological properties of gellan, κ-carrageenan and alginate polysaccharides: effect of potassium and calcium ions on macrostructure assemblages. Carbohydrate Polymers, 58, 15-24.
Nijenhuis, K. (1997). Thermoreversible networks. New York: Springer.
Norhazariah, S., Azahari, B., Sivakumar, R. and Azura, A.R. (2018). A Comparative Study on the Physiochemical Properties of Semi-Refined Carrageenan from Low Industrial Grade Seaweed and High-Grade Seaweed of Kappaphycus Alvarezii. Journal of Physics: Conf. Series, 1082, 1-6.
Normah, O. and Nazarifah, I. (2003). Production of semi-refined carrageenan from locally available red seaweed, Eucheuma cottonii on a laboratory scale. J. Trop. Agric. And Fd. Sc., 31(2), 207-213.
Okamura, H. and Ouchi, M. (1999). Self compacting concrete. Development, present use and future, in: Skarendahl, A. and Petersson O. (Eds.), Self compacting concrete, Proceedings of the first International RILEM Symposium, RILEM Publications, La Ferte'-Mace' (France), pp. 3-14.
Ozawa, K., Maekawa, K., Kunishima, H. and Okamura, H. (1989). Performance of concrete based on the durability design of concrete structures, Proc. Second East Asia-Pacific Conf. Struct. Eng. Const, 1, 445-456.
Parker, A., Brigand, G., Miniou, C., Trespoey, A. and Vailee, P. (1993). Rheology and fracture of mixed □- and □-carrageenan gels: Two-step gelation. Carbohydrate Polymers, 20, 253-262.
Patural, L., Govin, A., Ruot, B., Deves, O. and Grosseau, P. (2009). Influence of cellulose ether particle size on water retention of freshly mixed mortars. In: Ninth ACI International Conference on Superplasticizers and Other Chemical Admixtures in Concrete, Seville, Spain, 261-271.
Pereira, L. et Van De Velde, F. (2011). Portuguese carrageenophytes: Carrageenan composition and geographic distribution of eight species (Gigartinales, Rhodophyta). Carbohydrate Polymers, 84(1), 614-623. Doi:10.1016/j.carbpol.2010.12.036
Pereira, L., Critchley, A. T., Amado, A. M. and Ribeiro-Claro, P. J. A. (2009). A comparative analysis of phycocolloids produced by underutilized versus industrially utilized carrageenophytes (Gigartinales, Rhodophyta). J Appl Phycol, 21, 599-605.
Pérez René. Ces algues qui nous entourent. 1997. Livre. Éditions Quae. 9782759201136
Peschard, A., Govin, A., Grosseau, P., Guilhot, B. and Guyonnet, R. (2004). Effect of polysaccharides on the hydration of cement paste at early ages. Cem. Concr. Res., 34, 2153-2158.
Picker, K. M. (1999). Matrix tablets of carrageenans. II. Release behavior and effect of added cations. Drug Dev Ind Pharm, 25, 339-346.
Piculell, L., Nilsson, S. and Muhrbeck, P. (1992). Effects of small amounts of kappa-carrageenan on the rheology of aqueous iota-carrageenan. Carbohydrate Polymers, 18, 199-208.
Plank, J. (2004). Applications of biopolymers and other biotechnological products in building materials. Applied Microbiology and Biotechnology, 66(1), 1-9.
Pourjavadi, A., Ghasemzadeh, H. and Hosseinzadeh, H. (2004). Preparation and swelling behaviour of a novel anti-salt superabsorbent hydrogel based on kappa-carrageenan and sodium alginate grafted with polyacrylamide. E-Polymers, (027).
PT Alamindo Makmur Cemerlang. (2020). Website. https://picbabun.com/pt_amc.
Qingdao Oceanview Chemical Co., Ltd, Chine. (2020). Website. http://www.oceanviewchem.com.
Rees, D. A. (1970). Structure, conformation, and mechanism in the formation of polysaccharide gels and networks. Advances in Carbohydrate Chemistry and Biochemistry, 24, 267-332.
Rols, S., Ambroise, J. et Pera, J. (1999). Effects of different viscosity agents on the properties of self-leveling concrete. Cernent and Concrete Research, 29(2), 261-266.
Rudolph, B. (2000). Seaweed product: Red algae of economic significance. Dans: Martin, R. E., Carter, E. P., Davis, L. M. et Flich, G. J. (Eds.), Marine and freshwater products handbook, 515-529. Lancaster, USA: Technomic Publishing Company Inc. cemconcomp.2014.08.007
Sigma-Aldrich. (2020). Website. https://www.sigmaaldrich.com/catalog/product/sigma/22048?lang=fr&region=CA.
Sjamsiah et al., 2013. Malaysian Journal of Analytical Sciences. 17(2), 236-243.
Sonebi, M. (2006). Rheological properties of grouts with viscosity modifying agents as diutan gum and welan gum incorporating pulverised fly ash. Ce ment and Cancre te Research, 36(9), 1609-1618.
Spiratos, N., Pagé, M., Mailvaganam, N. P., Malhotra, V. M. and Jolicoeur, C. (2003). Superplasticizers for concrete. ACI, Ottawa.
Susilorini, M. I. R., Hardjasaputra, H., Tudjono, S., Hapsari, G., Wahyu, S. R., Hadikusumo, G. and Sucipto, J. (2014). The advantage of natural polymer modified mortar with seaweed: green construction material innovation for sustainable concrete. Procedia Engineering, 95, 419-425.
Suzuki, T. and Nakagami, H. (1999). Effect of crystallinity of microcrystalline cellulose on the compactabitiy and dissolution of tablets. Eur J Pharm Biopharm, 47, 225-230.
Tanaka, K., Sato, K., Watanabe, S., Arima, I. and Suenaga, K. (1993). Development and Utilization of High Performance Concrete for the Construction of the Akashi Kaikyo Bridge, High Performance Concrete in Severe Environments, SP-140, P. Zia, ed., American Concrete Institute, Farmington Hills, MI, pp. 25-51.
Thành, T. T. T., Yuguchi, Y., Mimura, M., Yasunaga, H., Takano, R., Urakawa, H. and Kajiwara K. (2002). Molecular Characteristics and Gelling Properties of the Carrageenan Family, 1. Macromol. Chem. Phys., 203, 15-23.
Thrimawithana, T. R., Young, S., Dunstan, D. E. and Alany, R. G. (2010). Texture and rheological characterization of kappa and iota carrageenan in the presence of counter ions. Carbohydrate Polymers, 82, 69-77.
Tolstoguzov, V. B. (1986). In Functional Properties of Food Mucromolecules, eds J.R. Mitchell & D.A. Ledward. Elsevier. London, pp. 385415.
Tolstoguzov, V. B. (1988). Food Hydrocoll., 2, 339-370.
Tolstoguzov, V. B. (1991). Food Hydrocoll., 4, 429468. Welti. D. (1977). J. Chem. Res. iM), 3566-3587.
Uca, S., Ramli, N., Daik, R. and Yarmo, A. (2013). Determination of the functional properties of Kappaphycus alvarezii seaweed powder. Malaysian Journal of Analytical Sciences. 17(2), 236-243.
U.S. Pat. No. 5,975,220 B2
U.S. Pat. No. 6,110,271 B2
U.S. Pat. No. 6,173,778 B2
U.S. Pat. No. 6,235,809 B2
U.S. Pat. No. 7,007,754 B2
U.S. Pat. No. 9,650,559 B2
U.S. Pat. No. 9,845,265 B2
US patent application publication no. 2015/0291475 A1. BACTERIAL CELL WALLS AS VISCOSITY MODIFYING ADMIXTURES OF CONCRETE. Pei et al. (2015).
US patent application publication no. 2018/023005 6A1
U.S. Pat. No. 5,004,506 B2, WELAN GUM IN CEMENT COMPOSITIONS. Allen et al. (1991).
U.S. Pat. No. 7,605,196 B2, WATER-SOLUBLE COPOLYMERS CONTAINING SULFO GROUPS, METHOD FOR THE PRODUCTION AND USE. Schinabeck et al. (2009)
U.S. Pat. No. 7,909,927 B2, RHEOLOGY MODIFYING ADMIXTURE. Margheritis et al. (2011).
U.S. Pat. No. 9,174,873 B2, MATERIAL TO BE USED AS A CONCRETE ADDITIVE. Laukkanen et al. (2015).
US20180312435A1
van De Velde, F., Knutsen, S. H., Usov, A. I., Rollema, H. S. and Cerezo, A. S. (2002). ¹H and ¹³C high resolution NMR spectroscopy of carrageenans: application in research and industry. Trends Food Sci. Technol., 13, 73-92.
Vazquez, A. and Pique, T. M. (2016). Biopolymers and Biotech Admixtures for Eco-Efficient Construction Materials. (Duxford: Woodhead Publishing)
Vieira, M. C., Klemm, D. and Einfeldt, L. (2005). Dispersing agents for cement based on modified polysaccharides. Cement and Concrete Research, 35, 883-890.
Wallevik, O. H. and Wallevik, J. E. (2011). Rheology as a tool in concrete science: The use of rheographs and workability boxes. Cement and Concrete Research, 41(12), 1279-1288. Doi: 10.1016/j.cemconres.2011.01.009
Watase, M. and Nishinari, K. (1982). The rheological study of the interaction between alkali metal ions and kappa-carrageenan gels. Colloid and Polymer Science, 260(10), 971-975.
Webber, V., Matos de Carvalho, S., Ogliari, P. J., Hayashi, L. and Barreto, P. L. M. (2012). Optimization of the extraction of carrageenan from Kappaphycus alvarezii using response surface methodology. Ciênc. Tecnol. Aliment., Campinas, 32(4), 812-818.
Yahia, A. and Khayat, K. H. (2001). Analytical models for estimating yield stress of high-performance pseudoplastic grout. Cement and Concrete Research, 31(5), 731-738. Doi:10.1016/S0008-8846 (0)00476-8

1. (canceled)

2. (canceled)

3. A method of modifying the viscosity of a flowable cementitious suspension, the method comprising adding carrageenan as a viscosity-modifying admixture to the flowable cementitious suspension, wherein the flowable cementitious suspension is a cement-based composition that can be cast without consolidation and vibration.

4. A dry cementitious composition comprising carrageenan as a viscosity-modifying admixture, wherein the dry cementitious composition produces a flowable cementitious suspension when mixed with water, and wherein the flowable cementitious suspension is a cement-based composition that can be cast without consolidation and vibration.

5. (canceled)

6. The dry cementitious composition of claim 4, wherein the dry cementitious composition comprises:
from about 40% to about 80% of sand;
from about 0% to about 50% of aggregates;
from about 10% to about 40% of cement;
from about 0.04% to about 0.6% of a superplasticizer; and
from about 0.04% to about 0.25% of carrageenan,
all percentages being w/w % based on the total weight of the dry cementitious composition.

7. (canceled)

8. (canceled)

9. The dry cementitious composition of claim 4, wherein the flowable cementitious suspension is a self-leveling flowable cementitious suspension, and wherein the dry cementitious composition is_free coarse aggregates, wherein coarse aggregates are aggregates having a size greater than about 5 mm.

10. The dry cementitious composition of claim 9, comprising:
from 60 to 80% of sand,
from 20 to 40% of cement,
from 0.08 to 0.6% of a superplasticizer, and
from about 0.06% to 0.25% of carrageenan,
all percentages being w/w % based on the total weight of the dry cementitious composition.

11. The dry cementitious composition of claim 10, wherein the sand has a maximum size of about 5 mm.

12. The dry cementitious composition of claim 10, wherein the sand is siliceous sand.

13. The dry cementitious composition of claim 10, further comprising one or more of hydrated calcium sulphate, a natural or synthetic anhydrite, a biocide, an antifoam agent, a redispersible resin, or another conventional additive.

14. (canceled)

15. (canceled)

16. The dry cementitious composition of claim 4, wherein the flowable cementitious suspension is a self-consolidating flowable cementitious suspension, and wherein the dry cementitious composition comprises:
from 40 to 60% of sand,
from 30 to 50% of aggregates,
from 10 to 40% of cement
from 0.05 to 0.4% of a superplasticizer, and
from about 0.04% to 0.16% of carrageenan,
all percentages being w/w % based on the total weight of the dry cementitious composition.

17. (canceled)

18. The dry cementitious composition of claim 16, further comprising one or more of fly ash, ground limestone filler, silica fume, blast furnace slag, or glass powder.

19. The dry cementitious composition of claim 16, wherein the total volume of powder material having a size up to 0.075 mm is between about 320 to about 500 kg/m³.

20. The dry cementitious composition of claim 6, wherein the superplasticizer is a sulfonated melamine-formaldehyde, a sulfonated naphthalene-formaldehyde, or a polycarboxylate ether.

21. A flowable cementitious suspension comprising the dry cementitious composition of claim 4 and water, wherein the flowable cementitious suspension is a cement-based composition that can be cast without consolidation and vibration.

22. (canceled)

23. The flowable cementitious suspension of claim 21, having a water-to-cement ratio, by weight, of from 0.40 to 0.60.

24. The flowable cementitious suspension of claim 21, being a self-leveling flowable cementitious suspension.

25. The flowable cementitious suspension of claim 24, being grout or mortar for self-leveling flooring, crack injection, or and anchorage sealing.

26. The flowable cementitious suspension claim 21, being a self-consolidating flowable cementitious suspension.

27. The flowable cementitious suspension of claim 26, being a flowable concrete.

28. The flowable cementitious suspension of claim 21, wherein the carrageenan is Kappa (κ)-carrageenan or a mixture of Iota (ι)-carrageenan and (κ)-carrageenan.

29. The flowable cementitious suspension of claim 21, wherein the carrageenan is provided in the form of a red algae powder.

30. (canceled)
